(19) United States
(12) Patent Application Publication
(10) Pub. No.: US 2024/0064274 A1
(43) Pub. Date: Feb. 22, 2024

(54) VEHICULAR VISION SYSTEM WITH MIRROR DISPLAY FOR VEHICLE AND TRAILER CAMERAS

(71) Applicant: Magna Mirrors of America, Inc., Holland, MI (US)

(72) Inventors: Rodney K. Blank, Zeeland, MI (US); Christopher R. Koetje, Zeeland, MI (US); Mark L. Larson, Grand Haven, MI (US); John T. Uken, Jenison, MI (US); Kurtis M. Larson, Grand Haven, MI (US); Christopher L. Long, Big Rapids, MI (US); Jeffrey D. Heinz, Ionia, MI (US)

(21) Appl. No.: 18/260,078

(22) PCT Filed: Jan. 6, 2022
(86) PCT No.: PCT/US2022/070062

§ 371 Date: Jun. 30, 2023

Related U.S. Application Data
(60) Provisional application No. 63/262,641, filed on Oct. 18, 2021.
(60) Provisional application No. 63/260,936, filed on Sep. 7, 2021.
(60) Provisional application No. 63/201,405, filed on Apr. 28, 2021.
(60) Provisional application No. 63/199,858, filed on Jan. 29, 2021.
(60) Provisional application No. 63/199,526, filed on Jan. 6, 2021.

(51) Int. Cl. H04N 7/18; B60R 1/26; B60R 1/25; B60R 1/12; B60R 1/04; B60R 1/08; H04N 23/90; H04N 5/262; H04N 23/63

(52) U.S. Cl. CPC H04N 7/181; B60R 1/26; B60R 1/25; B60R 1/12; B60R 1/04; B60R 1/088; H04N 23/90; H04N 5/2624; H04N 5/2628; H04N 23/631; B60R 2300/105; B60R 2001/1253; B60R 2300/20; B60R 2300/303

(57) ABSTRACT

A vehicular vision system includes an electronic control unit (ECU), a plurality of exterior viewing vehicle cameras that capture image data and provide captured image data to the ECU. When the vehicle is towing a trailer, a rearward-viewing trailer camera captures image data and provides captured image data to the ECU. A video mirror display screen is disposed at an interior rearview mirror assembly of the vehicle and is operable to display video images derived from video image data provided from the ECU. The mirror assembly is adjustable between a mirror mode and a display mode. The mirror assembly, when in the display mode, is operable by the driver of the vehicle to display at the video mirror display screen (i) a single image display of video images, (ii) a dual image display of video images or (iii) a three image display of video images.

### CROSS REFERENCE TO RELATED APPLICATIONS

The present application claims the filing benefits of U.S. provisional application Ser. No. 63/262,641, filed Oct. 18, 2021, U.S. provisional application Ser. No. 63/260,936, filed Sep. 7, 2021, U.S. provisional application Ser. No. 63/201,405, filed Apr. 28, 2021, U.S. provisional application Ser. No. 63/199,858, filed Jan. 29, 2021, and U.S. provisional application Ser. No. 63/199,526, filed Jan. 6, 2021, which are all hereby incorporated herein by reference in their entireties.

### FIELD OF THE INVENTION

The present invention relates to vehicular vision systems that display video images derived from image data captured by one or more cameras of the vehicle.

### BACKGROUND OF THE INVENTION

It is known to provide a video display at the exterior rearview mirror assembly, such as described in U.S. Pat. No. 7,777,611, which is hereby incorporated herein by reference in its entirety, or to provide a video display at an interior rearview mirror assembly to display sideward and/or rearward images, such as described in U.S. Pat. No. 5,670,935, which is hereby incorporated herein by reference in its entirety. A variety of interior and exterior mirror assemblies with indicators are known in the art, such as U.S. Pat. Nos. 5,668,663; 5,355,284; 5,788,357; 6,257,746; 6,005,724; 5,481,409; 6,111,683; 6,045,243; 6,264,353; 6,512,624; 6,356,376; 2,263,382; 2,580,014; 3,266,016; 4,499,451; 4,588,267; 4,630,904; 4,623,222; 4,721,364; 4,906,085; 5,313,335; 5,587,699; 5,575,552; 5,436,741; 5,587,699; 5,938,320; 6,700,692 and 5,786,772, which are all hereby incorporated herein by reference in their entireties.

### SUMMARY OF THE INVENTION

A vehicular vision system may display video images at a video display screen of an interior rearview mirror assembly for a camera monitoring system and a trailer camera or system, and optionally a rear backup camera system and a surround view vision system, while optionally also or selectively displaying video images at a center console or stack video display screen for the rear backup camera system and the surround view vision system. The system includes an electronic control unit (ECU) of the vehicle that receives image data captured by the rear backup camera, surround view vision cameras (such as a front forward-viewing camera, a driver-side sideward-viewing camera, a passenger-side sideward-viewing camera and the rear backup camera), the camera monitoring system cameras (such as a rearward-viewing camera, a driver-side rearward-viewing camera and a passenger-side rearward-viewing camera) and the trailer camera (when a trailer equipped with a trailer camera is hitched to the vehicle), and outputs (such as via a coaxial cable) video image data to the video display of the interior rearview mirror assembly for displaying video images at the display screen based on the driving situation and/or user input by the driver. The vision system provides for selection by the driver of the vehicle of different camera images (e.g., a single camera image derived from image data captured by the rearward viewing vehicle or trailer camera, dual camera images derived from image data captured by the driver-side rearward-viewing camera and the passenger-side rearward-viewing camera, or three camera images derived from image data captured by the driver-side rearward-viewing camera, the passenger-side rearward-viewing camera and the rearward viewing vehicle or trailer camera) at the video display screen. The driver may also (when the vision system is displaying the dual camera images or the three camera images) selectively adjust display parameters of one of the displayed images independent of the other displayed images.

The processing of image data captured by all of the cameras (optionally including a trailer camera disposed at a trailer that is being towed by the vehicle) may be performed by a data processor or image processor at the ECU, such that less processing capabilities are needed at the video display device at the interior rearview mirror assembly. The ECU may automatically adjust the output to the display device based on the driving conditions so the appropriate video images are displayed by the display device for viewing by the driver of the vehicle. Optionally, the system may include an interior trailer camera located inside the trailer and may display video images derived from image data captured by the interior trailer camera for monitoring the inside of the trailer.

The interior rearview mirror assembly is selectively adjustable by manual flip mechanism or electric actuator to a mirror mode, where the driver of the vehicle views reflections at the mirror reflective element to view rearward of the vehicle, and to a display mode, where the video mirror display screen is actuated to display video images for viewing by the driver through the mirror reflective element. The interior rearview mirror assembly includes user actuatable buttons or switches or capacitive touch sensors or proximity sensors for controlling display of the video mirror display screen when operating in the display mode. The user actuatable buttons include a view selection where the driver can select (i) the single image display of video images derived from image data captured by the rearward-viewing CMS camera, (ii) the dual image display of video images derived from image data captured by the side rearward-viewing CMS cameras (with the left-side camera images displayed at a left side of the video display screen and the right-side camera images displayed at a right side of the video display screen), and (iii) the three image display or multi-image display of video images derived from image data captured by the rearward-viewing CMS camera and the side rearward-viewing CMS cameras (with the left-side camera images displayed at a left side of the video display screen, the rear camera images displayed at a center region of the video display screen and the right-side camera images displayed at a right side of the video display screen). When the dual image display or the three image display is selected, the driver can actuate another of the user actuatable buttons to selectively adjust display parameters of each displayed video images independently of the others. The circuitry and processing may be all contained in the interior mirror as a single box or control unit, or the system may have remote ECU and a reduced content mirror (i.e., a two box or two unit system), or the system may have some circuitry in a repeater in addition to the remote ECU and mirror.

The user actuatable buttons may provide for adjustment of tilt, pan, roll, zoom, perspective and/or intensity of one displayed image at one side of the video mirror display screen independent of the displayed image at the other side of the video mirror display screen. The video mirror display screen may provide indication of which video images are being adjusted by actuation of the other user actuatable buttons.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle having a vision system

FIGS. 2A and 2B are views of an interior rearview mirror assembly, with the display activated (FIG. 2A) and deactivated (FIG. 2B);

FIG. 3 is a plan view of the vehicle, showing the vehicle towing a trailer;

FIGS. 4A-C are views of the mirror display, showing display configurations for displaying video images derived from image data captured by different cameras of the vision system;

FIGS. 5-66 are plan views of the mirror head, showing various user input controls for the user to actuate to control various display characteristics and views and modes;

FIG. 67 is a view of a menu schematic for adjusting intensity, zoom, tilt, pan and rotation of the displayed video images;

FIG. 68 is a view of a lockout icon that may be overlayed at the displayed video images when the user attempts to adjust the display when the vehicle is traveling over a threshold speed;

FIGS. 69-78 are plan views of the mirror head, showing various menu controls for a single camera view mode, and showing a camera icon indicating that the mirror is operating in the video display mode;

FIGS. 79-93 are plan views of the mirror head, showing various menu controls for a two camera view mode, and showing a camera icon indicating that the mirror is operating in the video display mode;

FIGS. 94-116 are plan views of the mirror head, showing various menu controls for a three camera view mode, with the center video images being derived from image data captured by a trailer camera of a trailer hitched to the vehicle, and with the displayed images including an icon indicating that the trailer is hitched to the vehicle;

FIG. 117 is a plan view of the mirror head, showing a signal loss icon that alerts the driver of the vehicle that the camera signal is compromised;

FIG. 118 is a plan view of the mirror head, showing a lockout mode indicator that appears responsive to the driver pressing the menu button when the vehicle is traveling at a speed above a threshold speed;

FIGS. 119A-F are plan views of the mirror head operating in the three camera mode, showing various alert icons that indicate to the driver that a signal is compromised or that the mirror is operating in the trailer camera mode or that the menu controls are locked out;

FIGS. 120A-E are plan views of another mirror head operating in the three camera mode, showing a different menu configuration;

FIGS. 121A-F are plan views of the mirror head, showing highlighting around the particular image that is being adjusted via the menu controls;

FIGS. 122A-G are plan views of the mirror head, showing different menu indications depending on which view is selected and whether there is a trailer camera connected from a trailer hitched to the vehicle;

FIGS. 123A-F are plan views of the mirror head, showing different menu indications depending on which view is selected and whether there is a trailer camera connected from a trailer hitched to the vehicle;

FIG. 124A is an exploded perspective view of the interior mirror assembly;

FIG. 124B is an exploded perspective view of the display panel assembly of the mirror assembly;

FIGS. 125-127 are perspective views of a toggle assembly for toggling the mirror reflective element and video display screen between a mirror mode and a display mode;

FIGS. 128A-B are perspective views of a button assembly for controlling the video mirror display screen;

FIGS. 129A-H are views showing the assembly process steps for assembling the interior rearview mirror assembly;

FIGS. 130A-B are perspective views of the assembled interior rearview mirror assembly;

FIGS. 131 and 71326 are perspective views of the electronic control unit;

FIGS. 133 and 134 are perspective views of another electronic control unit;

FIGS. 135-138 are views of a repeater for use with a trailer camera of the display system;

FIGS. 139 and 140 are block diagrams of the repeater connected to the trailer camera;

FIG. 141 is a plan view of a vehicle with a vision system having a repeater inline between the trailer camera and the ECU;

FIG. 142 is a block diagram of the system of FIG. 141;

FIG. 143 is a schematic of the wiring between the trailer camera and the ECU;

FIG. 144 is another block diagram of the repeater;

FIG. 145 is an exploded perspective view of the repeater assembly;

FIGS. 146A-C are exploded views showing the assembly process steps for assembling the repeater assembly;

FIGS. 147A-E are views of the assembled repeater assembly;

FIGS. 148A-H are views of the lower housing portion of the repeater assembly;

FIGS. 149A-F are views of the upper housing portion of the repeater assembly;

FIG. 150 is a perspective view of the lower housing portion, with the PCB and connectors and potting material disposed therein;

FIG. 151 is a perspective view of the perimeter seal that seals the upper housing portion relative to the lower housing portion;

FIG. 152 is a block diagram of an electrochromic mirror dimming system;

FIG. 153 is an exploded perspective view of an interior rearview mirror assembly with an electrochromic mirror reflective element and with the mirror dimming circuitry and system disposed remote from the mirror head;

FIGS. 154-161 are block diagrams of different implementations of vision systems having intelligent electrochromic mirror dimming;

FIG. 162 is a schematic view of an exemplary camera; and

FIG. 163 is a schematic view for transmission lines connecting a camera, a serializer, and a deserializer.

### DESCRIPTION OF THE PREFERRED EMBODIMENTS

A vehicle vision system and/or driver or driving assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a forward and/or rearward direction. The vision system includes an image processor or image processing system that is operable to receive image data from one or more cameras and to provide an output to one or more display devices for displaying video images representative of the captured image data. For example, the vision system may provide a rearview display or a top down or bird's eye or surround view display or the like.

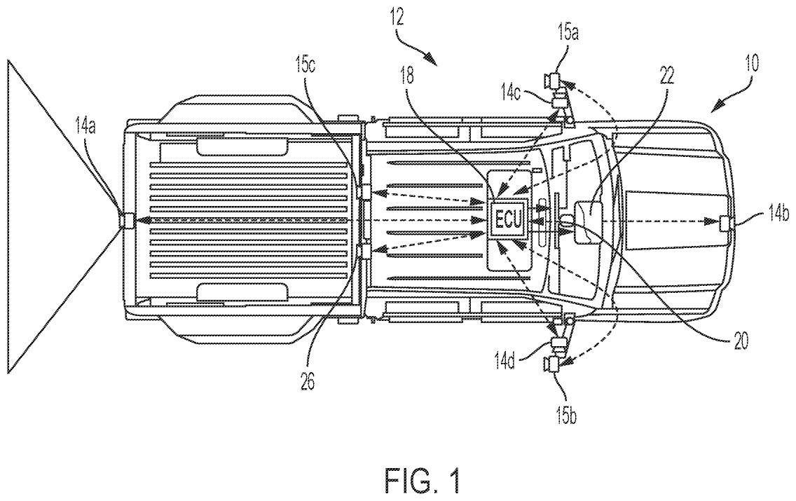

Referring now to the drawings and the illustrative embodiments depicted therein, a vehicle 10 includes an imaging system or vision system 12 that includes multiple exterior viewing cameras, including, for example, surround view cameras 14a-d (including a rearward-viewing or rear backup camera 14a, a forward-viewing camera 14b at the front of the vehicle and side surround view cameras 14c, 14d at respective sides of the vehicle), camera monitoring system (CMS) cameras 15a-c (including side rearward-viewing CMS cameras 15a, 15b at the respective sides of the vehicle, and a rearward-viewing camera 15c that has a different field of view than the rear backup camera 14a), which capture image data of the respective scenes exterior of the vehicle and in the field of view of the respective camera, with each camera having a lens for focusing images at or onto an imaging array or imaging plane or imager of the camera (FIG. 1). Optionally, a forward-viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The system may utilize aspects of the systems described in U.S. Pat. Nos. 10,967,796; 10,948,798; 10,442,360; 10,421,404; 10,166,924 and/or 10,046,706, and/or U.S. Publication Nos. US-2021-0245662; US-2021-0162926; US-2021-0155167; US-2020-0377022; US-2019-0146297; US-2019-0118717; US-2018-0134217; US-2017-0355312 and/or US-2014-0285666, which are all hereby incorporated herein by reference in their entireties.

The vision system 12 includes a control or electronic control unit (ECU) 18 having electronic circuitry and associated software, with the electronic circuitry including a data processor or image processor that is operable to process image data captured by the cameras, whereby the ECU may detect or determine presence of objects or the like and/or the system may provide video images or video image data or outputs or signals to a display device of the interior rearview mirror assembly 20 of the vehicle for displaying video images for viewing by the driver of the vehicle and/or to a display device 22 at the center console or stack of the vehicle (and optionally to CMS displays at or near the driver and passenger side A-pillars of the vehicle, such as described in U.S. Publication Nos. US-2018-0134217 and/or US-2014-0285666, which are hereby incorporated herein by reference in their entireties). The data transfer or signal communication from the cameras to the ECU may comprise any suitable data or communication link, such as a vehicle network bus or CAN (Controller Area Network) bus or LIN (Local Interconnect Network) bus or I2C bus or the like of the equipped vehicle.

The ECU receives image data captured by each of the cameras and the image data is processed by the data processor or image processor of the ECU. The ECU is connected to the video display of the mirror assembly 20 via a single coaxial wire or cable for communicating with the display (such as to provide control signals or the like) and for providing video image signals to the display. The ECU is also connected to the video display 22 of the center console via a single coaxial wire or cable for communicating with the display and for providing video image signals to the display. Thus, the ECU can provide video image signals or outputs to the center stack display or head unit 22 and/or to the video mirror display 20.

The connections between the cameras and the ECU and/or between the displays and the ECUs may be made via respective coaxial cables, which may provide power and control of the cameras (by the ECU) and which may provide image data from the cameras to the ECU, and which may provide video images or video image data from the ECU to the display devices. Each device (e.g., camera and display device) is thus connected to and communicates with the ECU via a single respective coaxial cable, thus reducing cable inputs to the video mirror display and the center stack display. The connections and communications may utilize aspects of the systems described in U.S. Pat. Nos. 10,264,219; 9,900,490 and/or 9,609,757, which are hereby incorporated herein by reference in their entireties.

The ECU may selectively or episodically provide video image data or signals to the center stack display or head unit 22 and/or the video mirror display 20 based on vehicle speed. For example, at slower speeds (e.g., during a parking or unparking maneuver), video images (such as surround view images or rearview images or the like) are displayed at the center stack display 22 (where it is safe for the driver to look down toward the center stack display when slowly maneuvering the vehicle), and at higher speeds (such as when the vehicle is driven forward along a road), video images (such as rearview images or CMS images or the like) are displayed at the video mirror display 20 (where it is safe for the driver to view without taking his or her eyes off the road when driving the vehicle at higher speeds).

The rearward-viewing camera 15c of the CMS cameras may also or otherwise function to provide rearward video images for a dual-mode interior rearview video mirror that can switch from a traditional reflection mode to a panoramic live-video display mode, such as is by utilizing aspects of the mirror assemblies and systems described in U.S. Pat. Nos. 10,948,798; 10,442,360; 10,421,404; 10,166,924 and/or 10,046,706, and/or U.S. Publication Nos. US-2021-0245662; US-2021-0162926; US-2021-0155167; US-2020-0377022; US-2019-0146297; US-2019-0118717; US-2018-0134217; US-2017-0355312 and/or US-2014-0285666, which are all hereby incorporated herein by reference in their entireties.

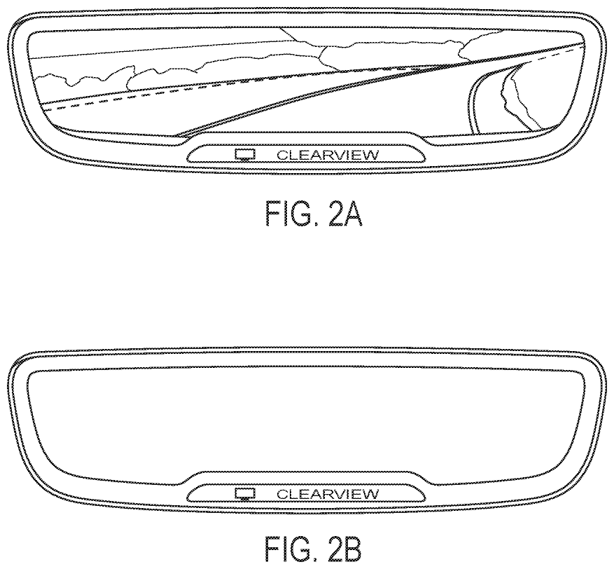

The interior rearview mirror assembly may comprise any suitable mirror assembly having a video display device disposed behind the mirror reflective element so as to be viewable through a partially reflectant and partially visible light transmitting or transflective mirror reflector of the mirror reflective element when the display screen is powered. For example, and such as shown in FIGS. 2A and 2B, the interior rearview mirror assembly may comprise an auto-dimming electro-optic (such as electrochromic) mirror assembly that operates as a reflecting mirror (FIG. 2A) when the display screen is off, and functions as a video mirror (FIG. 2B) when the display screen is activated. Optionally, the mirror assembly may comprise a prismatic mirror reflective element (that is toggled between a daytime viewing position and a nighttime or anti-glare viewing position) having a video display screen disposed behind the transflective mirror reflector of the prismatic mirror reflective element. Optionally, the display may include a reflective polarizer that may replace the reflective mirror element to provide a video display without a traditional mirror reflective element having a transflective mirror reflector.

Thus, when the mirror assembly is set to the video display mode (such as via actuation by the driver of a user-actuatable input), the ECU automatically switches to communicate video image data derived from image data captured by the rearward-viewing camera 15c to the video display screen at the interior rearview mirror.

Optionally, for a pickup truck application (such as shown in FIG. 1), the system may include a truck bed camera 26 disposed at the rear of the cab of the vehicle and having a field of view that encompasses the truck bed. The ECU communicates with the bed camera 26 and receives image data captured by the truck bed camera 26 and provides video image data (derived from image data captured by the truck bed camera 26) to the center stack display 22, such as responsive to actuation by the driver of a user input in the vehicle.

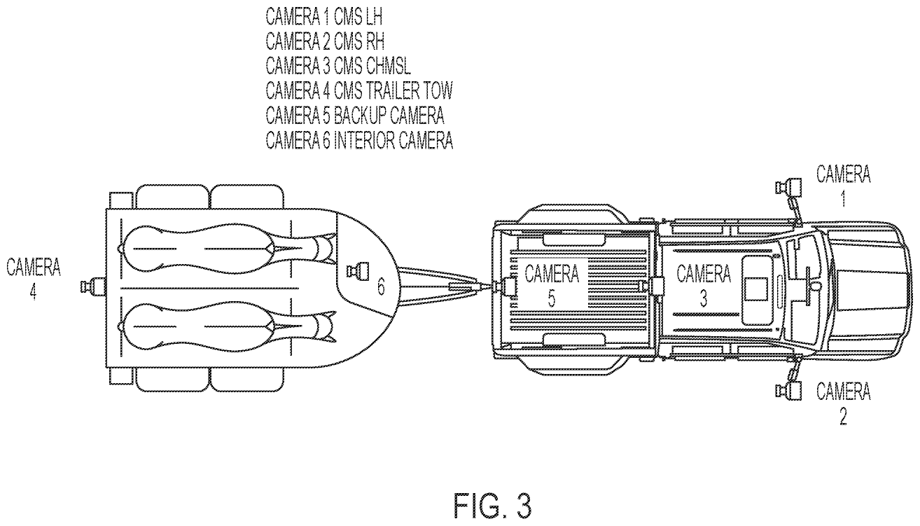

Optionally, and such as shown in FIG. 3, the vehicle may include a trailering assist function that is operable to assist in maneuvering (such as backing up or reversing) the vehicle with a trailer hitched to the vehicle at a hitch at the rear of the vehicle. The system communicates (such as via wireless communication or via a wired link) with a rearward-viewing trailer camera disposed at a rear of the trailer. The rearward-viewing trailer camera is disposed at the rear portion of the trailer, such as at the back end of the trailer, with the trailer camera centrally located at the rear portion and having a field of view at least rearward (and downward) rearward of the trailer.

The ECU receives image data captured by the rear trailer camera (and optionally other trailer cameras if the trailer has sideward-viewing or other rearward-viewing or interior-viewing cameras). The ECU, via processing of the received image data captured by the rear trailer camera, may detect objects or the like and/or may generate a video image output to display video images of the scene rearward of the trailer at the video mirror display or the center stack display for viewing by the driver of the vehicle. Optionally, the system may include or communicate with multiple trailer cameras (such as sideward-viewing cameras and a forward-viewing camera) to provide a surround view display of areas around the trailer as well as the vehicle, such as by utilizing aspects of the systems described in U.S. Publication No. US-2021-0094473, which is hereby incorporated herein by reference in its entirety. The system thus may display a 360 degree bird's eye view or surround view of the surroundings of the towing vehicle and the trailer being towed by the vehicle.

Optionally, the system may provide for display of a trailer see-through image (such as by utilizing aspects of the systems described in U.S. Publication No. US-2021-0094473, incorporated above), which shows a rearward and transparent view through the trailer with seamlessly stitching of video images and image data captured by the towing vehicle's rear backup camera with video images and image data captured by the trailer or satellite camera to provide the rearward video images. For example, the ECU may process image data captured by the rearward-viewing trailer camera and image data captured by some or all of the rearward-viewing CMS cameras 15a-c to generate the composite video images for display at the center stack display and/or the video mirror display.

The ECU may selectively or episodically provide the generated composite video image data or video images to the center stack display or the mirror display, such as responsive to a user actuatable input or responsive to a vehicle driving condition or responsive to vehicle speed or the like. For example, the ECU may provide the generated composite see-through trailer images or data to the center stack display when the vehicle is being driven in reverse and/or when the vehicle (towing the trailer) is driven forward at a speed below a threshold speed (such as 7 mph or 10 mph or 15 mph or the like), and then automatically switches to provide the generated composite see-through trailer images to the video mirror display when the vehicle is being driven forward at a speed above a threshold speed (such as 7 mph or 10 mph or 15 mph or the like). Thus, when the vehicle (towing the trailer) is traveling at greater speeds, the video images are displayed at the mirror assembly so that the driver of the vehicle can readily view them without taking his or her eyes off the road.

The trailer assist system or trailer surround view display system may utilize aspects of the systems described in U.S. Pat. Nos. 9,446,713; 9,085,261 and/or 6,690,268, and/or U.S. Publication Nos. US-2020-0017143; US-2019-0297233; US-2019-0347825; US-2019-0118860; US-2019-0064831; US-2019-0042864; US-2019-0039649; US-2019-0143895; US-2019-0016264; US-2018-0276839; US-2018-0276838; US-2018-0253608; US-2018-0215382; US-2017-0254873; US-2017-0217372; US-2017-0050672; US-2015-0217693; US-2014-0160276; US-2014-0085472 and/or US-2015-0002670, which are all hereby incorporated herein by reference in their entireties.

The ECU provides a central and common image processor for processing image data captured by any one or more of the vehicle (and trailer) cameras. The cameras communicate with the ECU over a CAN bus or LIN bus or I2C or the like. The ECU provides video image data to the center stack display (head unit) or to the interior video mirror, and may switch between the two based on vehicle speed. The interior mirror assembly may comprise a dual mode mirror having a full mirror display screen and may also be selectively actuated to provide a reflected view rearward of the vehicle or a video image display of images rearward of the vehicle. The ECU provides the rearward image data to the mirror display responsive to actuation of a user input in the vehicle.

The data processor or image processor of the ECU is capable of receiving image data from each of the cameras and processing the received image data for generating video image data or video images and/or for object detection or the like. Thus, the ECU has multiple image data input ports for receiving the image data from the respective cameras and for communicating to and/or controlling the respective cameras (such as to instruct the cameras to capture image data and/or to control various camera parameters). The image processing of image data captured by multiple cameras for multiple systems (e.g., a backup assist system, a surround view vision system, a rearview display system, a CMS system, a driver monitoring system, a truck bed viewing system and the like) is thus performed at a single ECU of the vehicle, which allows for reduced processing capabilities (and reduced cost) at the video mirror display.

Optionally, the ECU may provide video image data responsive to other vehicle systems, such as responsive to a lane-change assist system or blind zone monitoring system or the like. For example, the ECU may provide video images or data to the video screen of the interior video mirror responsive to vehicle approach in a side lane only when a lane change maneuver of the equipped vehicle is anticipated (such as by the driver activating a turn signal indicator or such as by a camera vision-based lane departure warning system of the equipped vehicle detecting a lane change maneuver). In this regard, use can be made of the systems described in U.S. Pat. No. 10,300,856, which is hereby incorporated herein by reference in its entirety.

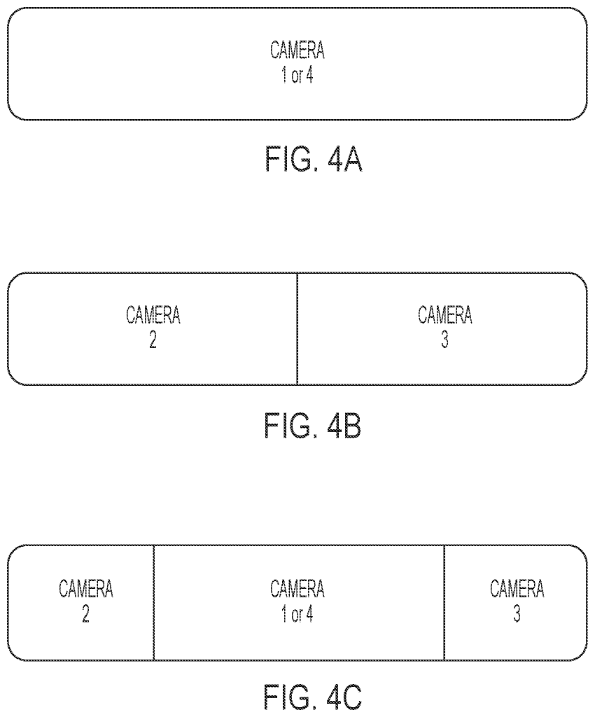

The vehicle may have a rearward-viewing camera disposed at a CHMSL (center high mounted stop lamp) area for capturing video image data for displaying video images a the interior mirror display, or may also include side-mirror mounted cameras, and/or may include a trailer mounted rearward-viewing camera at a trailer hitched to and towed by the vehicle, and the controller or ECU may receive outputs of other cameras and/or sensors of the vehicle, such as radar sensors and/or ultrasonic sensors and/or forward-viewing cameras and/or the like. The video display screen is operable to display video images captured by one or more of the cameras. For example, the video display screen may provide a single video image display (FIG. 4A), such as for displaying video images derived from image data captured by the rearward-viewing camera co-located at the CHMSL area or by the rear backup camera or by the rearward-viewing trailer-mounted camera. The video display screen may operate to provide a split screen display (FIG. 4B), such as for displaying video images derived from image data captured by the two side-mounted sideward and rearward-viewing cameras (such as for a CMS system), and/or the video display screen may operate to provide a split screen display (FIG. 4C), such as for displaying video images derived from image data captured by the two side-mounted sideward and rearward-viewing cameras and with a central pane of video images derived from image data captured by the rearward-viewing camera at the CHMSL area or the rearward-viewing trailer-mounted camera (such as for a CMS system).

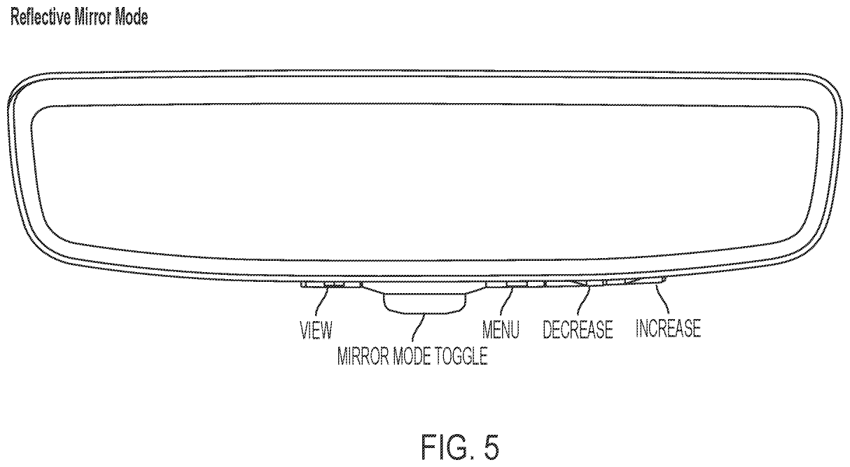

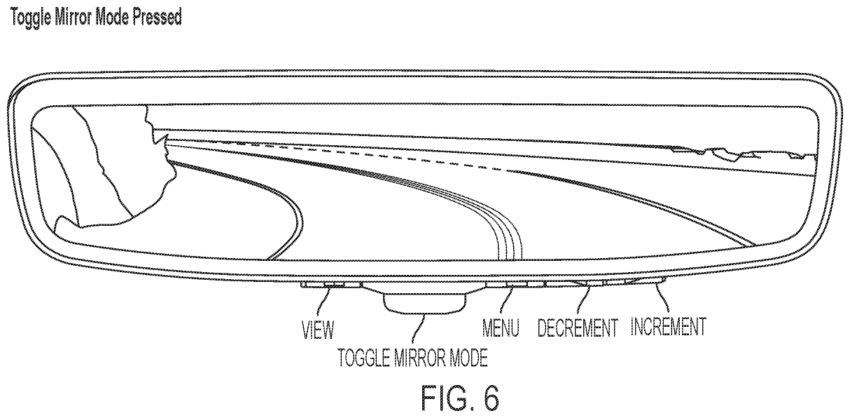

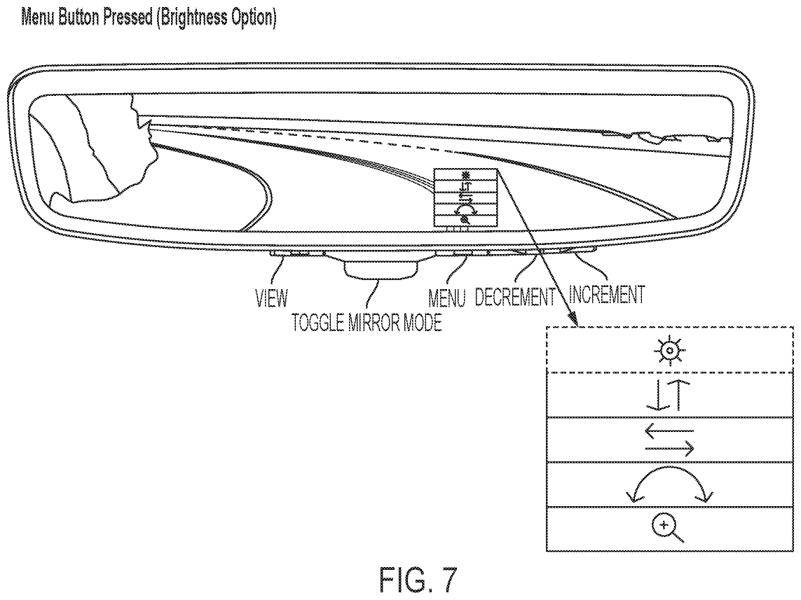

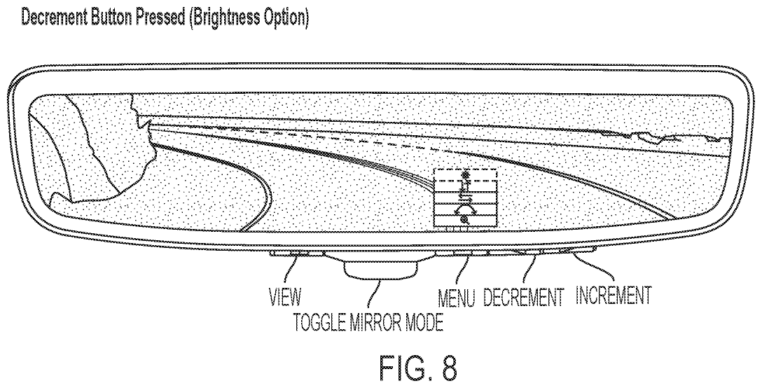

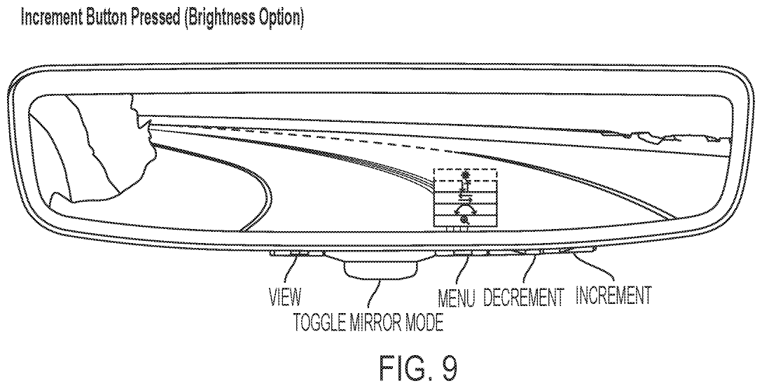

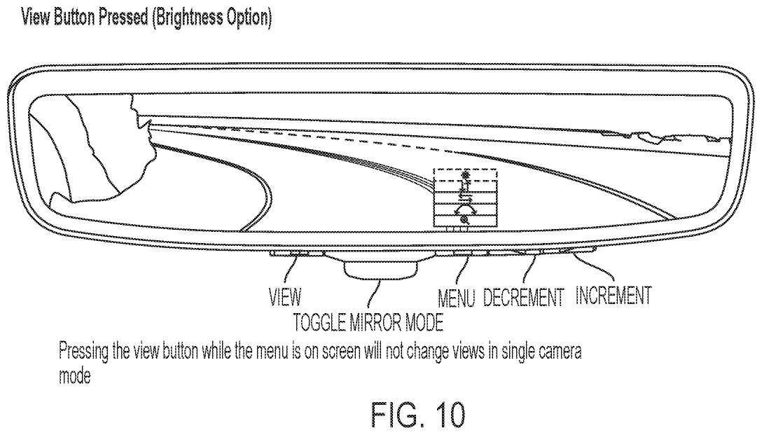

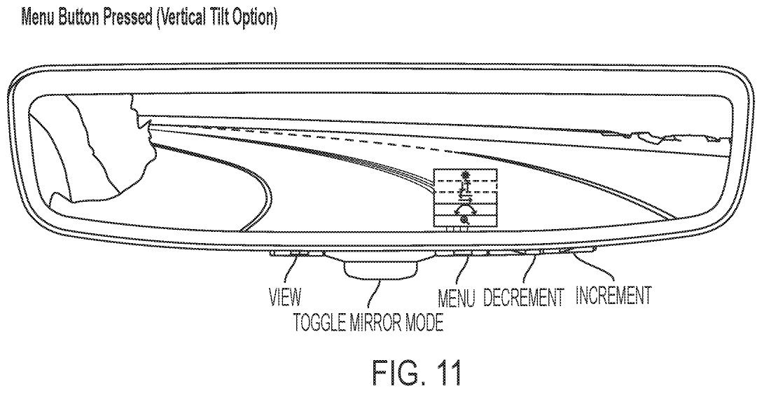

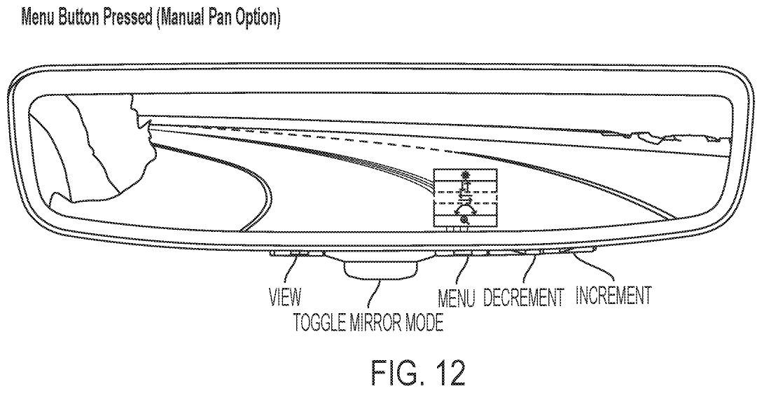

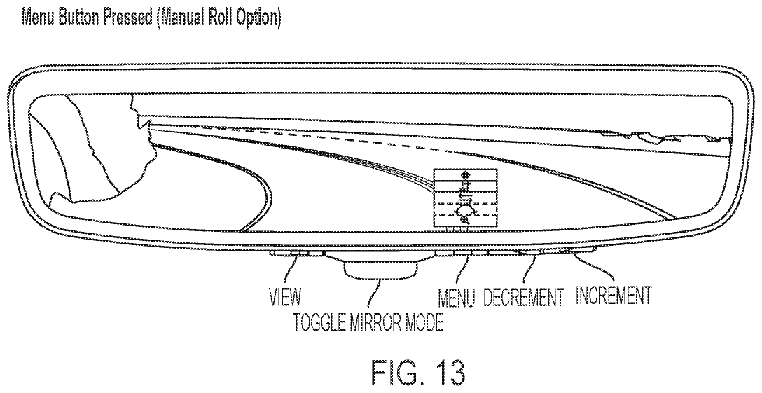

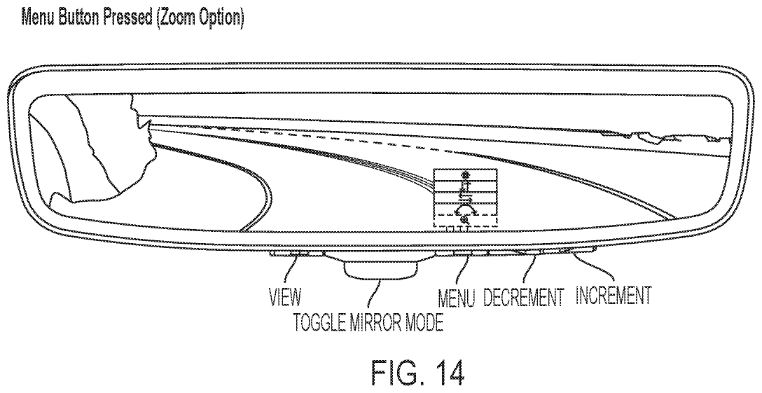

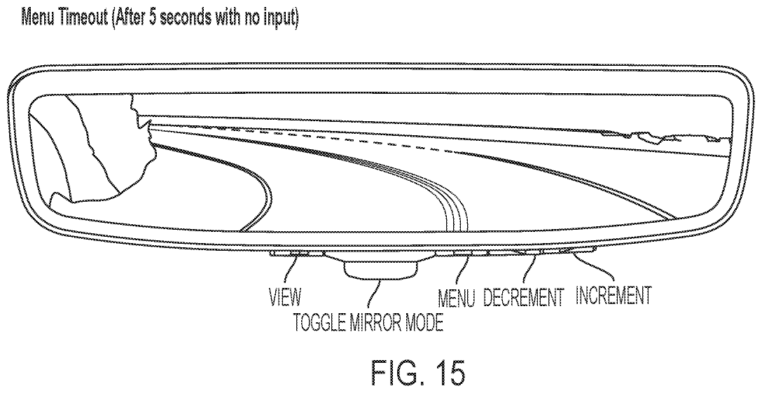

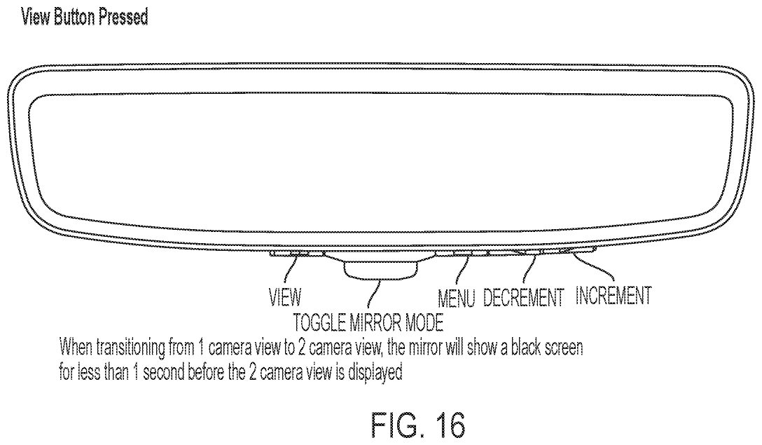

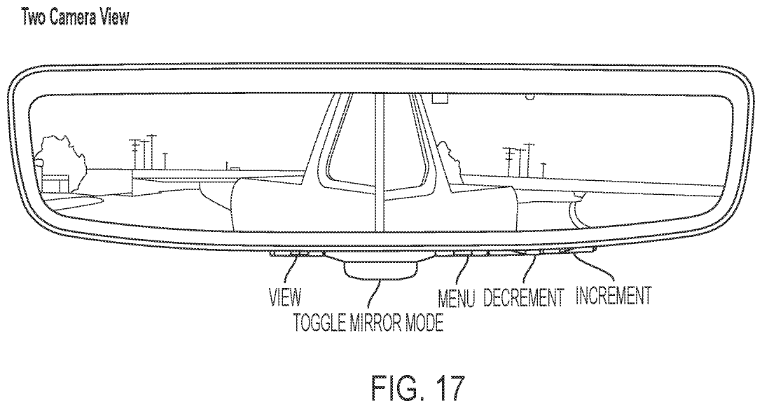

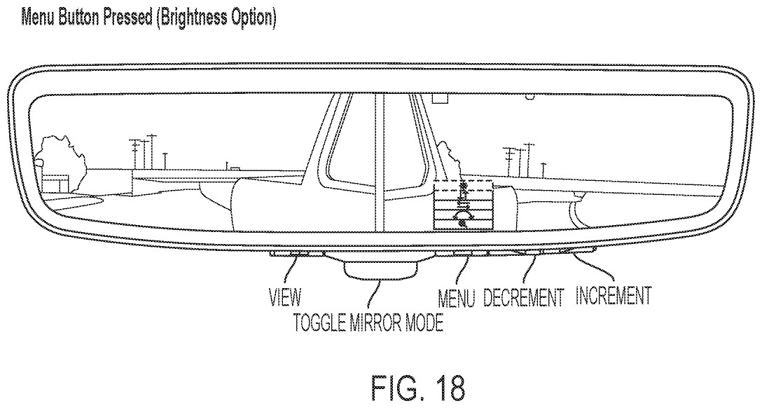

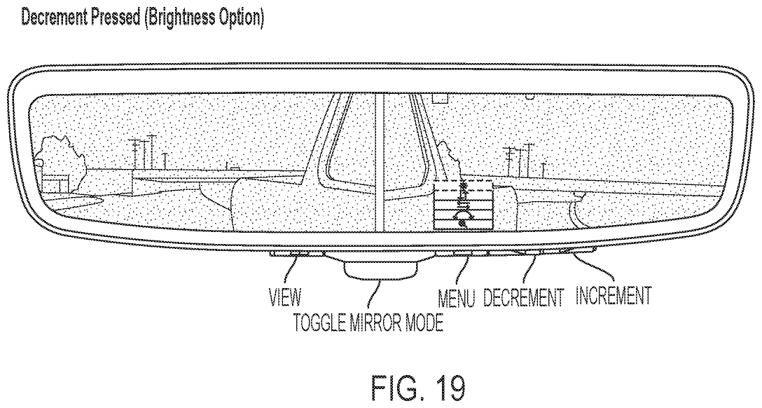

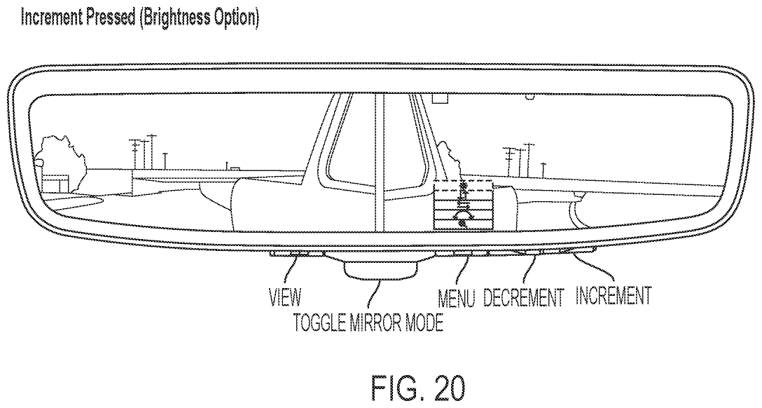

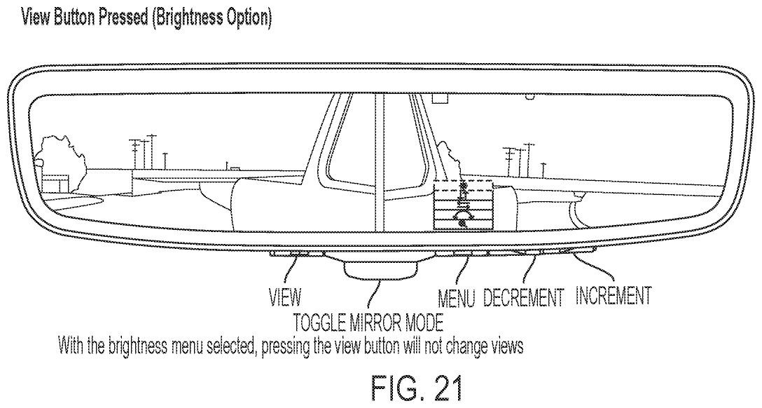

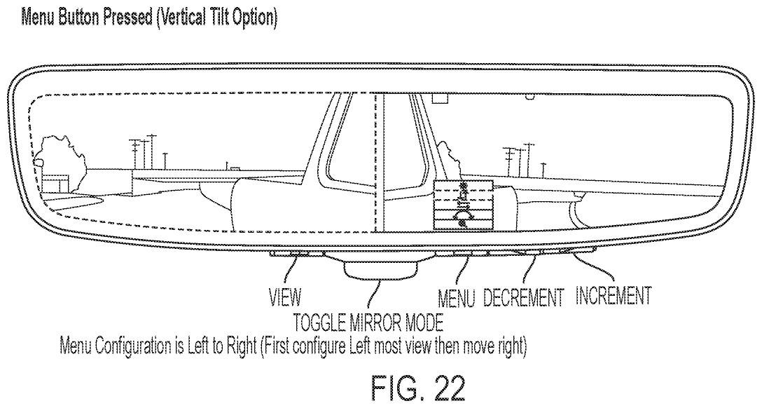

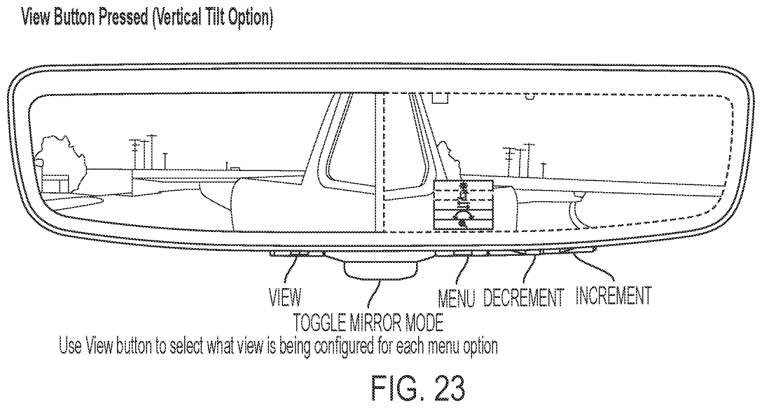

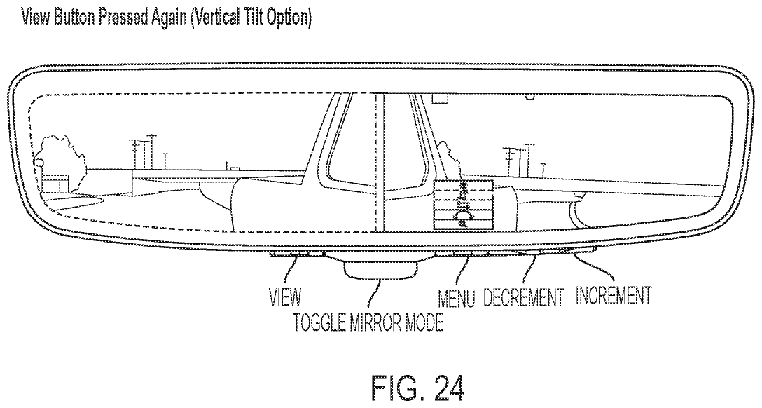

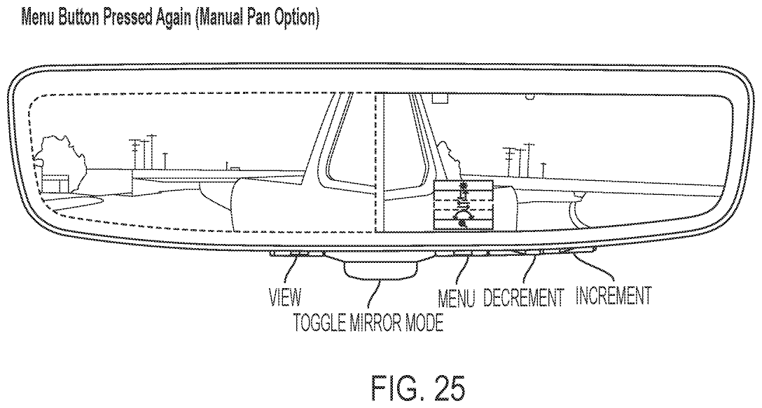

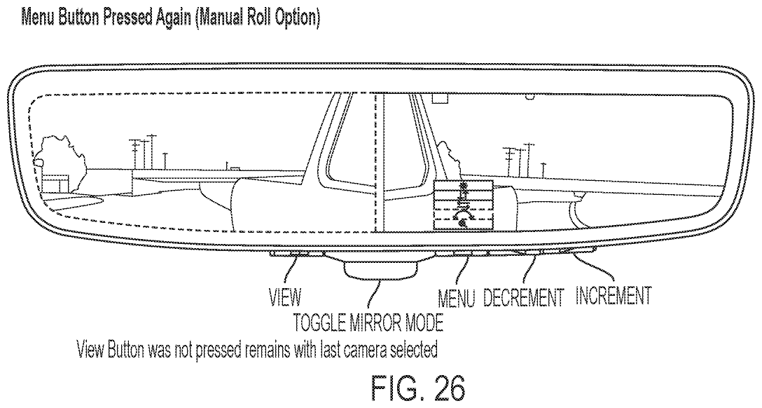

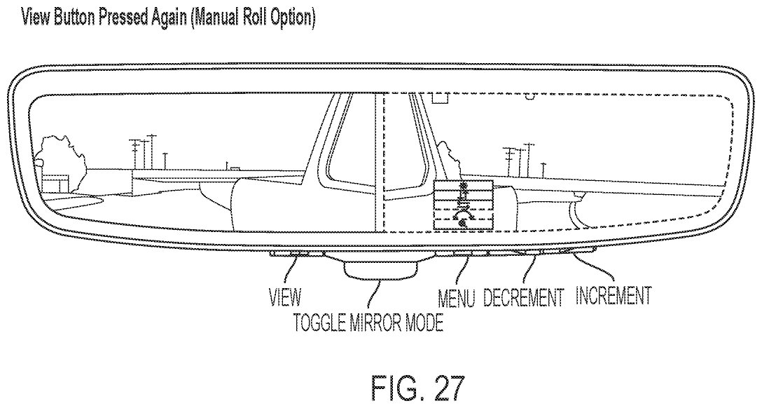

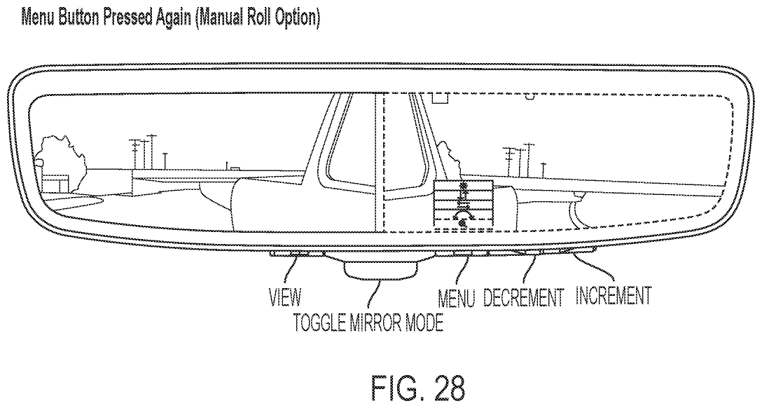

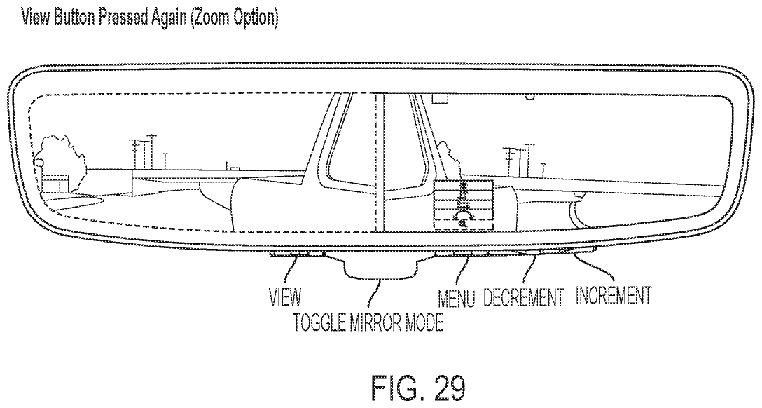

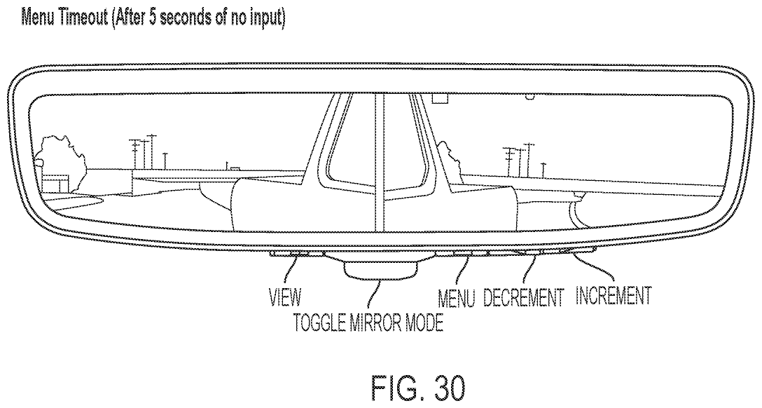

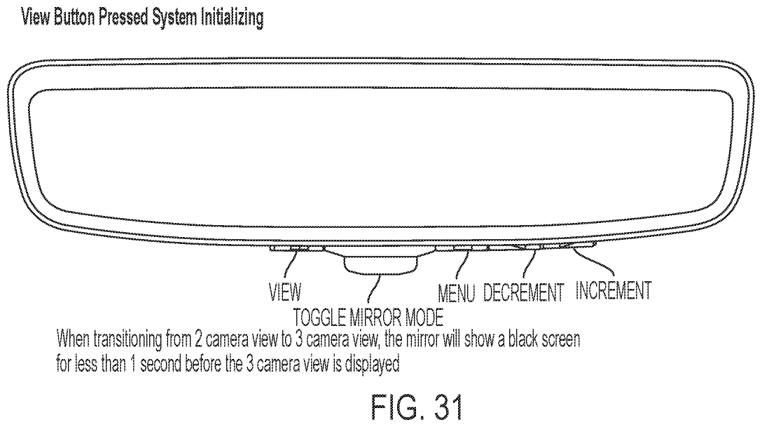

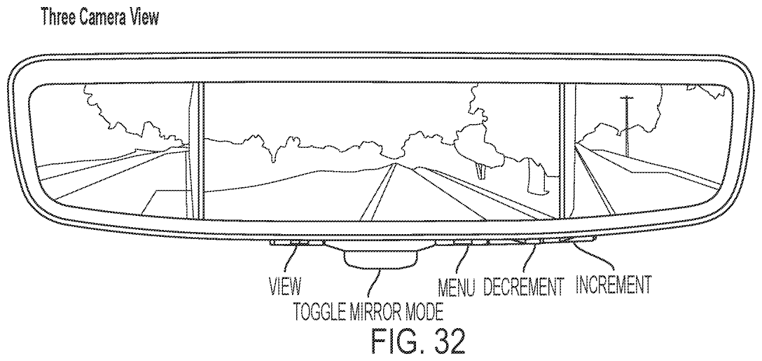

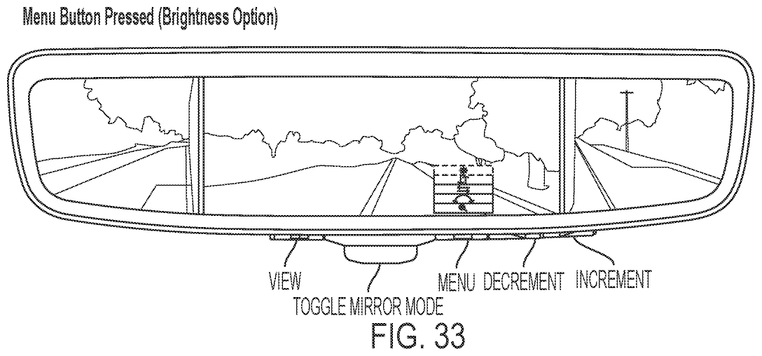

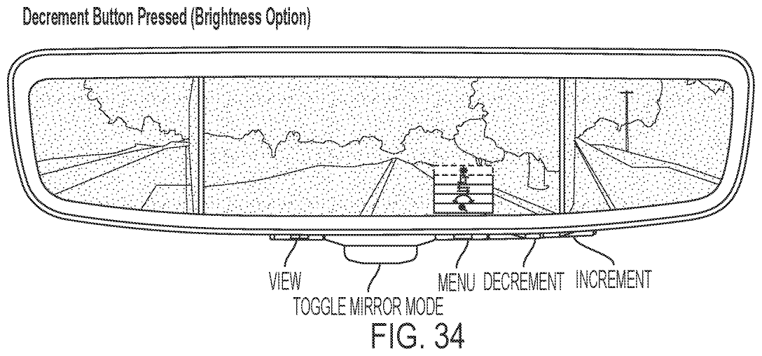

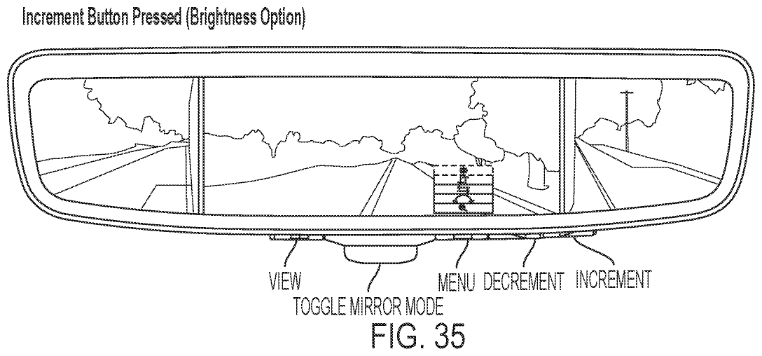

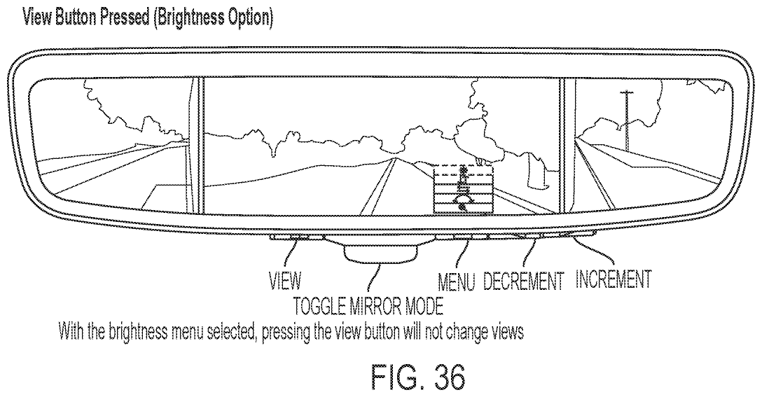

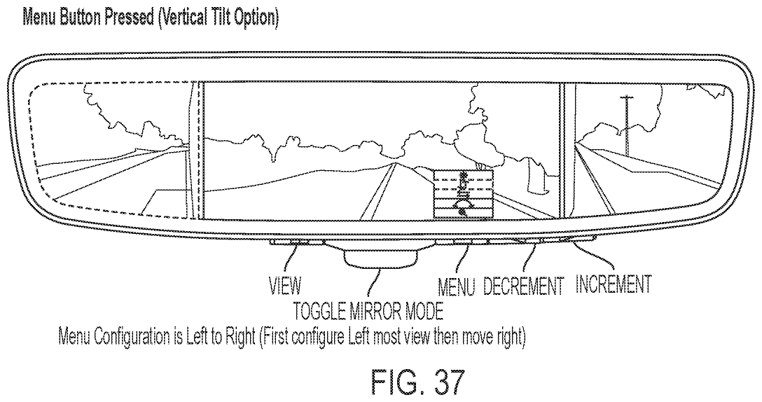

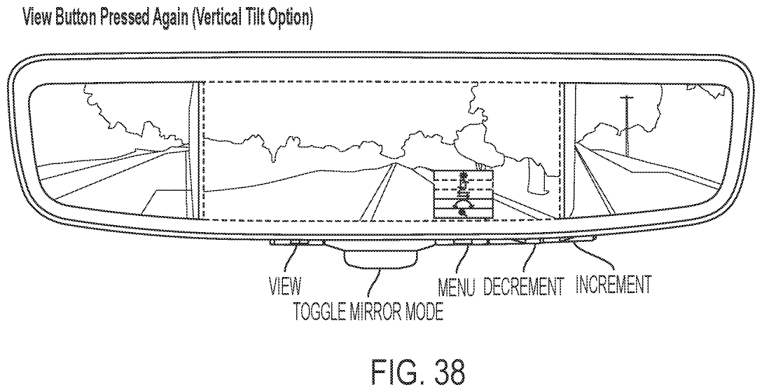

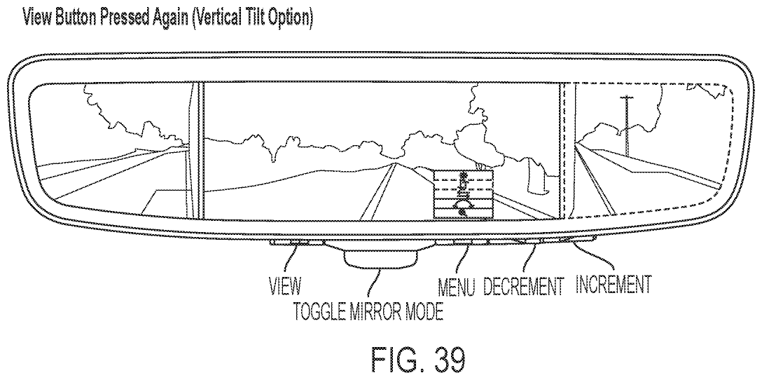

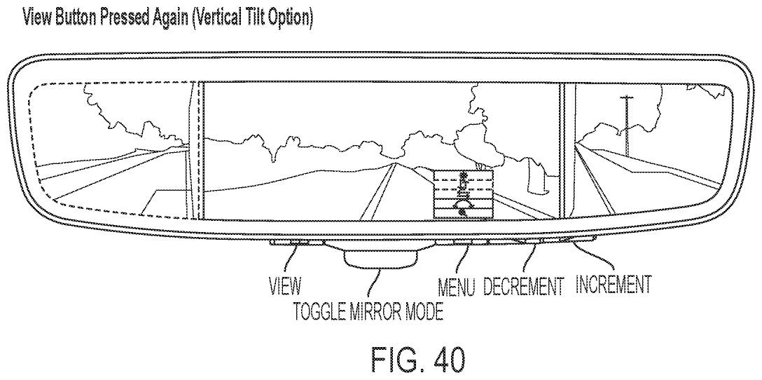

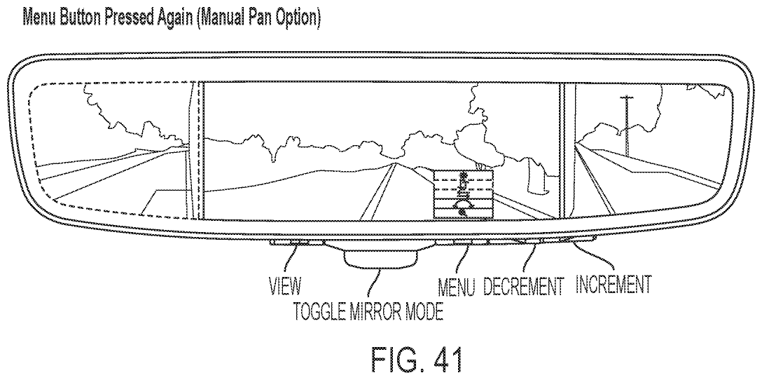

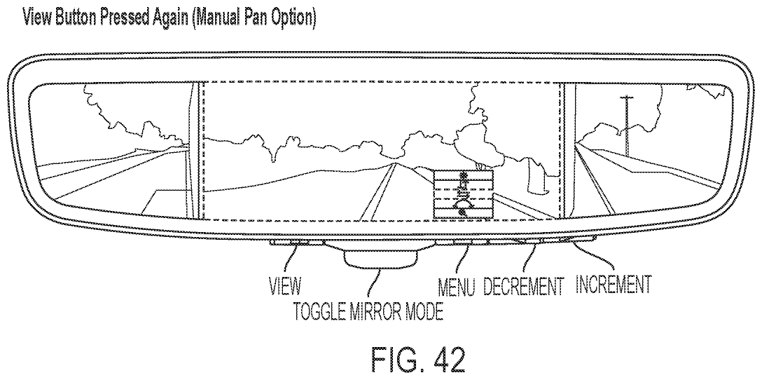

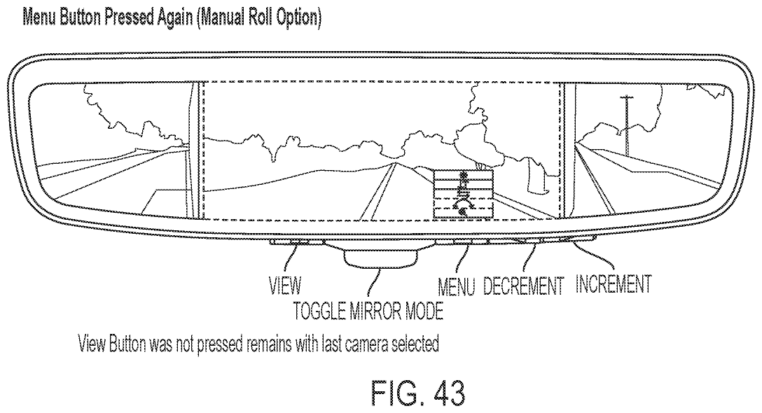

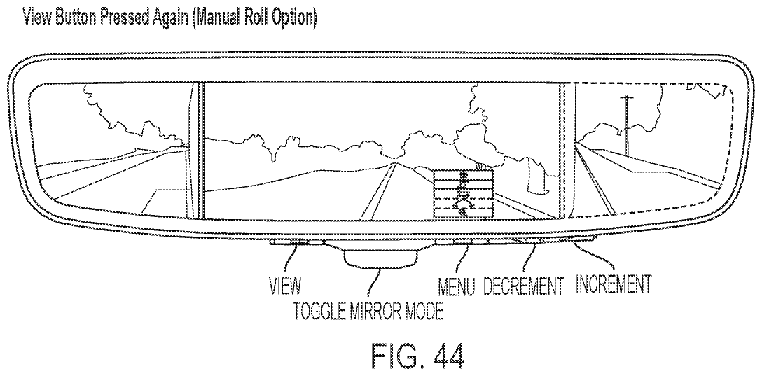

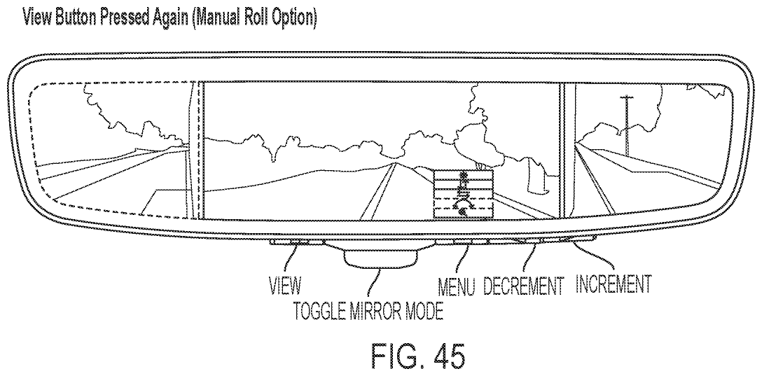

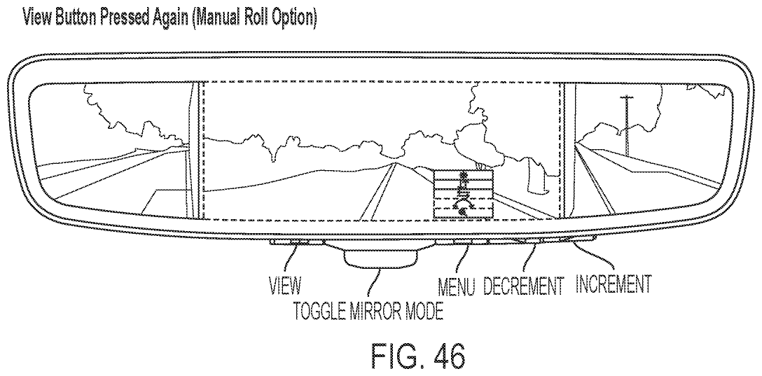

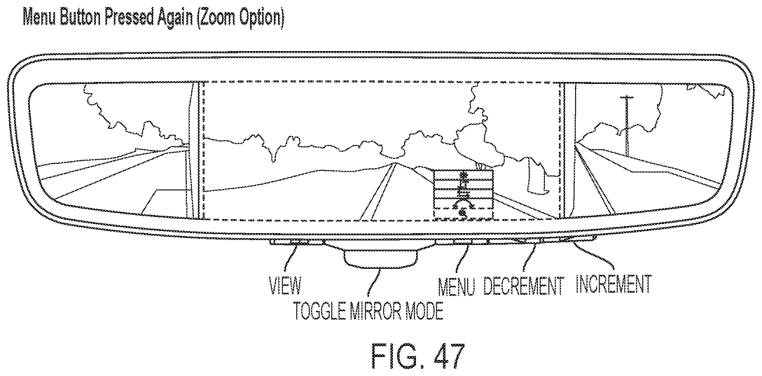

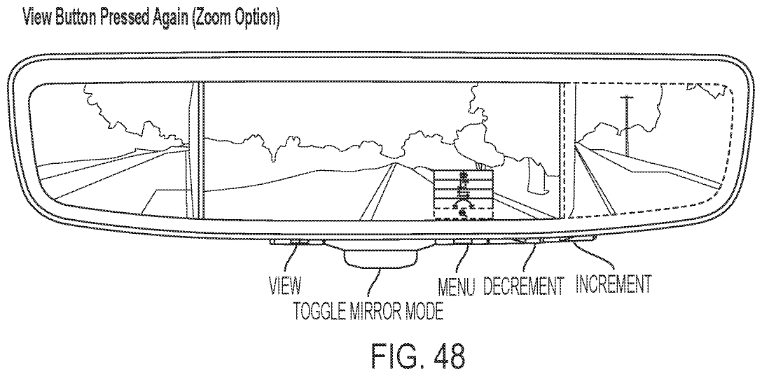

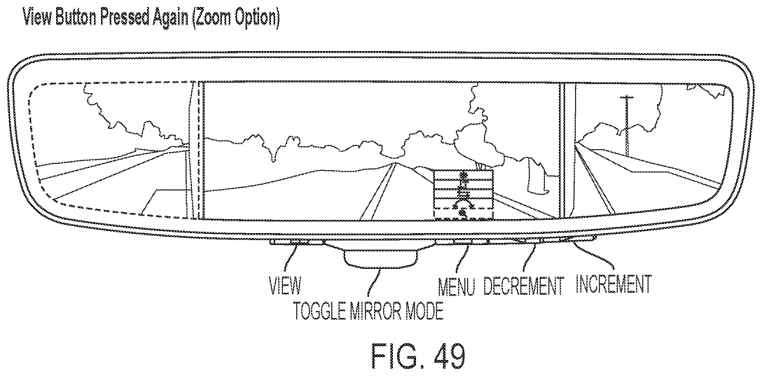

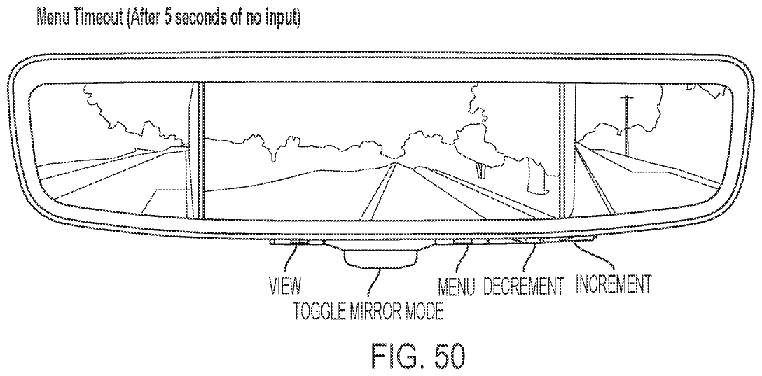

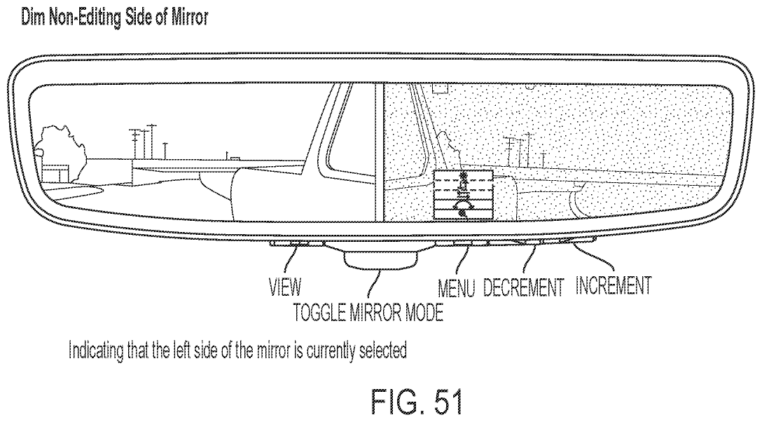

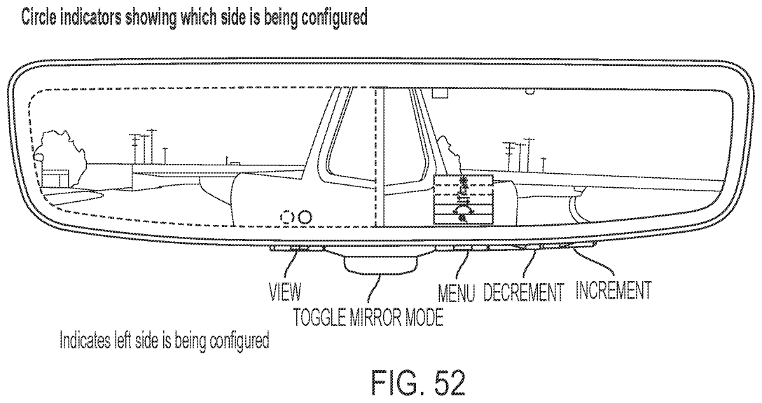

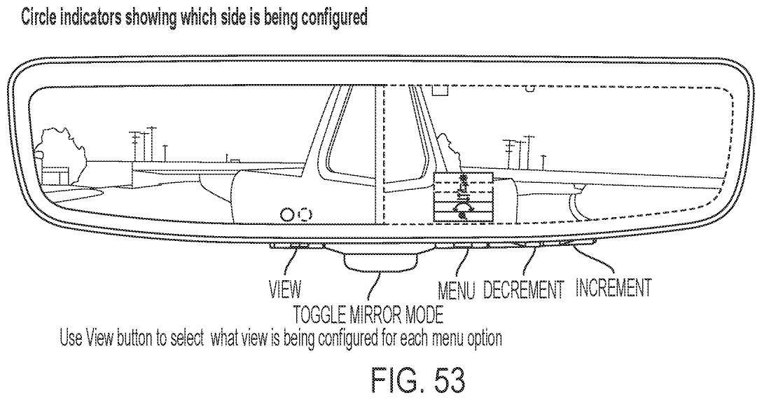

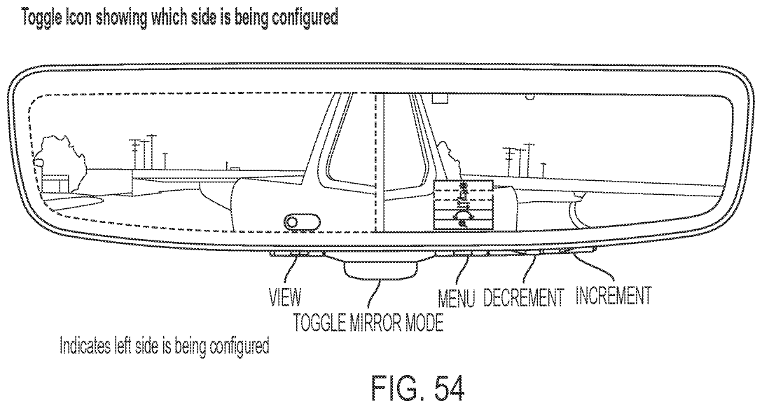

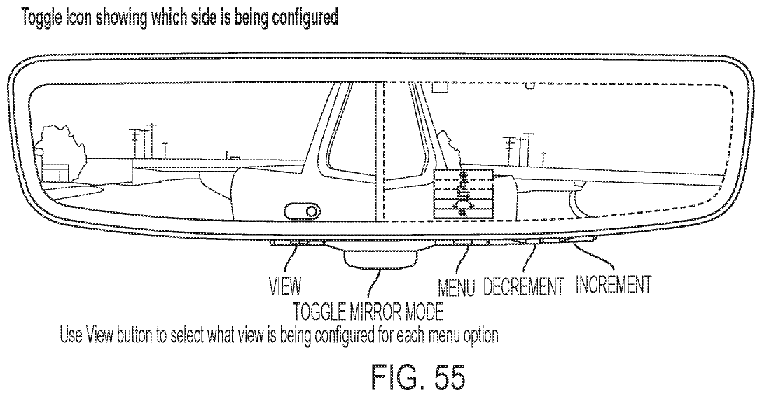

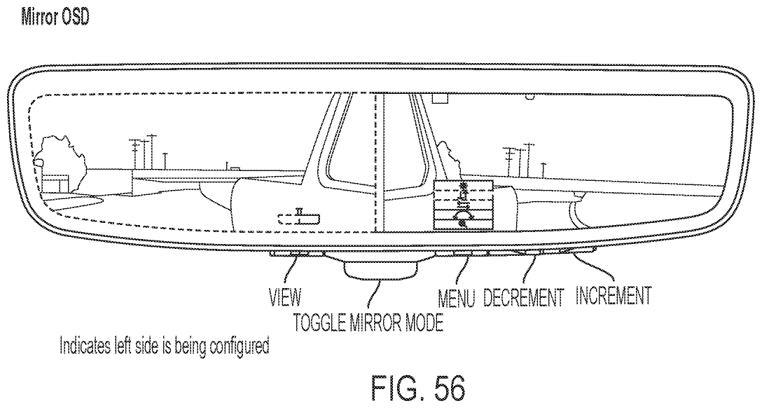

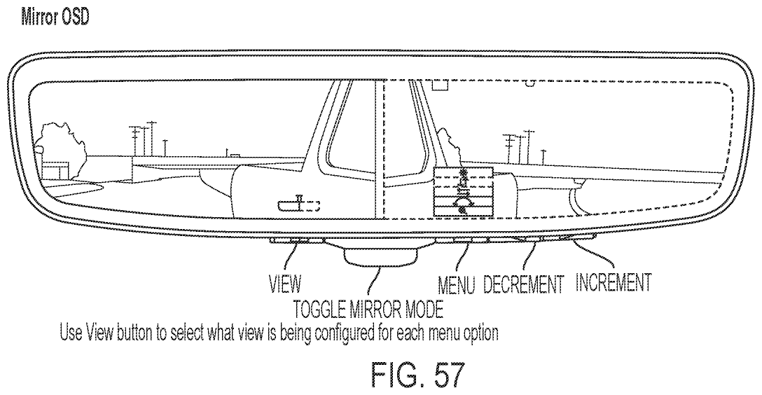

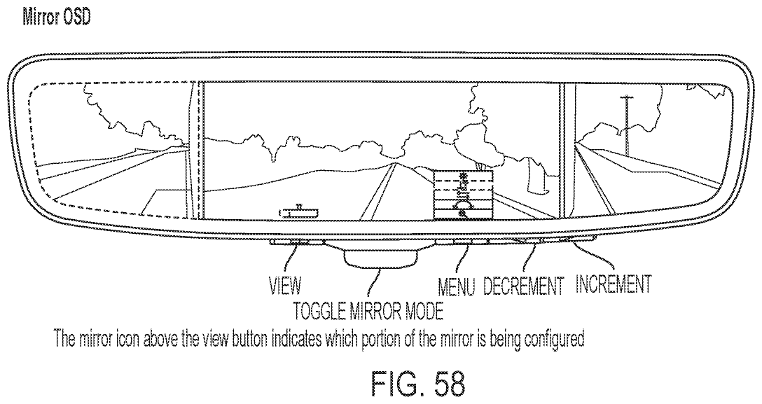

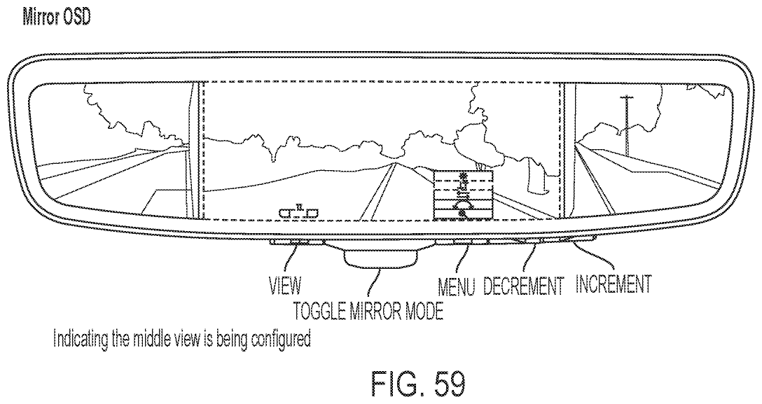

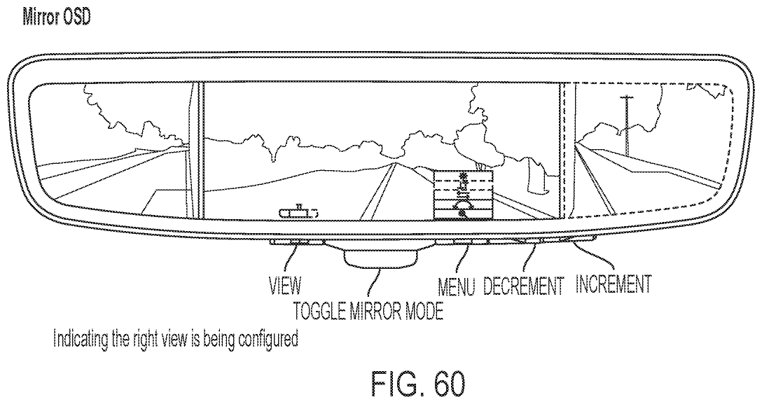

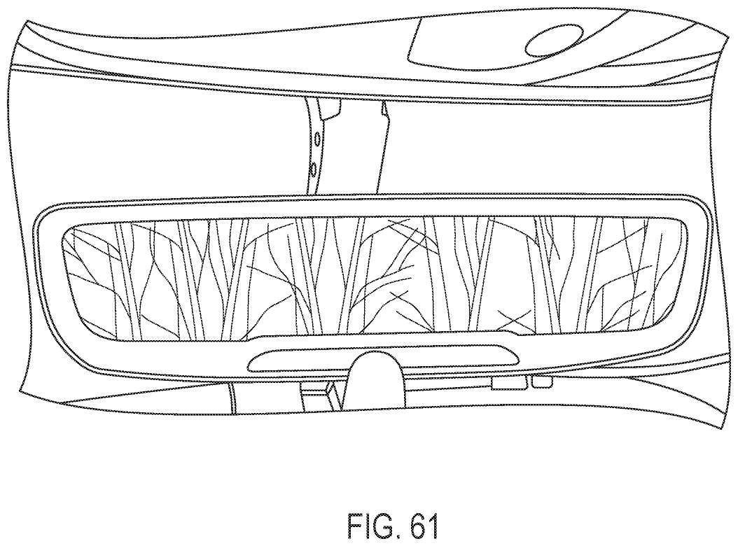

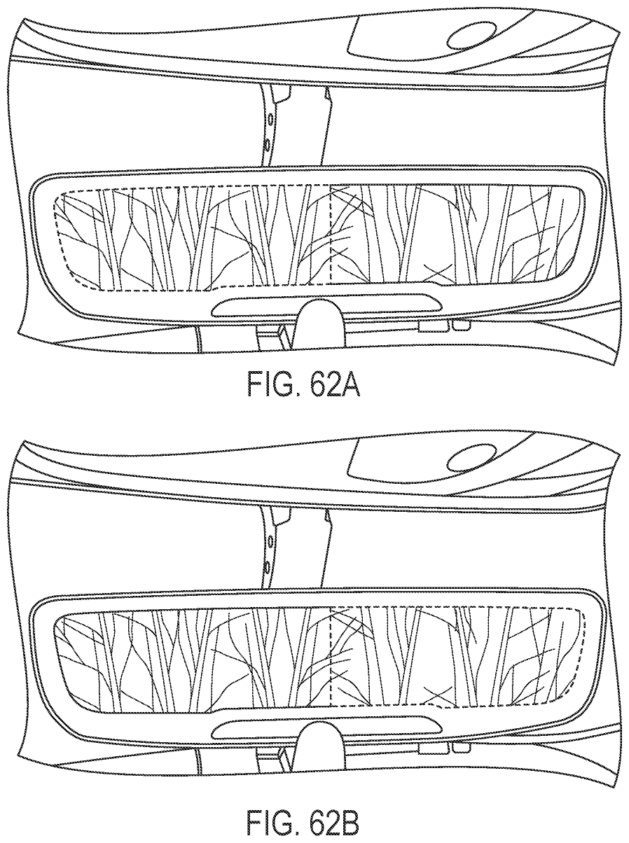

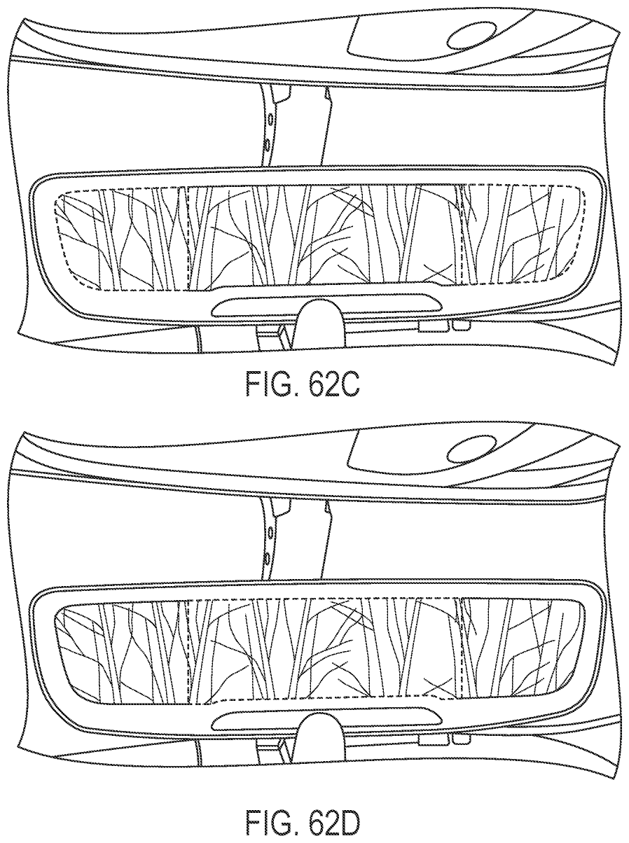

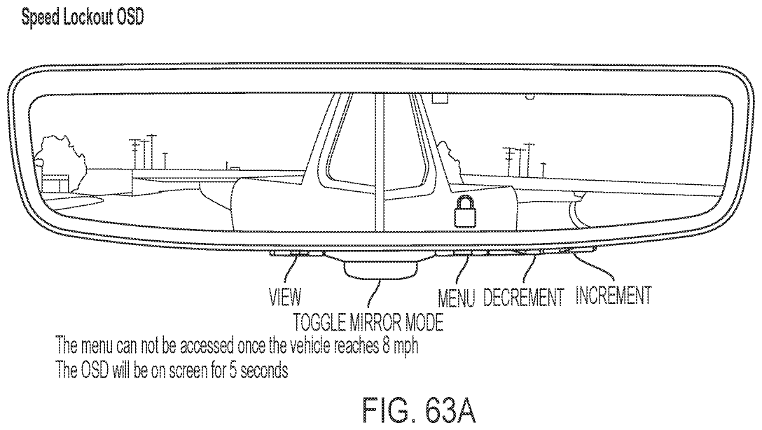

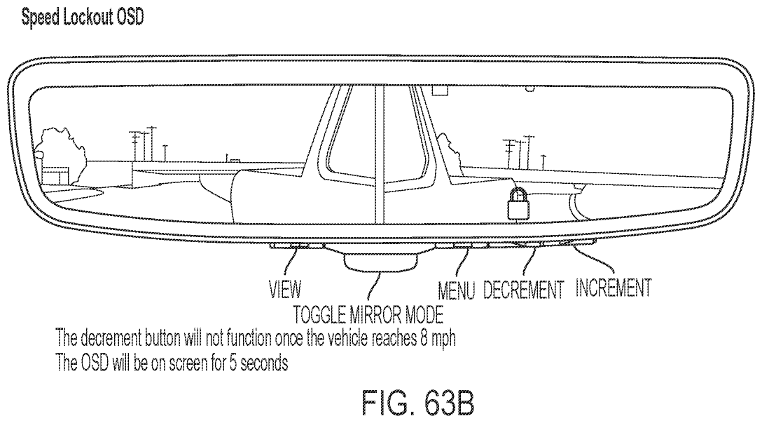

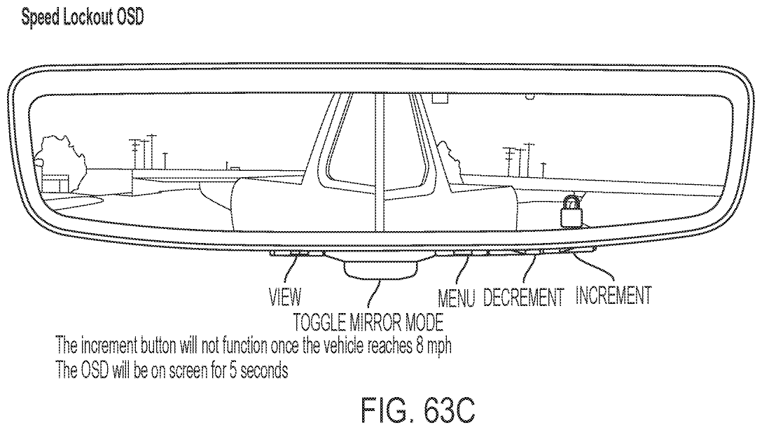

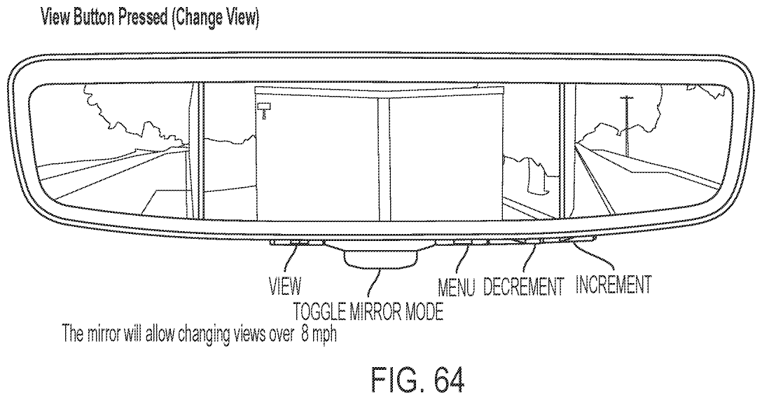

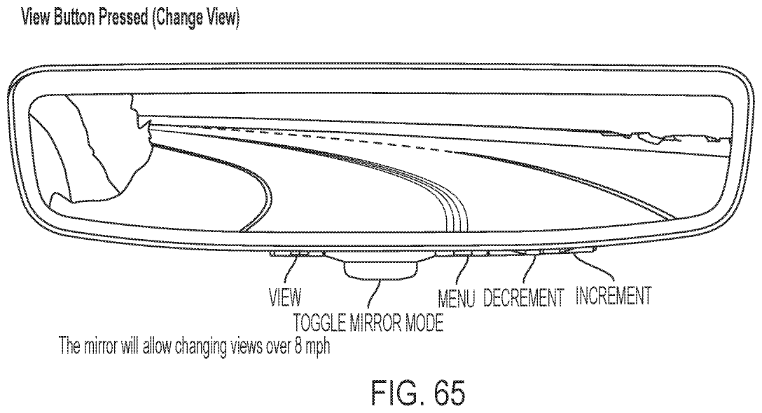

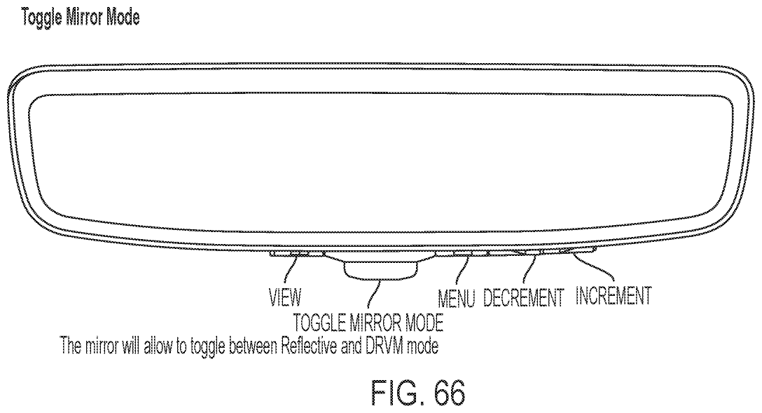

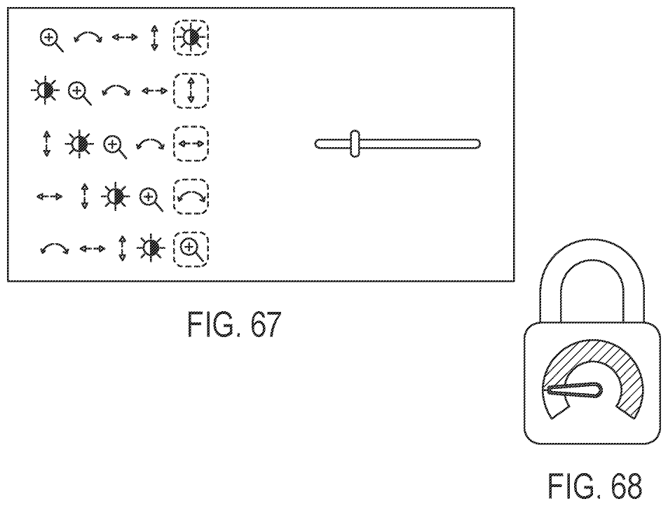

During operation, the user (e.g., the driver of the vehicle or a passenger of the vehicle) may adjust the mirror display to provide the desired video images. For example, the mirror display may provide user inputs or buttons that allow the user to change the displayed view(s), change display intensity, zoom in/out, pan left/right, pan up/down, roll left right or the like (see FIG. 7). With reference to FIGS. 5-66, the mirror includes a toggle or electric actuator that allows the user to turn on the video display mode or switch to the mirror mode. When in the video display mode, the user may actuate a “View” button to select the desired view mode. For example, the user may select (via operation of a view or vision selection user input or button or touch or proximity sensor) a single camera (e.g., the rearward-viewing (e.g., CHMSL-mounted) vehicle camera or the rearward-viewing trailer camera) view (see FIGS. 4A and 6-15), a dual camera (e.g., side vehicle cameras) view (see FIGS. 4B and 17-30) or a three camera (e.g., side vehicle cameras and rearward-viewing vehicle or trailer camera) view (see FIGS. 4C and 32-50). Optionally, the user may actuate the view or image selector or view or image selection or vision selection button or input to select a trailer tow camera view or an interior trailer camera view.

Responsive to selection by the driver of a particular viewing mode (single camera, dual camera, three camera) when the mirror is operating in the display mode, the ECU provides the video images or data to the mirror assembly (via the coaxial cable) for that view. In other words, when the dual display mode is selected, the ECU provides the left-side video image data and the right-side video image data (derived from image data captured by the side rearward-viewing vehicle cameras and provided to the ECU) for display of left-side video images and right-side video images at the left-side region of the video mirror display screen and at the right-side region of the video mirror display screen, respectively. The ECU thus provides the appropriate or selected video images or data for display at the video mirror display screen via the single coaxial cable connecting the ECU to the mirror assembly (with the mirror/display mode toggle and the view selection inputs or signals being provided from the mirror to the ECU via the single coaxial cable connecting the ECU to the mirror assembly).

The user actuatable buttons or switches thus allow the driver to select (i) a single image display of video images derived from image data captured by the rearward-viewing CMS camera 15c, (ii) a dual image display of video images derived from image data captured by the side rearward-viewing CMS cameras 15a, 15b (with the video images derived from image data captured by the left-side camera displayed at a left side of the video display screen and the video images derived from image data captured by the right-side camera displayed at a right side of the video display screen), and (iii) a three image or multi-image display of video images derived from image data captured by the rearward-viewing CMS camera 15c and the side rearward-viewing CMS cameras 15a, 15b (with the video images derived from image data captured by the left-side camera displayed at a left side of the video display screen, the video images derived from image data captured by the rear camera 15c displayed at a center region of the video display screen and the video images derived from image data captured by the right-side camera displayed at a right side of the video display screen). Operation of the vision selection input or image display selector may also provide an interior trailer camera view, if the trailer is so equipped. Optionally, when transitioning between the different views (single camera, dual camera, three camera), the display screen may show a black or dark screen for a short period of time (e.g., one second or less) before switching to the newly selected view/mode (see FIG. 16). The display screen may provide transition graphics or additional icons to indicate when the display is transitioning from one view to another.

When in the selected view mode (single camera, dual cameras, three cameras), the user may select a “Menu” input to select a particular characteristic to adjust the characteristic of the video images being displayed by the video mirror display screen. FIGS. 5-50 show how the features are controlled via actuation of the user inputs when in each respective display/view mode.

When the dual image display or the multi-image display is selected, the driver can adjust one or more display parameters (e.g., tilt or pan or zoom, or optionally intensity, etc.), and may actuate another of the user actuatable switches to selectively adjust display parameters of each displayed video images independently of the others. When in the dual images or three images or multi-images view, control or adjustment via the user inputs may operate for only one of the displayed images. In other words, the user may increase the zoom of one of the displayed video images and not the other(s) or may tilt one of the displayed video images downward and not the other(s). Optionally, the user may increase the display intensity of one of the displayed video images and not the other(s), or adjustment of the intensity may apply to the overall display images and not independent images. For example, and such as can be seen with reference to FIGS. 17-29, when in the dual image display mode, the driver may actuate the menu button and then the view button to switch from controlling parameters of both displayed images to just one (e.g., the left-side displayed images). Pressing the view selection input or button when in the parameter adjustment mode switches from controlling one displayed image to the other (e.g., from controlling parameters of the left-side displayed images to controlling parameters of the right-side displayed images).

Thus, when the interior rearview mirror assembly is displaying at the video mirror display screen the dual image display of video images, the driver can adjust the tilt or pan or zoom (or intensity) of the left-side displayed image while not adjusting the tilt or pan or zoom (or intensity) of the right-side displayed image (or may adjust the tilt or pan or zoom (or intensity) of the right-side displayed image while not adjusting the tilt or pan or zoom (or intensity) of the left-side displayed image), and when the interior rearview mirror assembly is displaying at the video mirror display screen the three image display of video images, the driver can selectively adjust at least one display parameter of the left-side displayed video images independently of the displayed rear video images and the displayed right-side video images, or can selectively adjust at least one display parameter of the right-side displayed video images independently of the displayed rear video images and the displayed left-side video images, or can selectively adjust at least one display parameter of the rear displayed video images independently of the displayed left-side video images and the displayed right-side video images. Optionally, and such as shown in FIGS. 51-60, the displays may be controlled to indicate which display has been selected by the user for adjustment (e.g., the user may want to dim or zoom the left side images). FIGS. 61-62D show the highlighting or halo effect about the perimeter of the selected displayed images (with the highlighting transitioning from a colored band to a semi-transparent and then transparent band as it transitions toward the displayed image), which may selected via toggling the view button. When in the three-image display, the two side images may be adjusted independently (see FIGS. 58 and 60) or may be adjusted together (see FIG. 62C).

Optionally, and such as shown in FIGS. 63A-63C, the display system has a speed lockout on-screen display (OSD), which indicates to the user when certain functions (e.g., menu functions) cannot be accessed (e.g., when the vehicle is traveling at or above 8 mph). The OSD indication may appear above the button that is being actuated when above the threshold speed (or may appear at an upper corner of the mirror reflective element). The mirror display may allow for view changes even at speeds where the menu functions are locked out (see FIGS. 64 and 65), and may allow the mirror to be toggled between the reflective mode and the display mode at any speed (see FIG. 66). As shown in FIG. 64, the center rear image may be of a trailer being towed by the vehicle, or optionally, the center rear image may be provided by a trailer-mounted camera disposed at the rear of the trailer and viewing rearward of the trailer.

The cameras may have a respective field of view that spans at least about 40 degrees vertically and at least about 55 degrees or 60 degrees horizontally. The displayed images are derived from only a portion or subset of the captured image data, and may provide displayed images that span about 10 degrees vertically and about 50 degrees horizontally. This allows the system to adjust the displayed images to various configurations within the overall captured image data. For example, the system may allow for selective (selected by the driver) or automatic adjustments of the displayed images, such as by adjusting tilt angle, horizontal panning, vertical panning and/or zooming in/out. The system may provide various field of view modes, including pan, tilt, roll, zoom, as well as graphical overlays and graphical icons.

The vision system thus provides a video display that receives images or inputs from multiple cameras of the vehicle (and optionally from a trailer as well). The inputs may be provided from the rearward-viewing camera or may be provided from a remote electronic control unit (ECU) that is separate and remote from the video display. For example, the vehicular rearview camera may electrically connect to the video mirror display via a first coaxial cable, while the side cameras and the trailer camera may electrically connect to a remote ECU, which electrically connects to the video mirror display via a second coaxial cable. The mirror includes a mirror ECU that receives inputs via the coaxial cables and provides the displayed video images and that controls dimming of the electrochromic mirror element and the display backlight control. The remote ECU receives inputs from the trailer camera (which may be an analog-HD camera or which may comprise a digital camera) and from the side cameras and provides the combined video image data to the mirror for display. Thus, a vehicle (such as a pickup truck as shown) may be equipped with three digital cameras, and with an ECU disposed in the vehicle (such as, for example, under a vehicle seat or the like). The three cameras connect with the ECU via respective coaxial cables, and the ECU electrically connects with the mirror display with a coaxial cable (with associated serializers and deserializers).

Thus, the system provides a three camera input system (or four if a trailer camera is implemented when a camera-equipped trailer is hitched to the vehicle), which can show live video feeds from one, two or three cameras. One or more display parameters of each view can be adjusted independently with the selected functions (pan up/down, pan left/right, rotate, zoom). The display may indicate which of the views or images is being adjusted. For example, the display may use a color outline or halo that may be partially transparent (such as 50 percent transparent) around the view that is being actively edited. The outline color may transition from 50 percent transparency to 100 percent transparency towards the inside of the view (see FIGS. 61-62D). The color outline may be larger than the viewable area, in order to minimize the potential to observe the graphic as m is-aligned between the artificial outline and the mechanical border. Optionally, the output areas that are not being edited may be dimmed or shaded, or the area or image that is being edited may be highlighted or brightened. A “page select” or radio button graphic may be used to indicate which output area is being edited, or a small mirror icon may be used with the appropriate area shown as yellow (or otherwise colored or highlighted).

The menu and notification interfaces help the vehicle operator configure, adjust and interact with the multi camera video mirror system. The system has a remote electronic control unit (ECU) that is separate and remote form the rearview mirror (e.g., under a seat of the vehicle). The ECU is supplied with vehicle power, has upwards of four digital camera inputs and is connected to the video mirror through a single coaxial cable. The ECU performs all of the image processing of the digital camera signals and then merges multiple camera images together into a single real time composite image with tiled regions from different cameras. The ECU also creates and superimposes high quality graphics into the tiled composite image. The video image data created in the ECU is transmitted over the single coaxial cable to the mirror where video images derived from the provided video image data from the ECU are displayed on a TFT LCD screen with a powerful backlight. The display comprises a free form display (it is not rectangular) that corresponds with the profile of the mirror reflective element and that is slightly smaller than the mirror glass but with an active area that is similar in shape and size to that of the mirror glass. The video mirror head may include mechanical inputs or buttons (e.g., four buttons along the lower part of the mirror head) or may include touch or proximity sensors (disposed along the lower part of the mirror head or reflective element), forward and rearward photo sensors, a manually actuated flip style mirror tilting mechanism to reduce reflections to the driver when the mirror is operating in the video mode, an electrochromic (EC) variable dimming reflective mirror element, vehicle power and a LIN bus communication link to the vehicle. The rearward (or glare light) photosensors may be disposed at a rearward part of the mirror head, or optionally the toggle portion (that is grasped and toggled by the user) may comprise a light pipe that guides light incident at the lower/rearward end of the toggle portion to one or more photosensors within the mirror head. The ECU and the video mirror communicate with each other using a SERDES link, which allows both video and bidirectional communication to take place over the single coaxial cable.

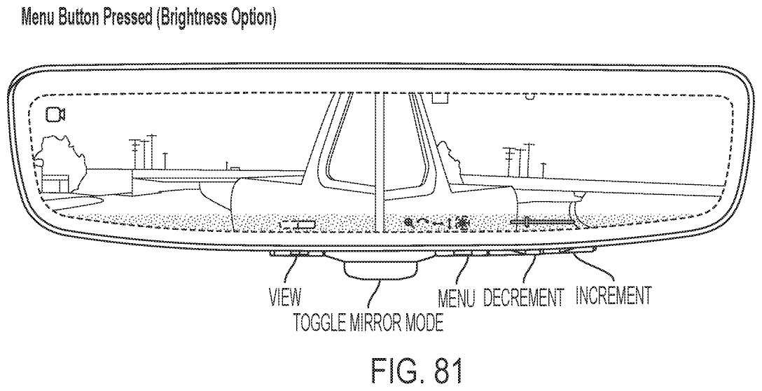

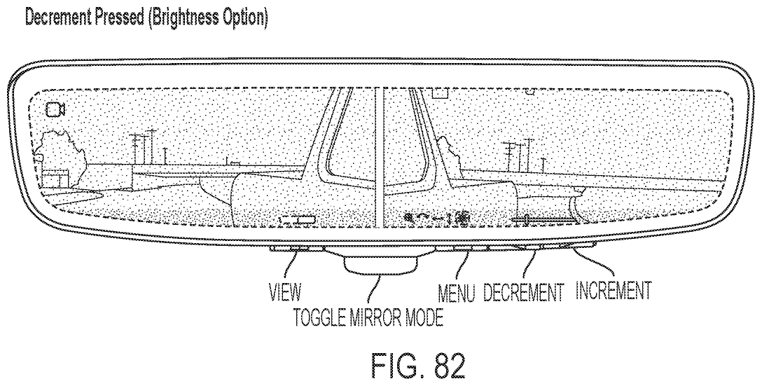

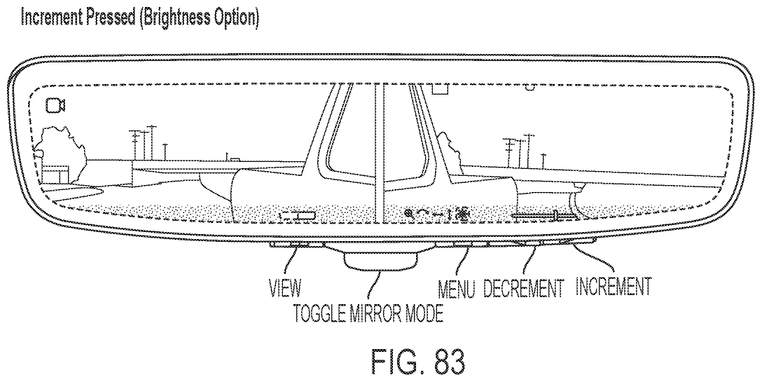

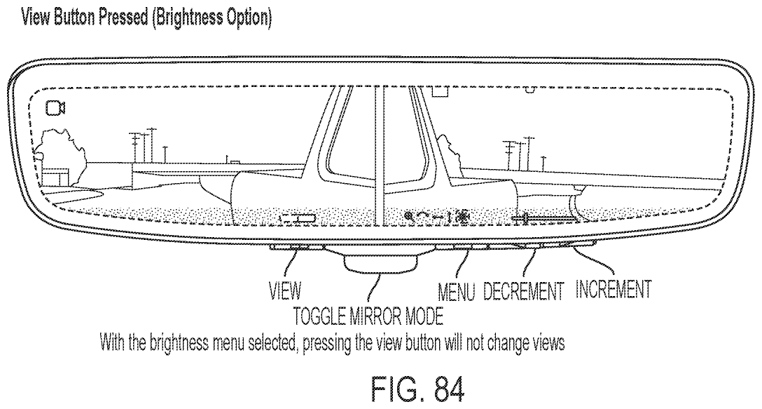

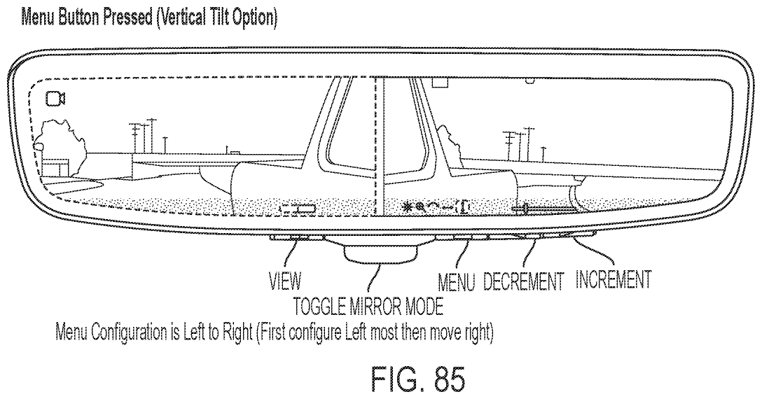

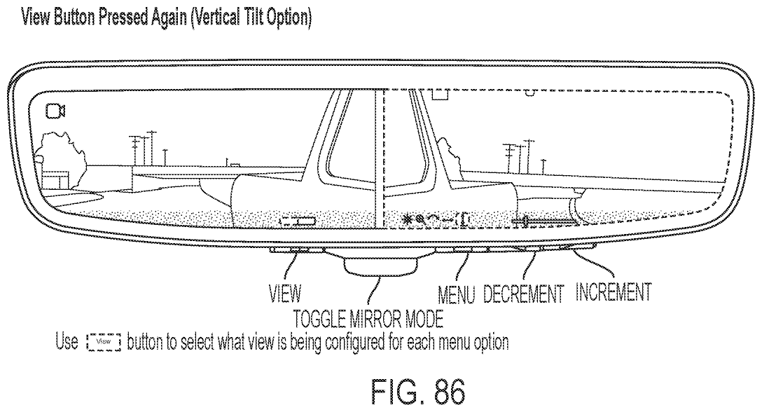

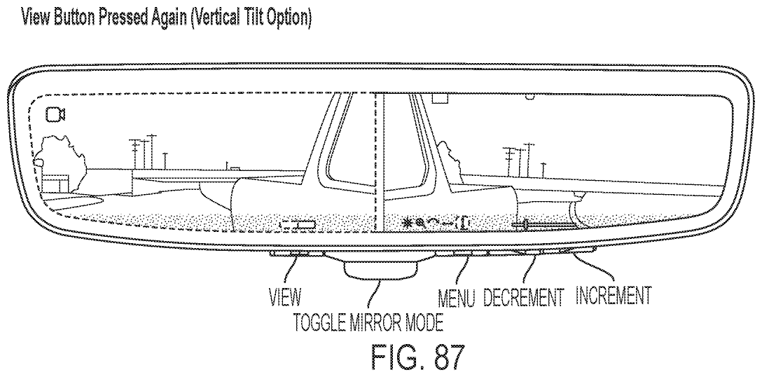

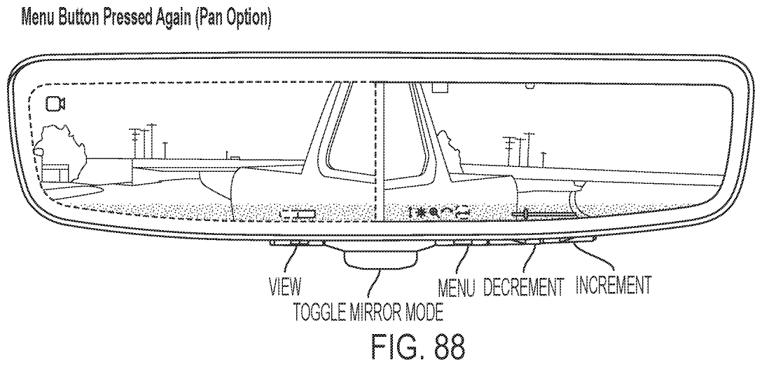

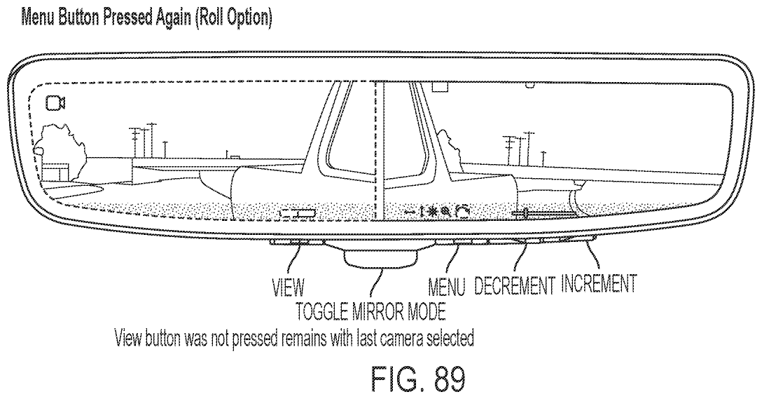

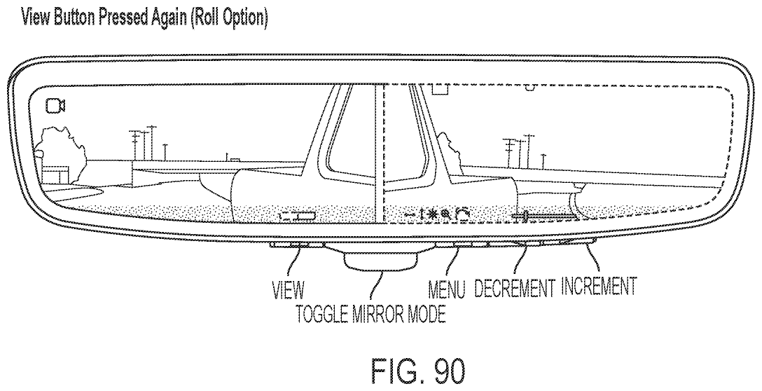

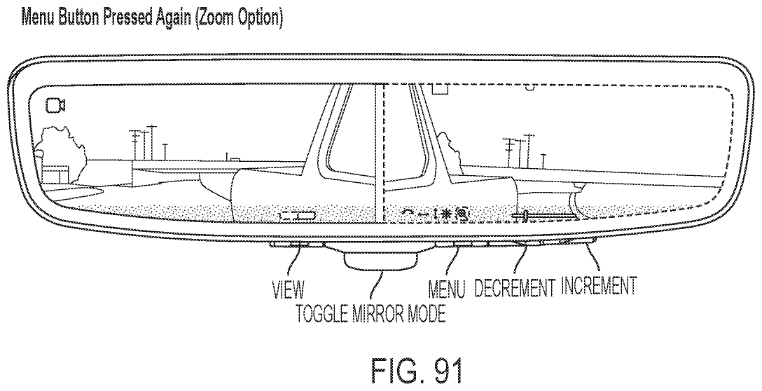

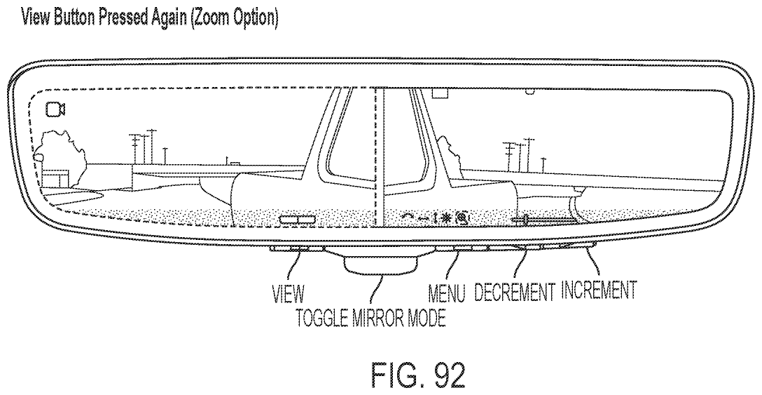

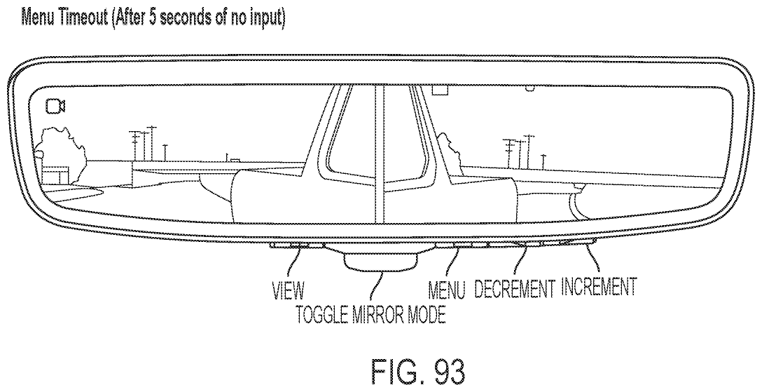

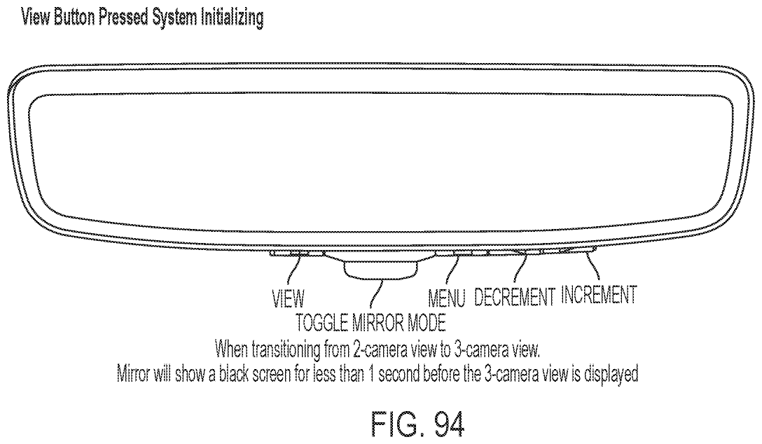

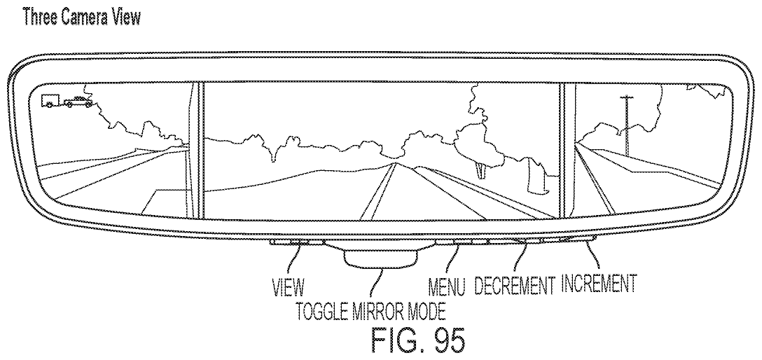

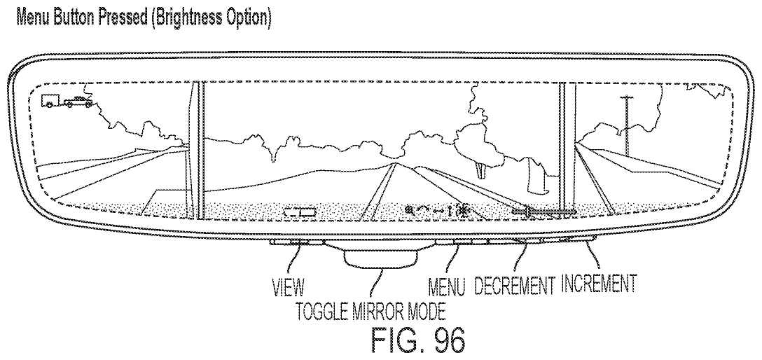

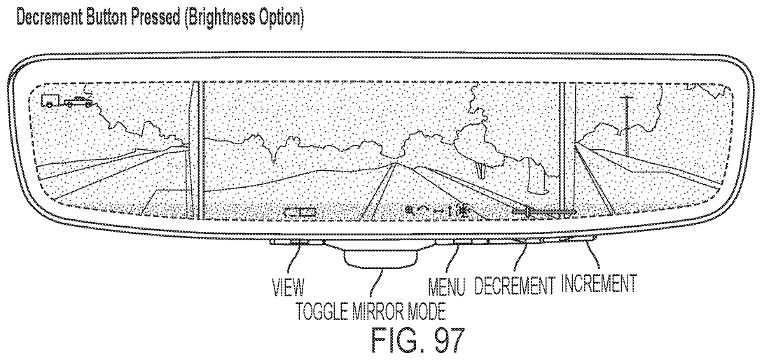

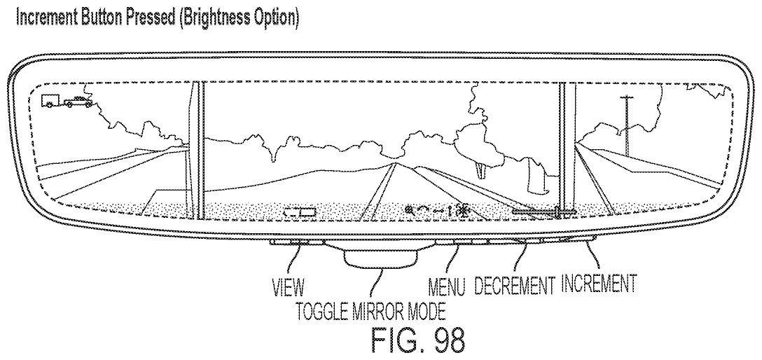

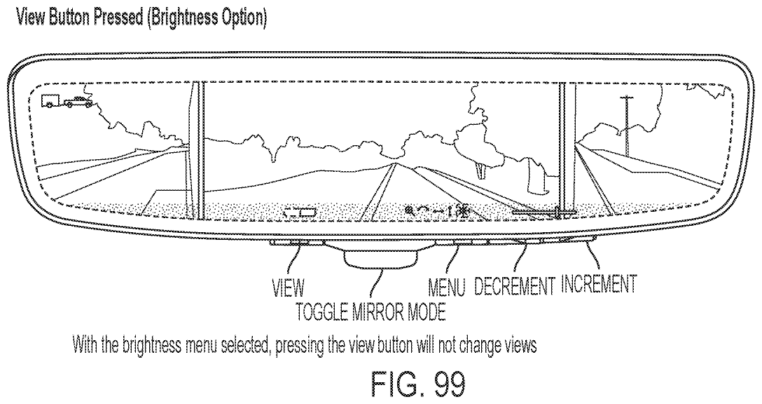

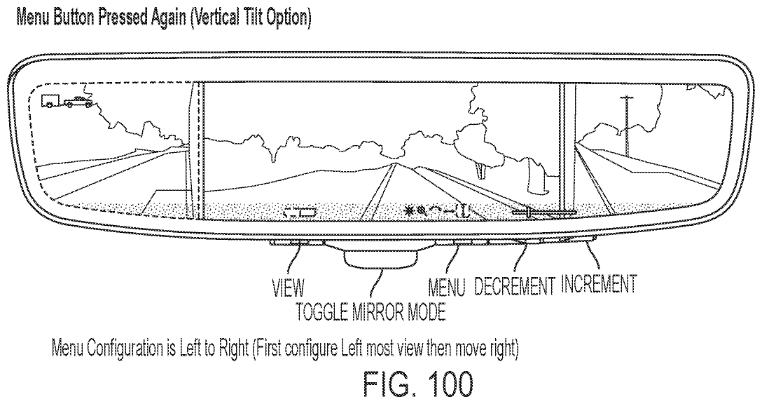

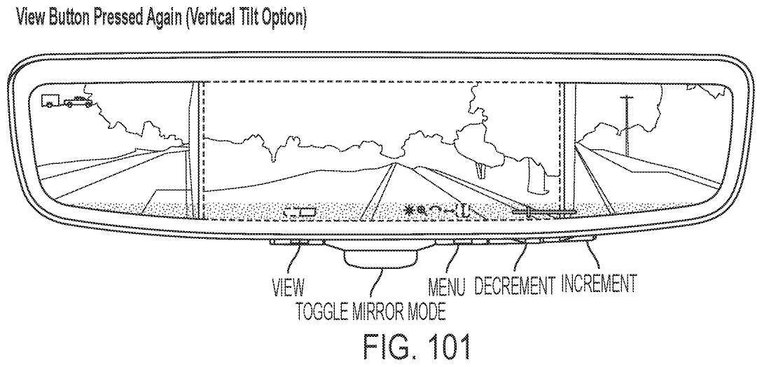

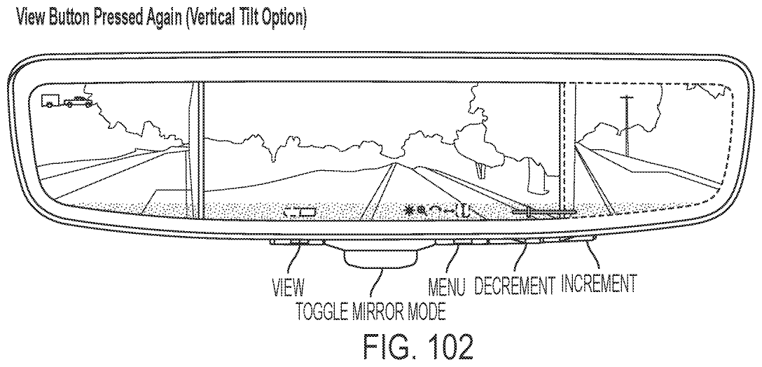

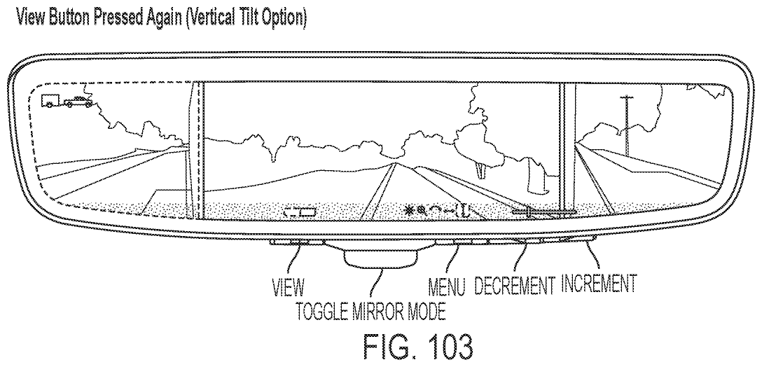

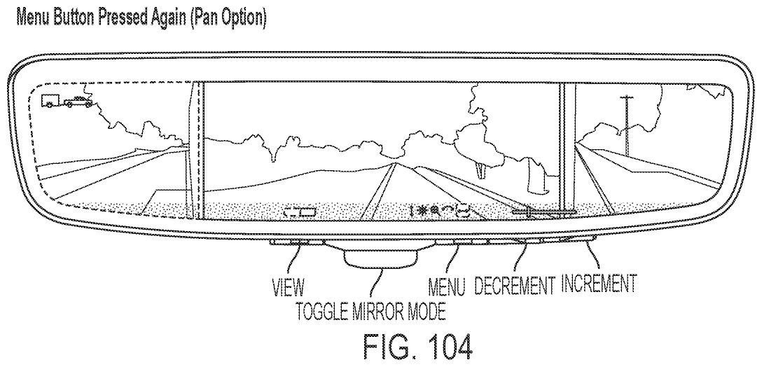

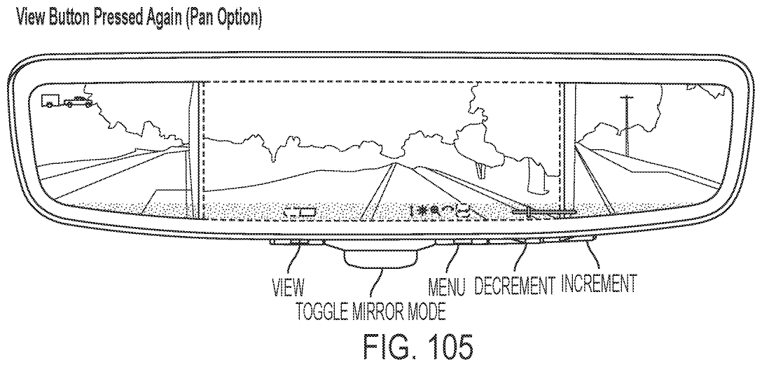

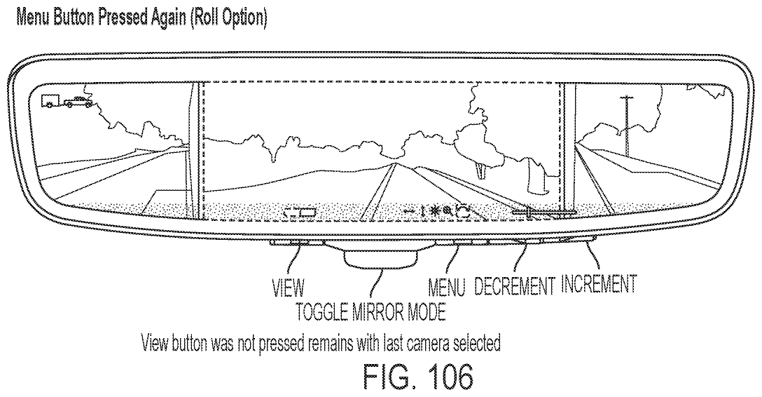

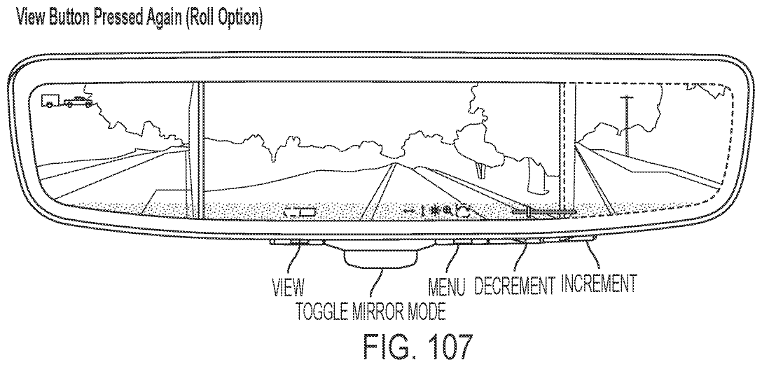

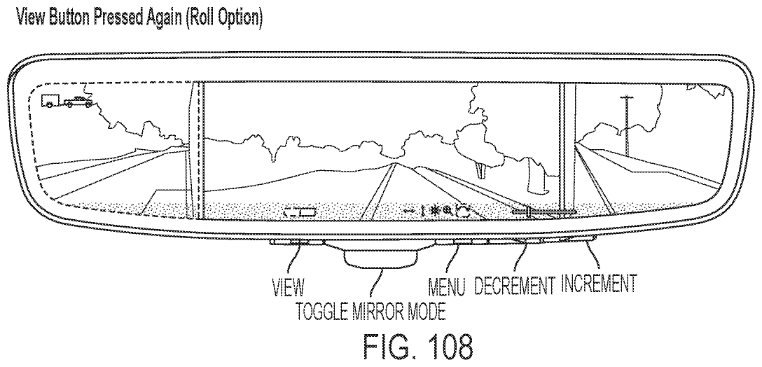

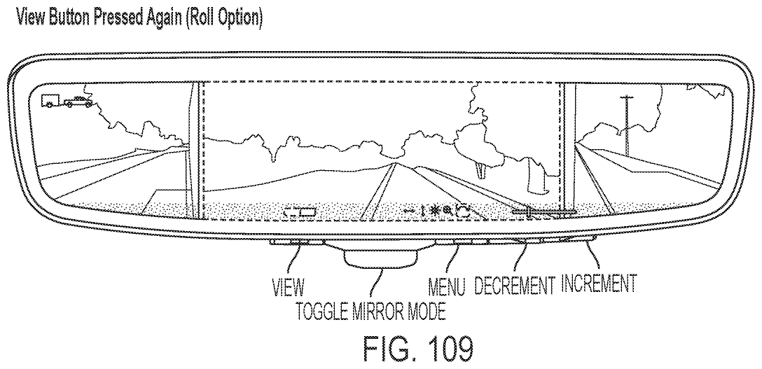

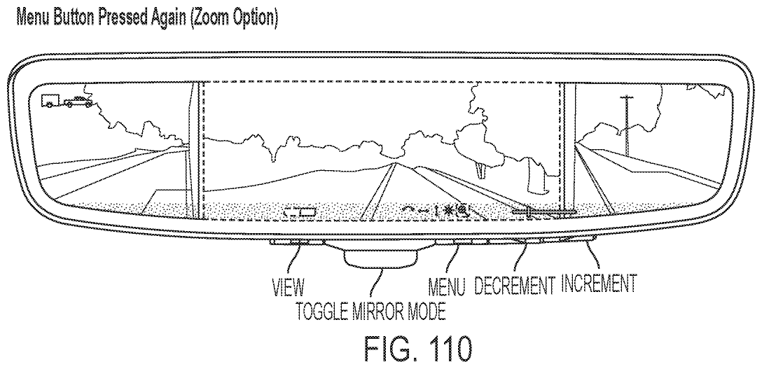

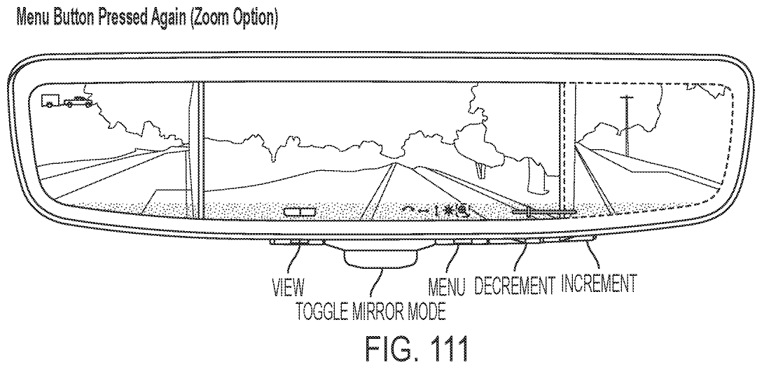

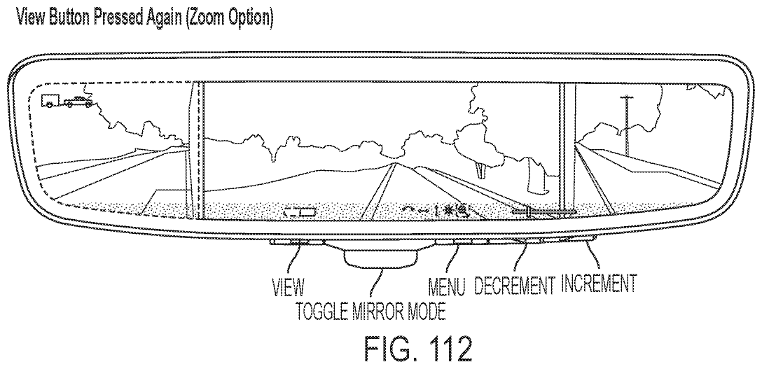

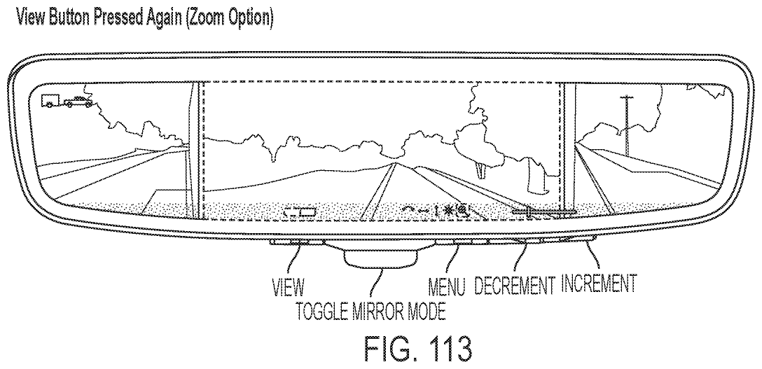

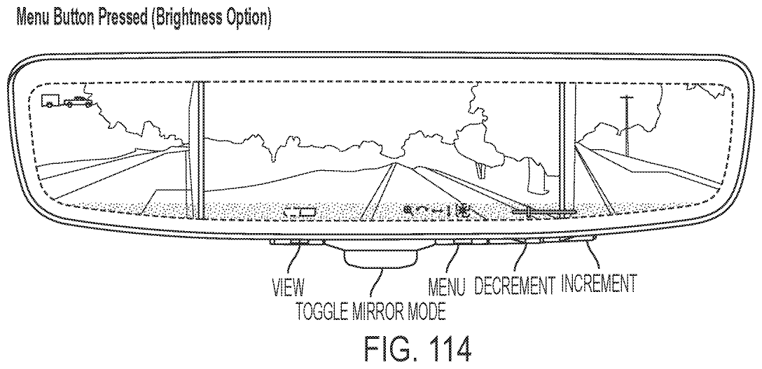

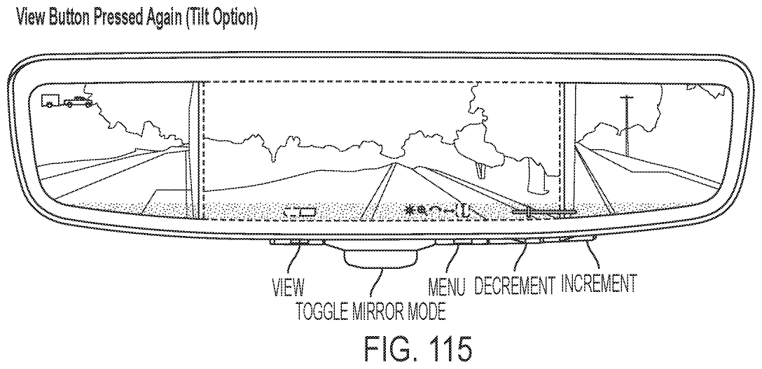

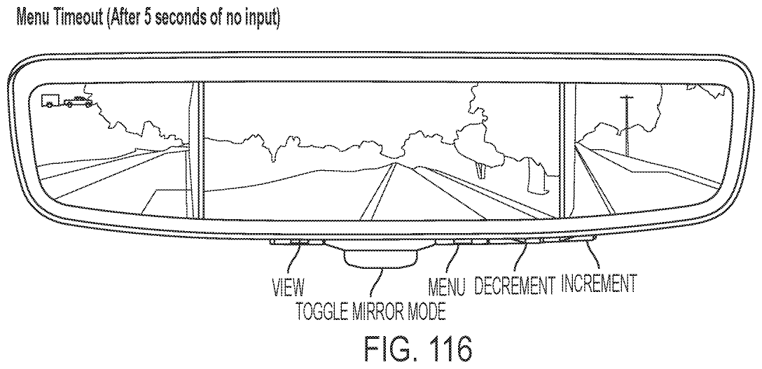

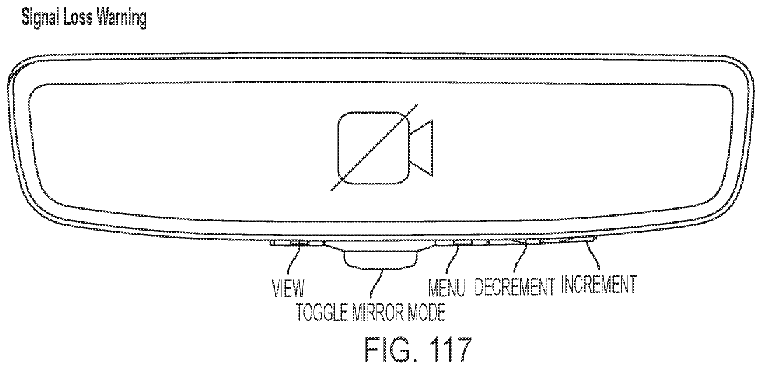

The video mirror system can simultaneously display one, two or three camera images on the display. Each image can be controlled through horizontal pan, vertical pan, rotation and zoom. Brightness or intensity may be controlled globally for the entire display region (see, for example, FIGS. 81-84), while the pan, tilt, rotation and zoom can be individually controlled for each displayed image (see, for example, FIGS. 85-92). The brightness control allows the user to adjust the displays automatic intensity adjustment to their liking. The video mirror may use a combination of forward and rearward photosensor signals in conjunction with light information available from one or more of the cameras to automatically adjust the display intensity to the proper level for that lighting environment (e.g., LIN or CAN provided dimming information). The user can influence the display backlight intensity through the user interface brightness menu to influence how the various sensor signals are used to create the automatic intensity function. The system applies a scaling factor to the output of the automatic intensity function but other more complicated approaches are also possible. The automatic intensity algorithm controls the PWM and level of current to the backlighting LEDs. The user can influence the automatic intensity control output such that it maintains the response curve shape but applies a scaling factor to reduce (or increase) the light output from the backlighting LEDs.

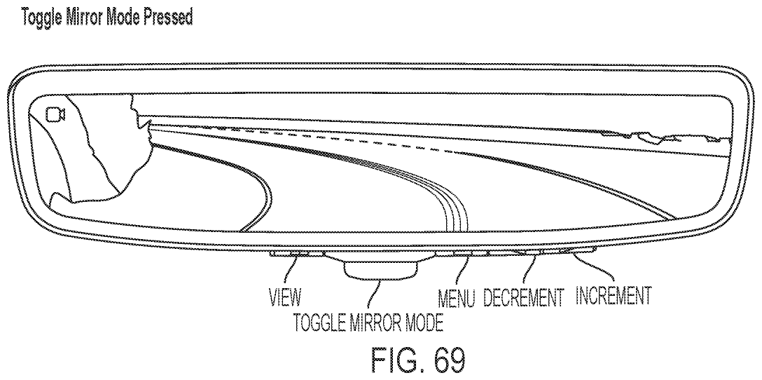

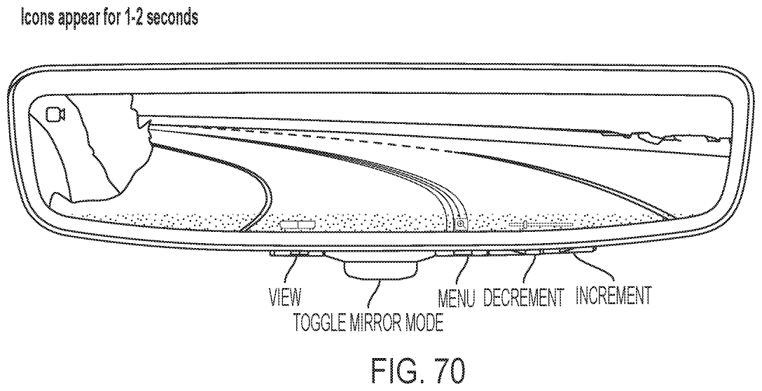

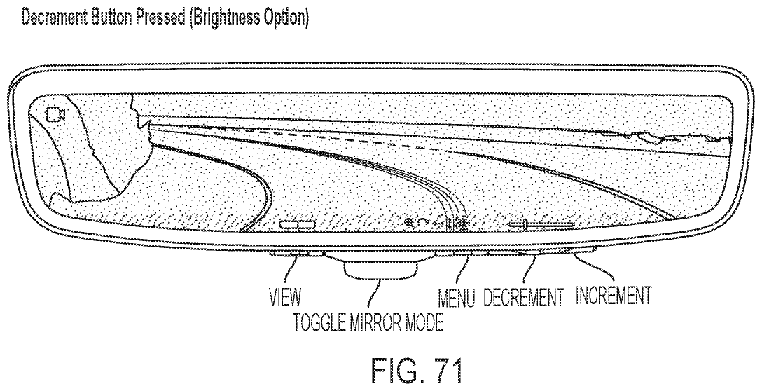

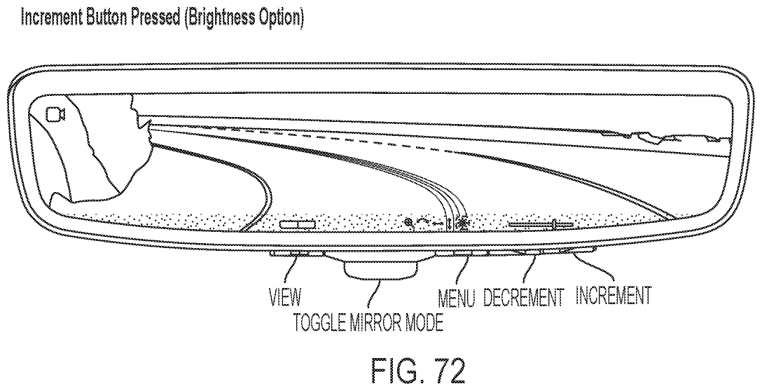

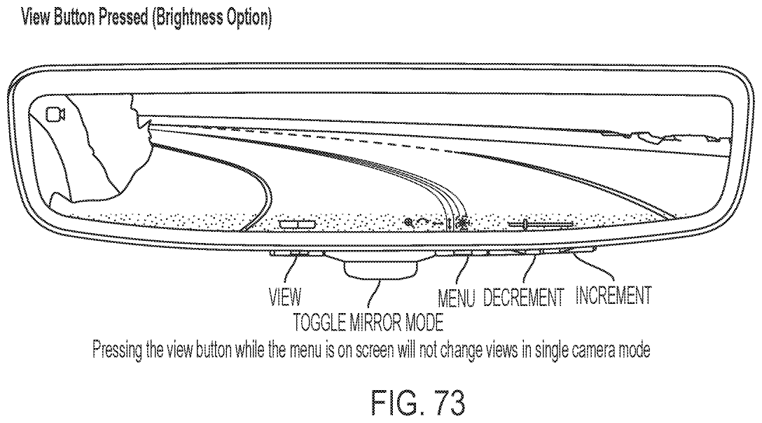

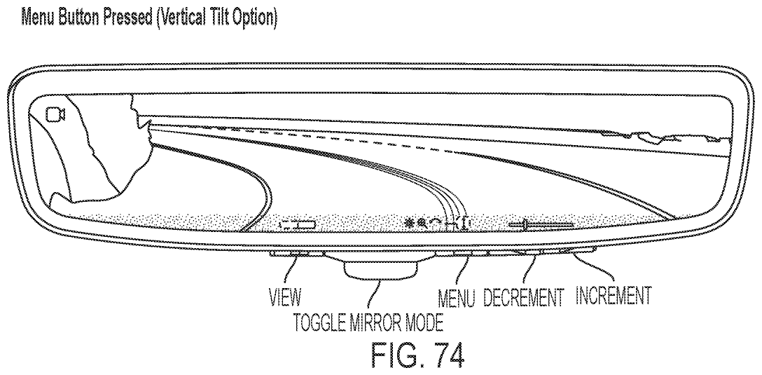

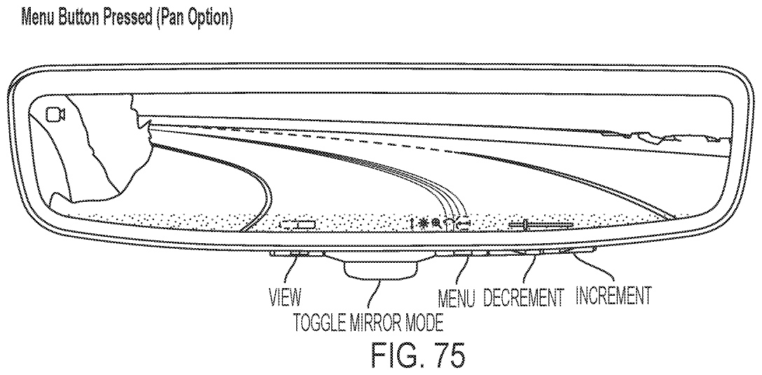

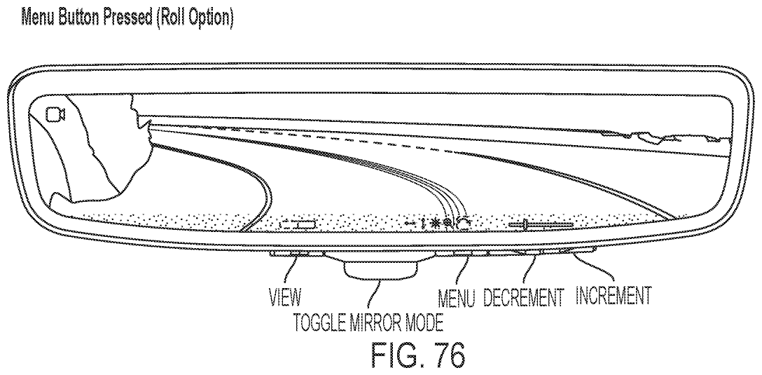

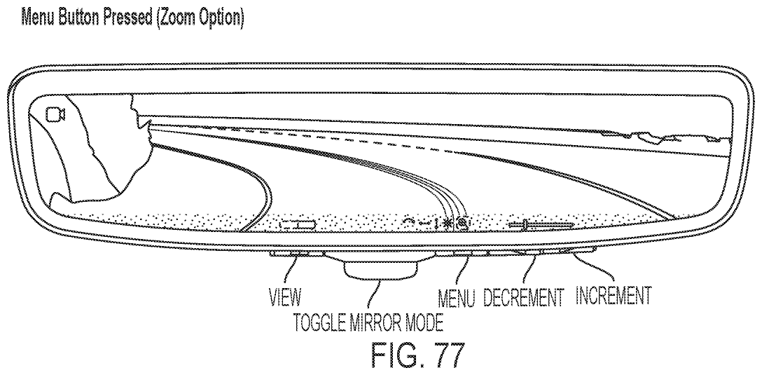

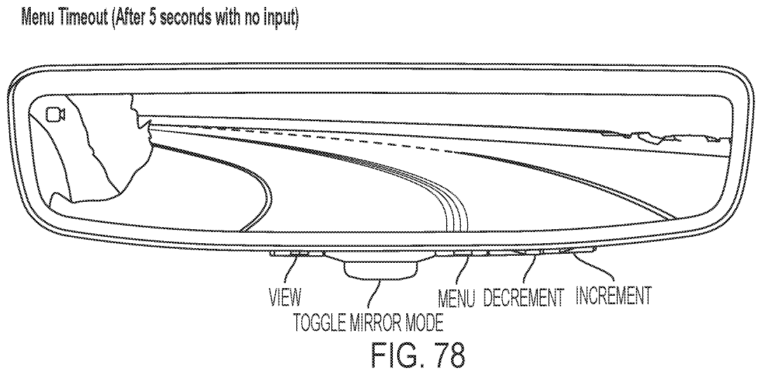

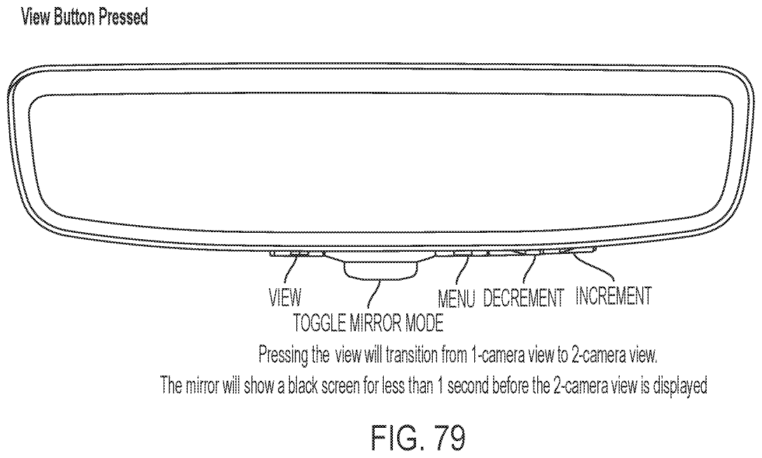

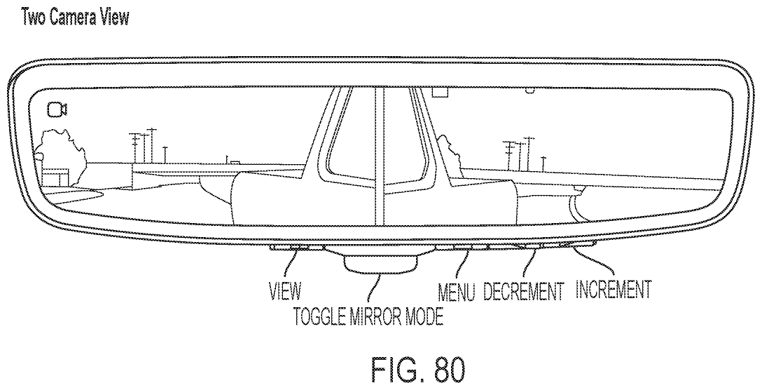

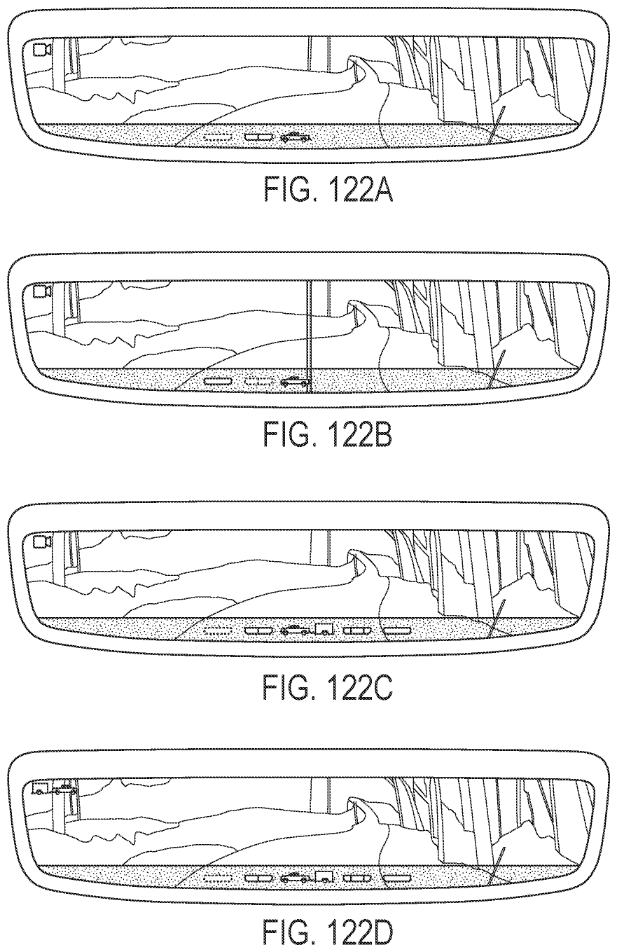

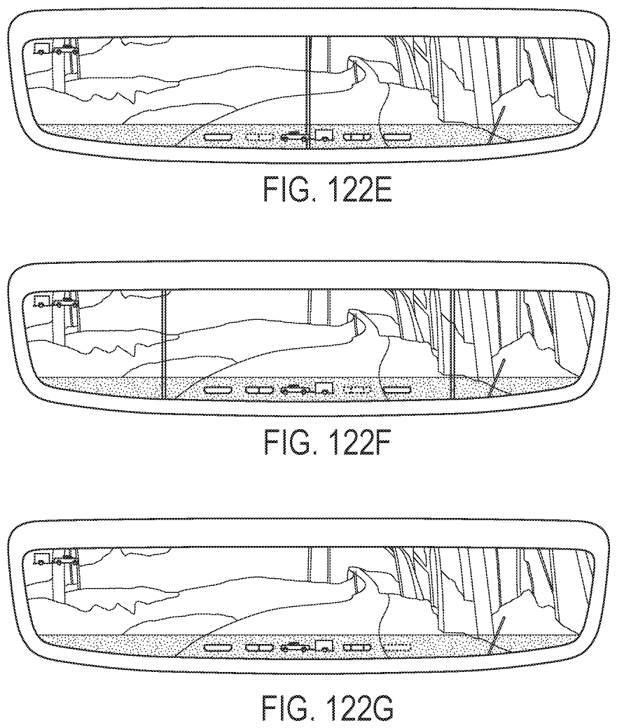

The HMI graphics are used in conjunction with three or four buttons to control the image selection and user fine tuning. All the graphics are changed in real time in response to button presses. Some of the graphics are opaque and others have various levels of transparency to allow the user to have the ability to partially see the image behind them (see, for example, the camera icon of FIGS. 69-78 and the camera, truck and trailer icons of FIGS. 122A, 122C, 122D, 123C and 123D). This transparency feature uses alpha blending of the graphic and of the camera image in real time on a frame-by-frame basis. A black transparent gradient is provided at the menu areas to help control the contrast of the menu content while at the same time allowing the user to see through the menu system, which is important when making user adjustments to individual camera images. The menu and black gradient are animated and scroll up from the bottom of the display (when, for example, the menu button is pressed) to their rest position (see, for example, FIG. 70). The animation of the menu is smooth and different speeds can be used for it entering and leaving the display area. Other animations include blinking graphics by either hard on/off states or through fast ramp up and down of the alpha blending applied to the graphics.

The user is given the ability to adjust pan/tilt/roll/zoom for each camera image in the image tiled side-by-side or split screen format display (where the two or three video images are displayed horizontally tiled side-by-side one another across the video display screen). The user also can choose if a single camera, two cameras (split view, with two images horizontally tiled side-by-side one another, such as with each displayed image spanning about half of the video display screen), or three cameras (tri-view, with three images horizontally tiled side-by-side one another, where each displayed image may span about a third of the video display screen or preferably where the center displayed image may span a greater amount of the video display screen and the two side displayed images span a lesser amount, such as a third, of the video display screen) will be displayed. If no trailer is attached, the user may only select between the single camera view and the split view, but optionally the tri-view may be available without a trailer camera (i.e., when no trailer is hitched to the vehicle) depending on the particular application and vehicle manufacturer selections. When a trailer (having a trailer camera) is hitched to the vehicle, the user can select the tri-view, with the center image being derived from image data captured by the trailer camera. The image data captured by the trailer camera is communicated to the ECU via the trailer wire harness connector at the rear of the vehicle.

The user can also select which single camera of the four cameras will be shown in the single view. Typically, the split view is created from the cameras in the driver side and passenger side outside mirror heads. The outer tiles of the tri-view are usually created from the cameras in the driver side and passenger side outside mirrors and the center tile can be from either the center high mounted stop light (CHMSL) camera or (with a trailer hitched to the vehicle) from a camera mounted on the trailer. Split and tri-view tiles or images are demarked with a black line between them to help make the composite image from various cameras easier to interpret by the driver. The dark or black demarcation lines may be, for example, about 12 pixels wide. If the demarcation lines are too thin, then their effectiveness to clearly separate image tiles is greatly diminished. Drop shadows may be added to graphics that are not placed over a contrast enhancing graphic (black gradient) region. The drop shadow helps to enhance the contrast of the graphic on lighter scenes, such as at the sky and in snow scenes in the displayed video images.

The alpha blended graphics are partially self-adjusting to the image content behind them. If a scene is dark, the display may provide a darker graphic and if the scene is bright, the display may provide a brighter graphic. At the same time, the transparency of the graphic does not totally obscure the image behind it and allows the user to have a partial visual sense of the camera image behind the graphic. Information graphics that are potentially on for long periods while driving (e.g., the camera symbol and the truck/trailer symbol) may be located at the display's corner regions so that they minimize obstruction of the most important portions of the camera images. The icons are shown at the driver side left upper corner of the display screen, but the icons could be located at the upper right corner of the display to minimize obstruction of the rearward image content.

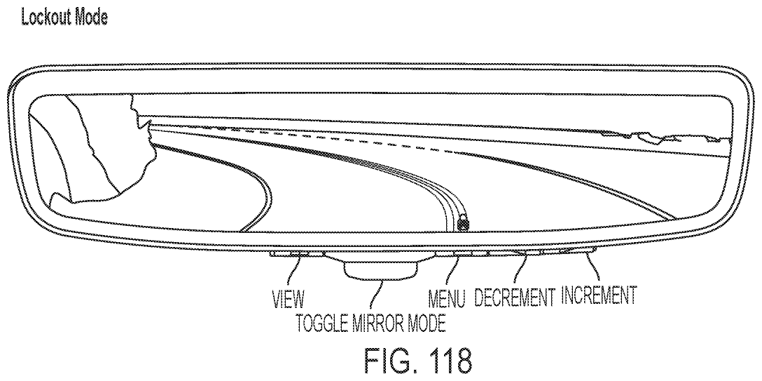

The menus at the bottom of the displayed image(s) are only temporary while the user is using the adjustment/select menus, and after a few seconds of button inactivity the menus will scroll off of the display to allow unimpeded viewing of the camera images. The LIN bus (or CAN bus etc.) communicates vehicle speed to the mirror and when the speed exceeds a threshold speed (e.g., 8 mph or thereabouts), the menu is inhibited and will not operate or allow camera adjustments to minimize distraction of the driver. The view select button will still allow the user to switch between single, split and triple views while the vehicle is moving (since such a change is significantly less distracting from the driving task than making adjustments to individual camera views). If a menu button is pressed when the vehicle is traveling at or above the threshold speed, the button will not initiate the menu but will cause a lock symbol graphic (see, for example, FIGS. 68 and 118) to be momentarily displayed (such as for about 2-5 seconds or blinked 2-3 times) at, for example, the upper left information corner or at the button (e.g., the menu button) that is being actuated by the user.

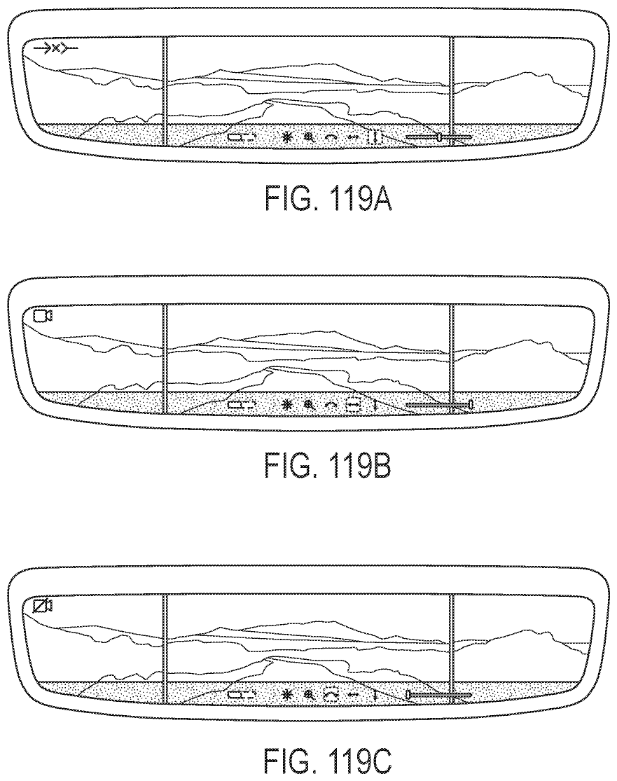

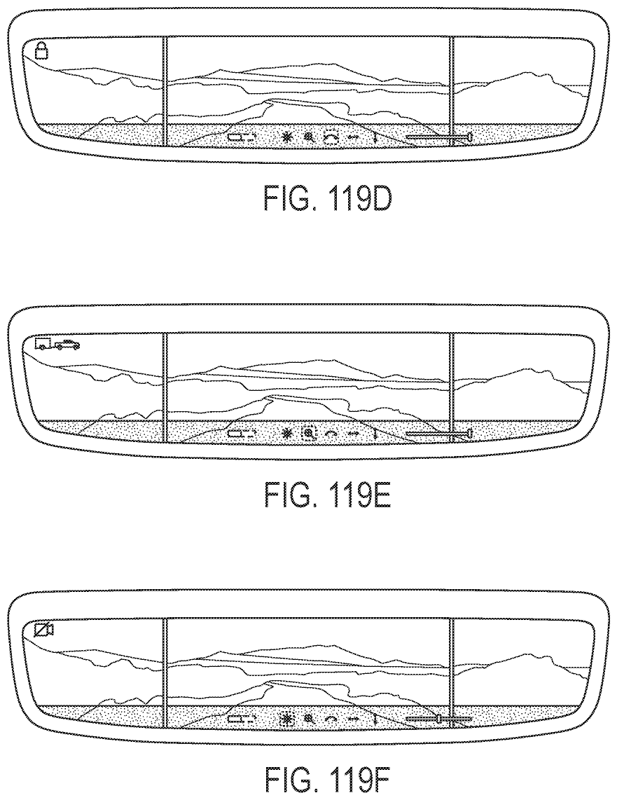

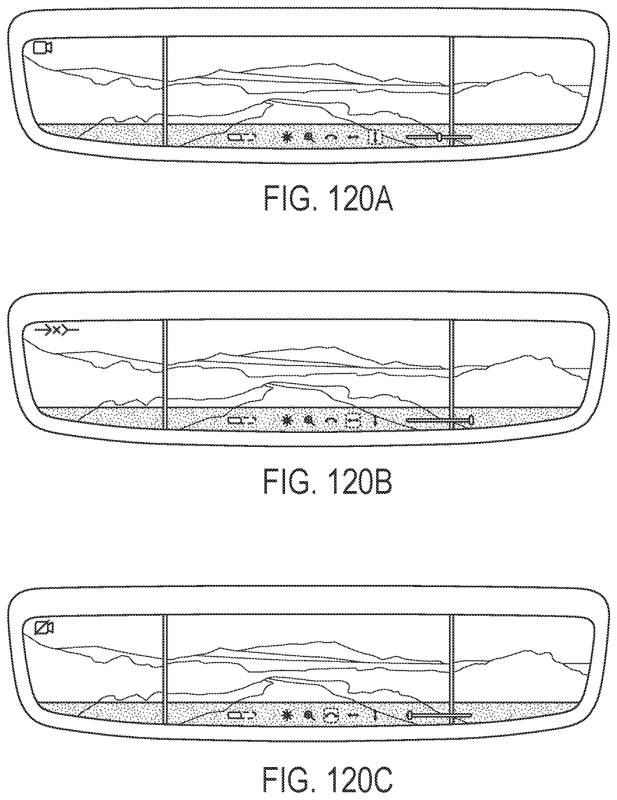

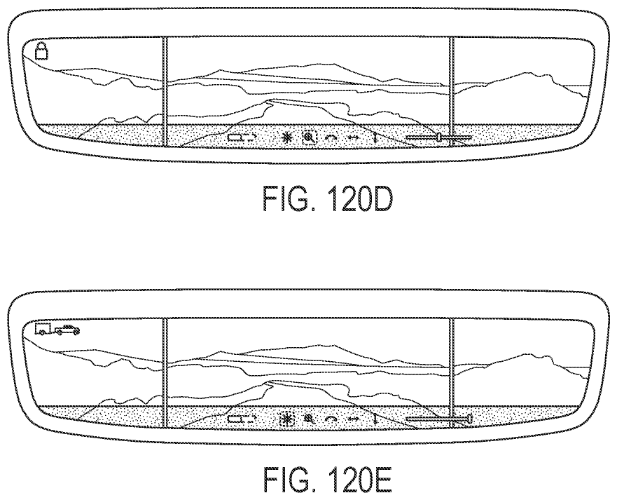

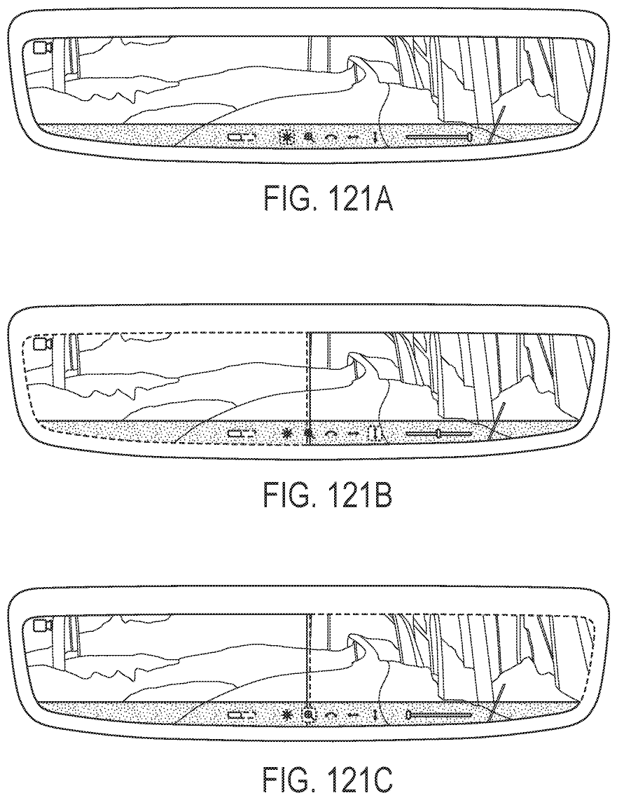

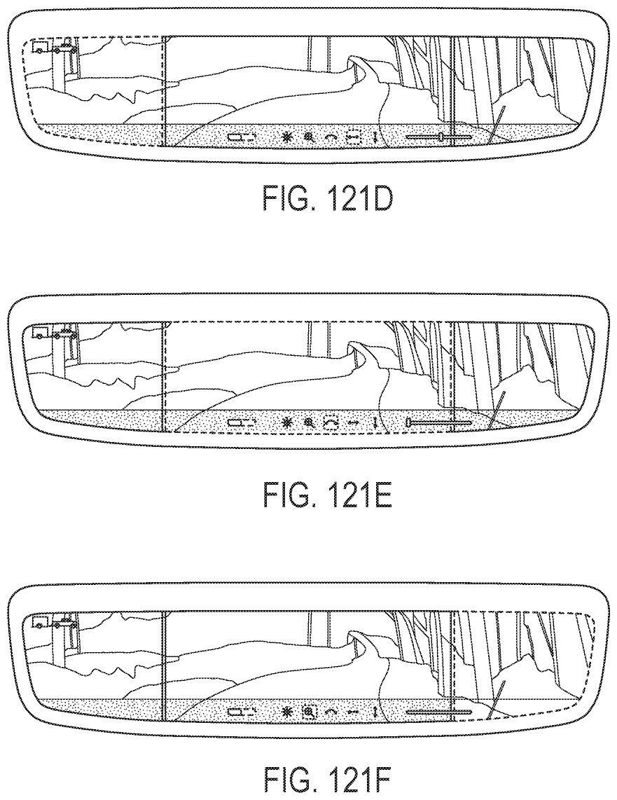

Other graphics or icons may be episodically generated to inform the user of various information. For example, a graphic image with a red X (see, for example, FIG. 119A) may be provided to represent loss of LIN communication with the vehicle and will be shown for a few seconds prior to the digital video function turning off and prompting the user to switch back to reflective mode. The LIN provides important information from the vehicle and if it is unavailable the video display function may be disabled. The camera graphic is a reminder that the system is operating in the digital video mode and not the mirror reflective mode. The camera with a red slash through it (see, for example, FIG. 119C) provides a warning that one or more of the four cameras is disconnected or malfunctioning. The truck trailer graphic (see, for example, FIG. 119E) is displayed to remind the user that a trailer is connected and that the image displayed in the video display is from a perspective of a camera mounted on the trailer, not from the camera mounted at the vehicle's CHMSL.

The upper corner (left or right) information graphic area thus may be used for displaying multiple graphic images that serve to notify the driver of system activity. The corner notification is active when the display system is operational in normal use as well as when there are system complications that may result in degraded operation. The majority of the graphic symbols shown in the notification corner are automatically displayed by the video system. Having the truck/trailer symbol in the upper left corner is a constant reminder to the driver that the vehicle is connected to a trailer and that part or all of the images being displayed in the digital video mirror is/are coming from a camera mounted on the trailer. This corner notification is present as long as the trailer camera is connected to the video system. The menu in the bottom of the mirror display is only visible after pressing the “view” button, and it is designed to be a temporary graphic that helps the driver choose the view he or she would like displayed at the video display. After several seconds of inactivity with the view button, the view menu will deactivate by animated sliding off the bottom of the screen.

The graphic area at the lower portion of the display is the menu display area that aids the operator in using the buttons (e.g., four buttons) at the lower region of the mirror to navigate configuring and adjusting the camera views to meet the driver's preferences or needs. The “view” button is used to select what camera views will be tiled on the video display. The “view select” button is supported by the menu with, for example, a different colored truck and trailer (e.g., a blue truck and an orange trailer). The objective of the “view select menu” is to allow the user to see what image presentations are available to them and then index their way to the desired view option by subsequent presses of the view button. The available image tile options change depending on whether a trailer camera is present when connected to a trailer. If a trailer camera is identified then 2 additional camera tiling options are available (display tiles that contain, for example, trailer-colored (e.g., orange) tiles). In summary, a blue (or other color) truck and cameras mounted on it are linked to the blue tiles in the available view options, and an orange (or other color) trailer and its camera are related to orange tiles in the views available when a trailer/camera system is connected. For example, and as shown in FIGS. 122A and 122B, when no trailer is hitched to the vehicle, the menu icons may show the truck and the two display options (single image and split image) for displaying video images captured by the vehicle cameras (rearward-viewing CHMSL camera and rearward-viewing side mirror cameras). Optionally, the menu items may include optional trailer views even when no trailer is hitched to the vehicle (see FIG. 122C). When a trailer is hitched to the vehicle (see FIGS. 122D-G), the camera icon in the upper corner of the mirror switches to the truck and trailer icon to remind the driver that a trailer is hitched to the vehicle, and the menu includes different colored trailer options (e.g., the trailer in the lower menu may light up in a different color such as, for example, orange). The user may press the view button to toggle through the different views available, including the single camera view based on the vehicle camera (FIG. 122D), which would show the trailer rearward of the vehicle, the split view based on the side vehicle cameras (FIG. 122E), the tri-view based on the side vehicle cameras and the trailer camera (FIG. 122F, with the tri-view icon to the right of the trailer having different colors for the different cameras/tiles, such as, for example, blue side portions that match the blue truck icon and an orange center portion that matches the orange trailer icon), and the single camera view based on the trailer camera (FIG. 122G).

Similarly, FIGS. 123A-F show different view options depending on whether or not the vehicle is towing a trailer, with the tri-view display only available when the vehicle is towing a trailer (see FIG. 123C), and the single and dual views available when the vehicle is towing a trailer (FIGS. 123A and 123B) and when the vehicle is not towing a trailer (FIGS. 123E and 123F). When the single view is selected with the vehicle towing the trailer, the trailer icon may be highlighted (see FIG. 123D) to indicate that the rearward view is based on image data captured by the rearward-viewing trailer camera.

The “menu” input or button initiates adjustment of the current view on the display and this is considered the primary or main menu. Once the user presses the menu button, the user may continue to interact with the main menu system using the view, menu and increment/decrement buttons. While in the main menu mode, a subsequent press of the menu button will index the user to a new control tab. While in the main menu, pressing the view button will index the user to a new available camera tile for adjusting. A yellow gradient line (semitransparent with alpha blending) surrounds the camera tile or tiles to which the adjustments will be applied. If, for example, the tiled configuration is the tri-view comprising the two outside mirror camera images and the trailer image, the user can enter main menu mode by pressing the menu button and then navigating to the camera tile that the user wants to adjust by pressing the view button. Once the yellow border is highlighting the camera tile or displayed image that the user wants to adjust, the user can then press the menu button repeatedly until the control tab that is desired to be altered is highlighted. Pressing the increment and decrement buttons at any time while in menu mode will make changes to the control tab that is actively highlighted. Inactivity while in either the view select or main menu modes will result in the menu deactivating and animating off of the screen by sliding downward.

As shown, the video display includes demarcations between the video images of different cameras. For example, if three tiles are displayed (based on image data captured by three cameras), the black lines are used to demarcate and separate each tile (that has its own camera image). The scene would not be continuous as in depicted in the graphics illustration, but instead, three distinctly different images would be present as derived from three distinctly different camera mounting perspectives. Due to duplications of regions rearward of the vehicle in the multiple captured images (e.g., duplication of other vehicles rearward and along one side of the vehicle as captured by both the rear camera and the side camera at that side of the vehicle), the demarcations are included to avoid confusion as to what is being displayed at the display screen.

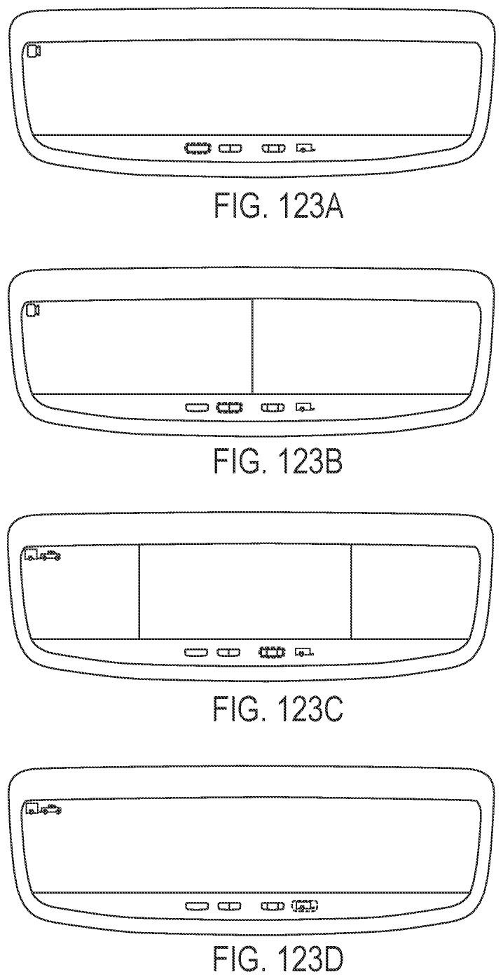

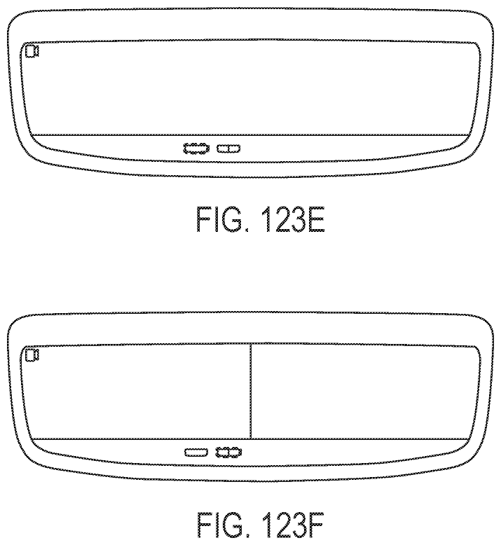

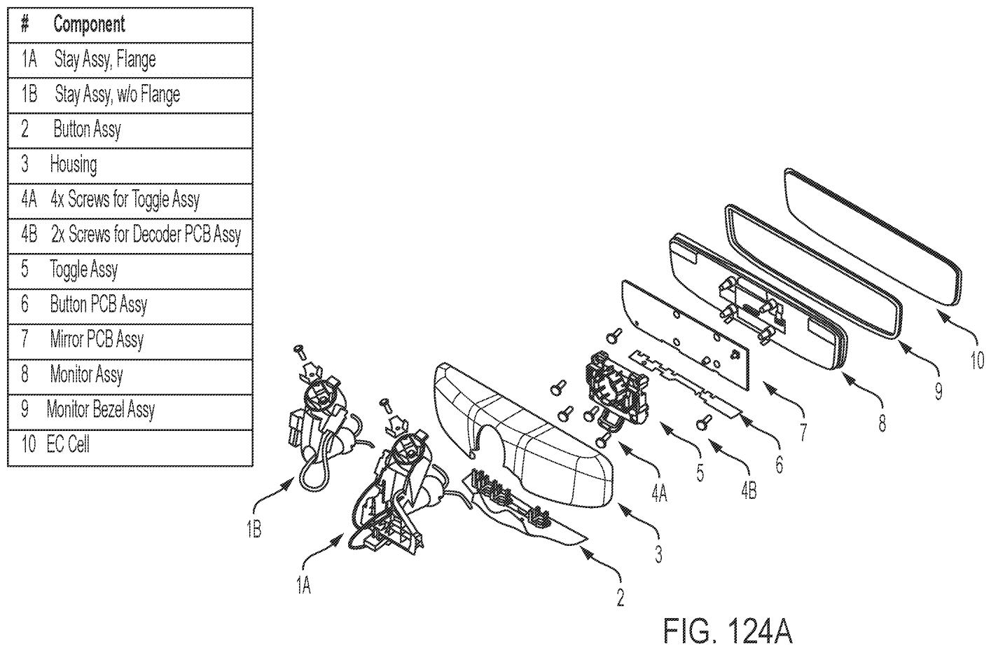

The interior rearview mirror assembly provides a full mirror display via the display screen and backlight assembly disposed behind the mirror reflective element or EC cell (see FIGS. 124A and 124B). The mirror assembly may include a touch assembly or button assembly, which may include customer branding.

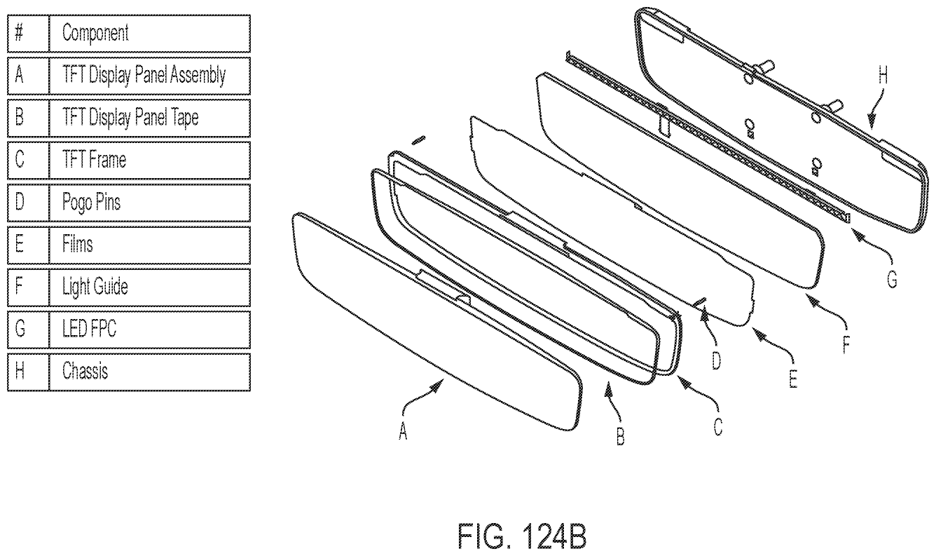

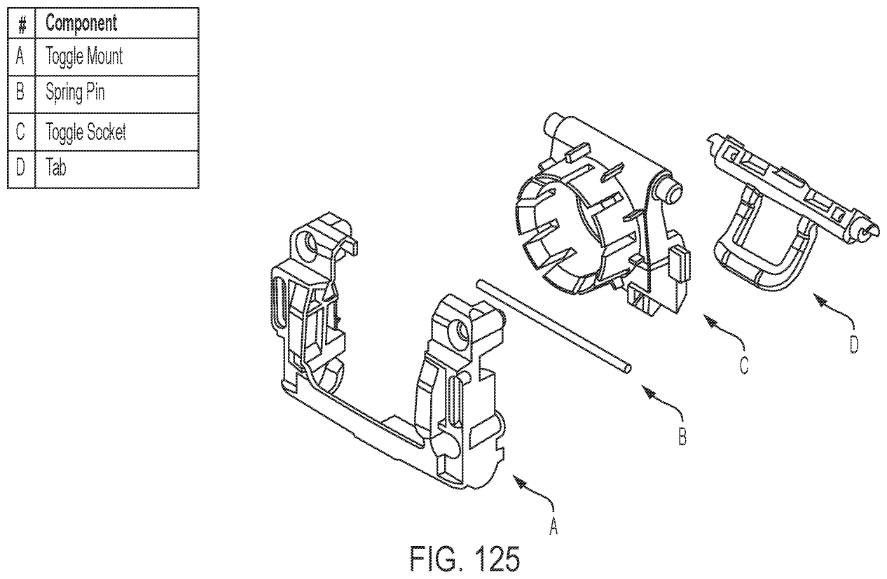

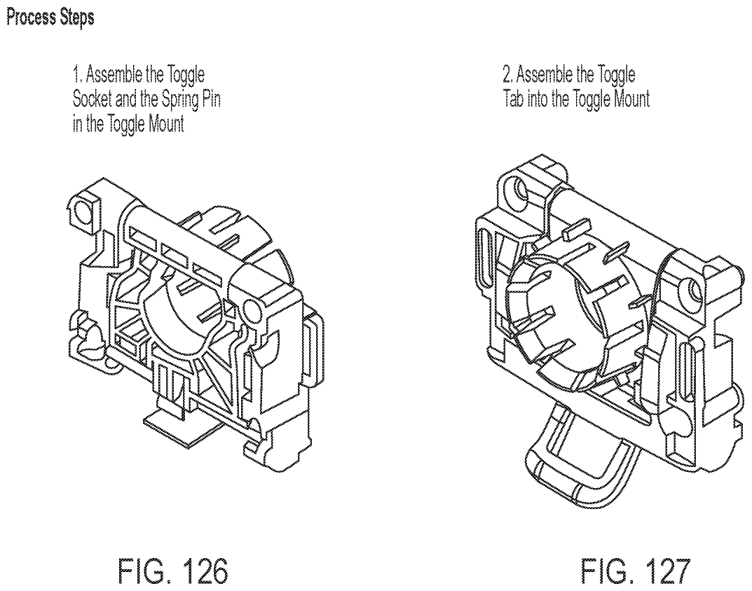

The mirror head (including the mirror housing and reflective element and display) is mounted at a stay assembly or mounting structure, which is configured to attach at an interior portion of the vehicle (such as at an overhead console or headliner or at an in-cabin side of the vehicle windshield). The mirror head may be toggled between the mirror mode and the display mode by flipping a toggle tab at the bottom of the mirror head, which causes the mirror head to pivot about a generally horizontal pivot axis relative to the mirror stay. As shown in FIGS. 125-127, the toggle assembly comprises a toggle mount that attaches at the rear of the display and reflective element, a toggle sprocket that pivotally attaches at the toggle mount, and a toggle tab that is pivotable to impart pivotal movement of the toggle sprocket relative to the toggle mount to pivot the mirror reflective element and mirror head relative to the mirror stay. A spring pin is disposed at the toggle mount to bias the pivotal movement toward either position (the mirror mode position or the display mode position).

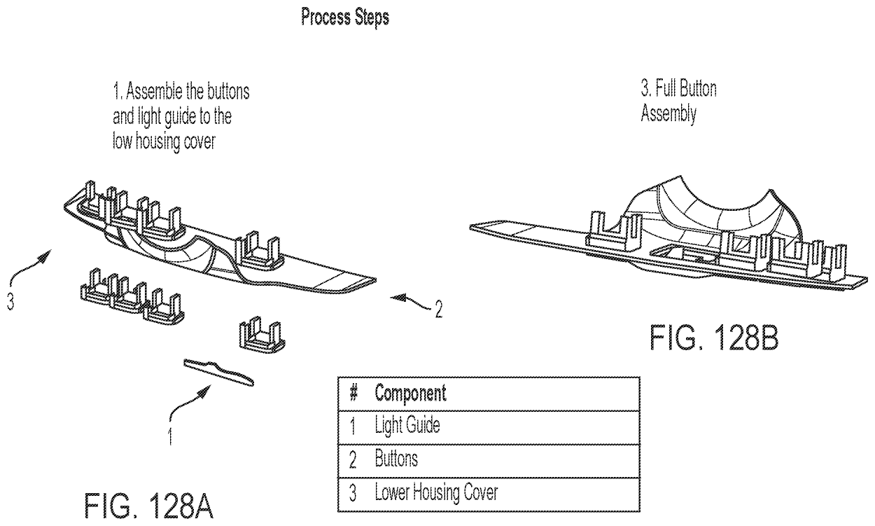

As shown in FIGS. 128A-B, the button assembly comprises user actuatable buttons disposed at a lower housing cover, which is configured to attach at the lower side of the mirror casing, with the user actuatable buttons configured to actuate electronic switches at the mirror display. The lower housing cover has an aperture through the center region for the toggle tab to protrude through so as to be accessible below the mirror casing for a user to switch or toggle the mirror between the mirror mode and the display mode. The button assembly also includes a light guide that guides light (which may be emitted by a light emitting diode (LED) within the mirror casing above the lower housing cover) so that the light backlights the buttons so the buttons are viewable by the driver of the vehicle, even in low lighting conditions. The buttons may have words or icons established thereat that are backlit or illuminated so the driver can readily discern the respective function associated with each button.

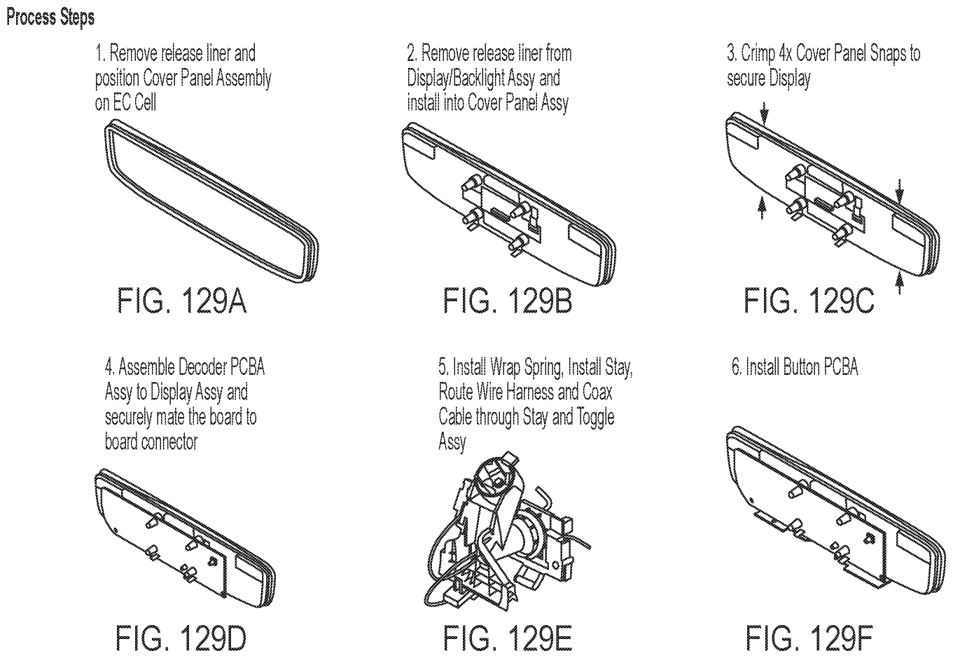

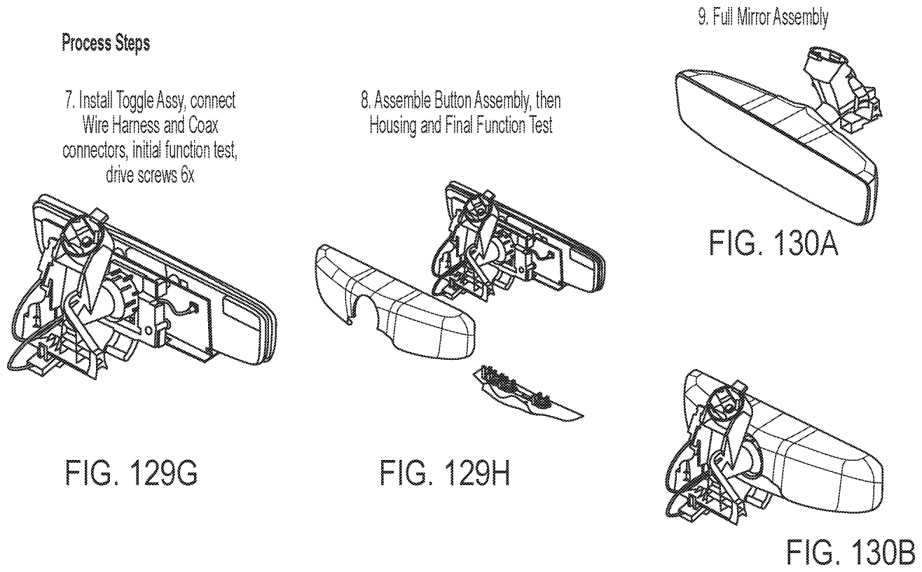

The assembly process steps for assembling the mirror head and mirror assembly are shown in FIGS. 129A-H, with the fully assembled mirror shown in FIGS. 130A and 130B.

The cameras comprise digital cameras that capture image data and that are electrically connected to the remote ECU and/or mirror ECU via a coaxial cable connector and coaxial connector. The output of the camera may comprise a low voltage differential signaling (LVDS) digital signal, and the camera may be powered via power over coax. During operation, the camera operate to capture frames of image data at 60 frames per second. To reduce or mitigate LED flicker, the LEDs may operate via pulse width modulation (PWM) at around 400 Hz, 10% duty cycle.

Optionally, the mirror assembly may comprise an electrochromic mirror reflective element, and the system may provide for dimming control of the electrochromic mirror reflective element of the interior mirror and optionally of electrochromic mirror reflective elements of one or both of the exterior mirrors via processing of image data captured by one or more of the cameras (such as by utilizing aspects of the vision systems described in U.S. Pat. Nos. 10,967,796 and/or 10,948,798, and/or U.S. provisional application Ser. No. 63/262,642, filed Oct. 18, 2021, which are all hereby incorporated herein by reference in their entireties). For example, the system may utilize a rearward sensing sensor at the mirror or the rearward-viewing camera (at the CHMSL region) to determine glare light rearward of the vehicle when the vehicle is not towing a trailer. However, when the vehicle is towing a trailer that obstructs the rear window view, the tall trailer blocks the glare or rear sensing sensor at the interior mirror and blocks the rear backup camera view and blocks the CMS CHMSL camera view. Thus, the presence of the trailer inhibits the ability for glare control for the exterior auto-dimming mirrors using the rearward sensing sensor and/or rearward-viewing cameras of the vehicle. In such trailering situations, the system may utilize the CMS exterior side cameras for independently determining glare conditions for each respective exterior auto-dimming mirror. Thus, the exterior CMS Cameras and the rearward-viewing trailer camera can be used to detect glare and determine the driver and passenger side auto-dimming mirror level of dimming independently.

The side cameras may be disposed at the respective exterior rearview mirror assemblies (or optionally may be disposed at a side body portion of the vehicle). The cameras may be disposed at an extendable and retractable mirror head that may extend/retract via telescoping arms or pivoting linkages or the like (such as by utilizing aspects of the mirror assemblies described in U.S. Pat. Nos. 5,483,385; 6,116,743; 6,213,609; 6,239,928; 6,276,808; 6,325,518; 6,394,616; 6,497,491; 7,267,449 and/or 9,796,334), whereby the mirror head is extendable outboard from the side of the vehicle by about six inches by a mechanical or electro-mechanical system.

Optionally, the side cameras may be disposed at the mirror base so that the cameras do not extend or move with the mirror head. The cameras may have a wide angle field of view so as to encompass a side region of the vehicle and the region sideward and rearward of the vehicle. The system may adjust the view of the camera (or adjust processing of the wide angle view to adjust the area that is displayed) based on whether or not a trailer is hitched to the vehicle and being towed by the vehicle.

The camera may be disposed at the exterior rearview mirror assembly and the display may be disposed at the A-pillar of the vehicle. Optionally, the camera may replace the mirror assembly such that the camera is disposed at an arm that extends laterally outward from the side of the vehicle. Video images derived from video image data captured by the side mounted CMS camera are displayed at the video display screen disposed at the A-pillar near the camera or mirror assembly. The display device may include a video processor (comprising an ISP) that processes the video image data captured by the camera (and received at the display device via a coaxial cable (that may also provide power to the camera) and outputs an image signal to the LCD panel for display.

The CMS or rearward-viewing vehicle cameras (and optionally a trailer tow camera, if applicable) provide image data to the ECU (located remote from the cameras and from the interior display, such as under a seat of the vehicle), which processes the image data and outputs a display signal to the display device (such as a video display screen at the interior rearview mirror assembly). The ECU may receive image data or camera signals from each of the CMS cameras (the side mirror cameras, the rear CHMSL camera and optionally the trailer camera (via a connection to a camera line at the trailer harness connector)) and may combine the image data (for the particular display configuration selected by the driver) into a single video image output that is provided to the display device via a single coaxial cable. The display device may receive vehicle information or user inputs via a LIN communication bus or link. The interior rearview mirror assembly receives the display signal via the coaxial cable and processes the signal for outputting to the display. The mirror assembly includes a microcontroller that outputs signals to an electrochromic driver of the EC cell and to an LED driver of the backlighting device of the display screen and to a deserializer of the TFT display panel.

The microcontroller receives an input from a light sensor, and may control the EC driver and the LED backlighting responsive to a detected or determined ambient light level at the mirror assembly. The system may also control EC dimming of the exterior mirrors and control the display intensity of the respective display screens (e.g., at the respective A-pillars) responsive to processing of image data captured by the respective side CMS cameras. The system may also control the intensity of the interior mirror display responsive to processing of image data captured by one or both side CMS cameras or responsive to processing of image data captured by the rearward-viewing CHMSL camera or responsive to processing of image data captured by the rear backup camera or responsive to processing of image data captured by the trailer camera. The data used for dimming control may be provided by one or more of the cameras (such as one or more of the CMS cameras) and/or may be provided via the CAN or LIN bus of the vehicle. Optionally, the system may operate to control the intensity of dash lights or other interior vehicle lighting and/or exterior vehicle lighting responsive to processing of image data captured by one or more of the CMS cameras (or surround vision cameras) of the vehicle. The data used for dimming control may be provided by one or more of the cameras (such as one or more of the CMS cameras) and/or may be provided via the CAN or LIN bus of the vehicle.

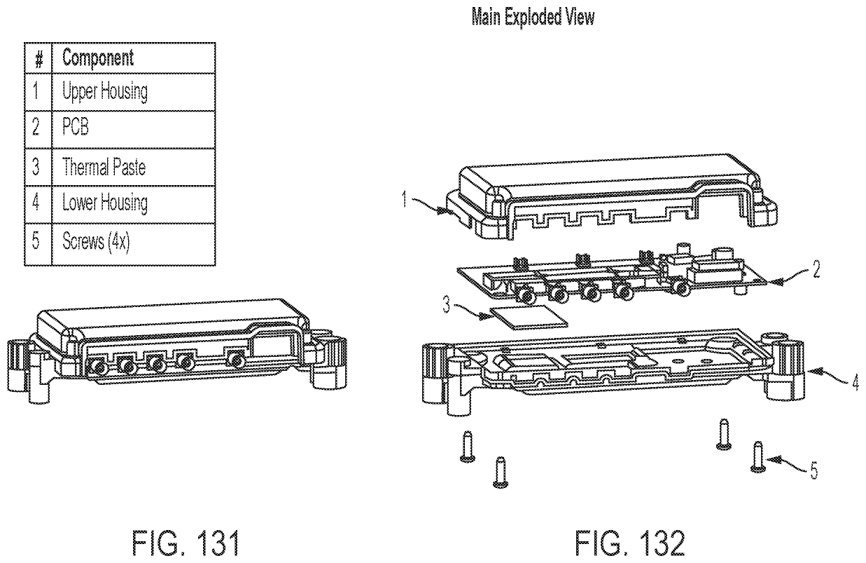

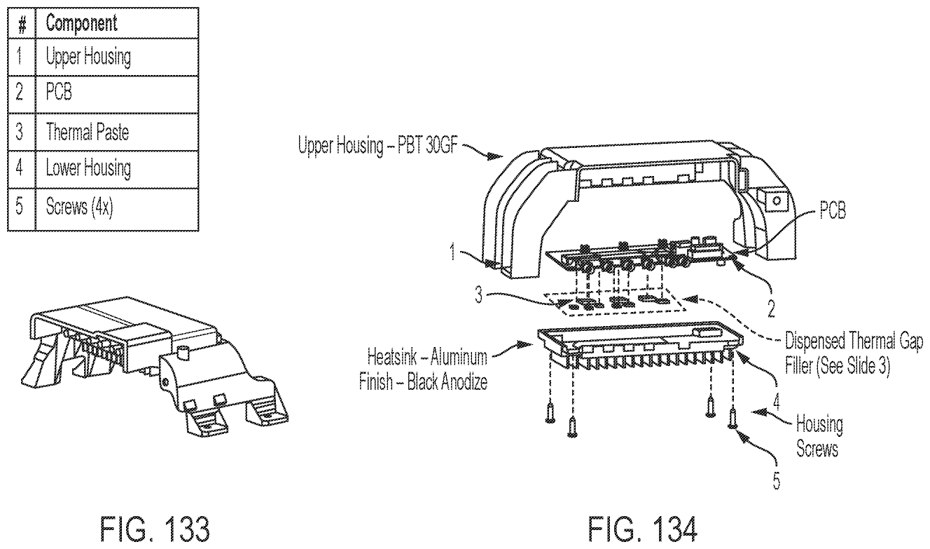

As shown in FIGS. 131 and 132, the remote ECU may include multiple coaxial input connections, with each one associated with one of the CMS cameras. The ECU includes an upper housing and a lower housing, with a printed circuit board (PCB) housed therein. The upper and/or lower housing may include heat dissipating elements, to dissipate heat generated by the processor during operation. As shown in FIG. 132, a thermal paste may thermally conductively connect the PCB to the housing to enhance heat dissipation. Optionally, and such as shown in FIGS. 133 and 134, the PCB may be mounted at a lower heatsink, with an upper housing that houses the PCB and that spaces the heatsink from the floor or support structure of the vehicle at which the ECU is attached.

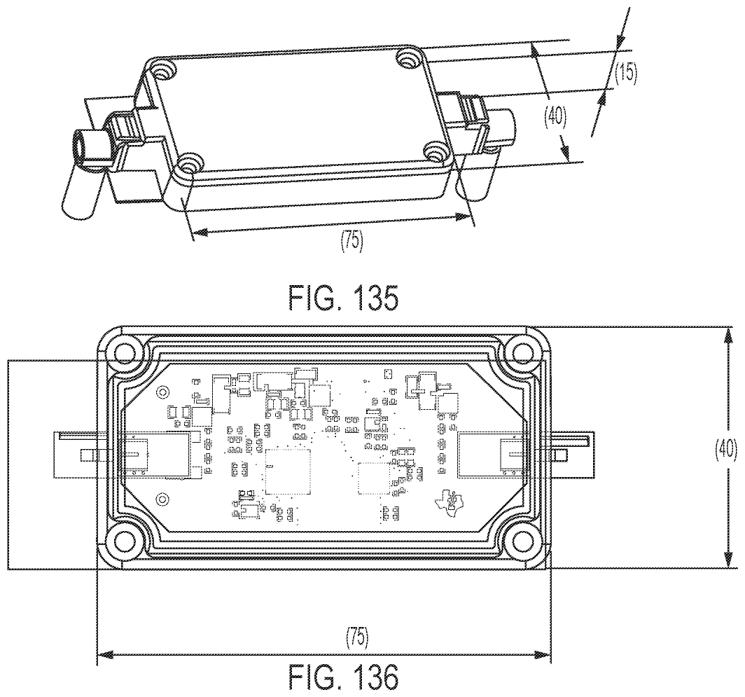

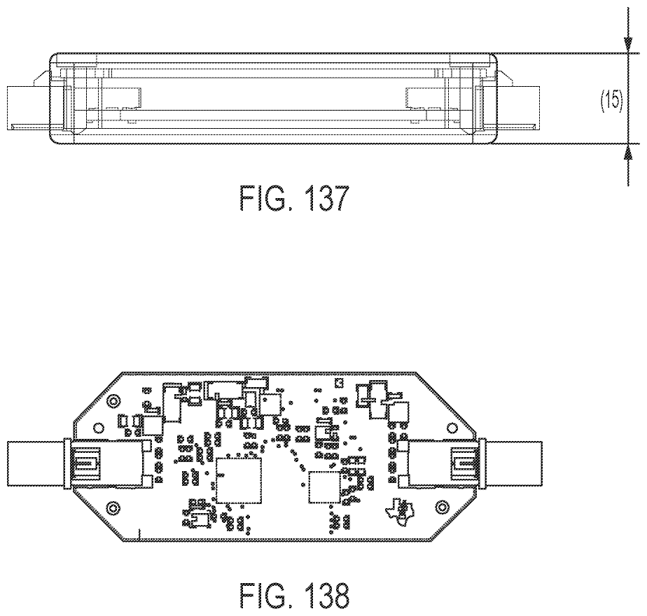

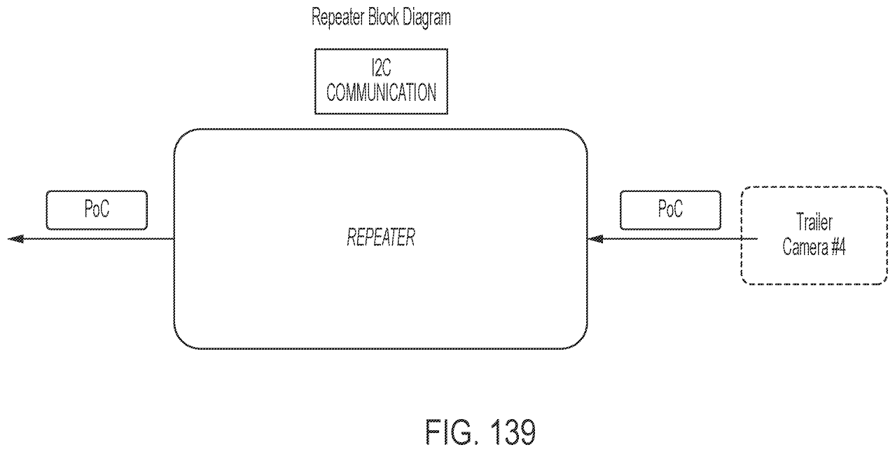

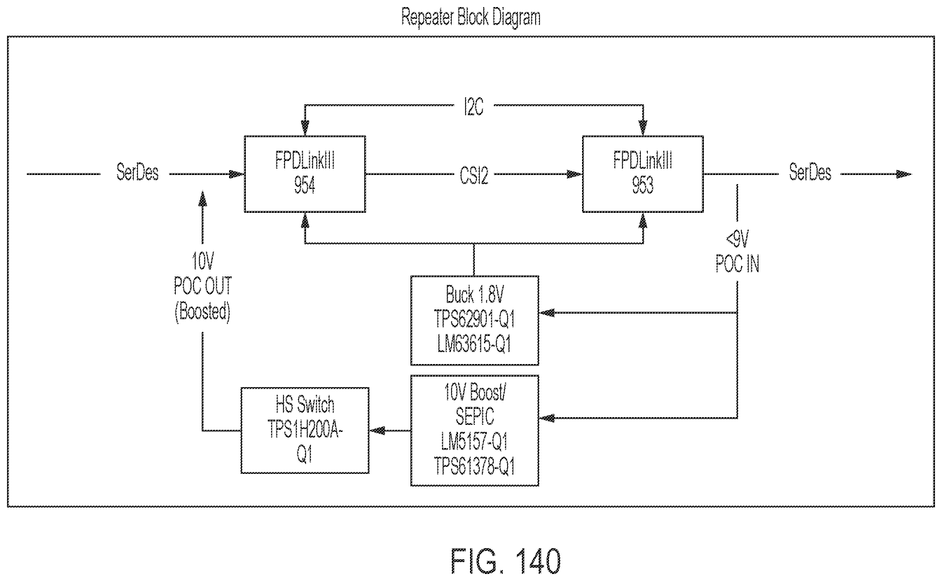

As shown in FIGS. 135-151, the camera (such as the trailer camera) may include a sealed exterior digital camera repeater for the trailer system. The repeater may be molded in Fakra connector plastics, and may include features to protect the camera cables, and features to prevent water/ice intrusion. The repeater may be potted internally to seal the repeater.

The tow camera repeater is an inline module which allows the digital video signal to be transmitted through a cable length which permits camera to be mounted on all FMVSS permitted trailer lengths. The repeater allows for a trailer camera that can function with a cable length of up to or greater than 15 meters or up to or greater than 20 meters, such as about 22 meters (from the connection at the rear of the vehicle to the trailer camera). The repeater may be installed around 5 meters upstream from the connection at the rear of the vehicle. The repeater is mounted on an exterior and underbody of the trailer or vehicle, and thus has dustproof/waterproof characteristics. The repeater receives power over coax (PoC).

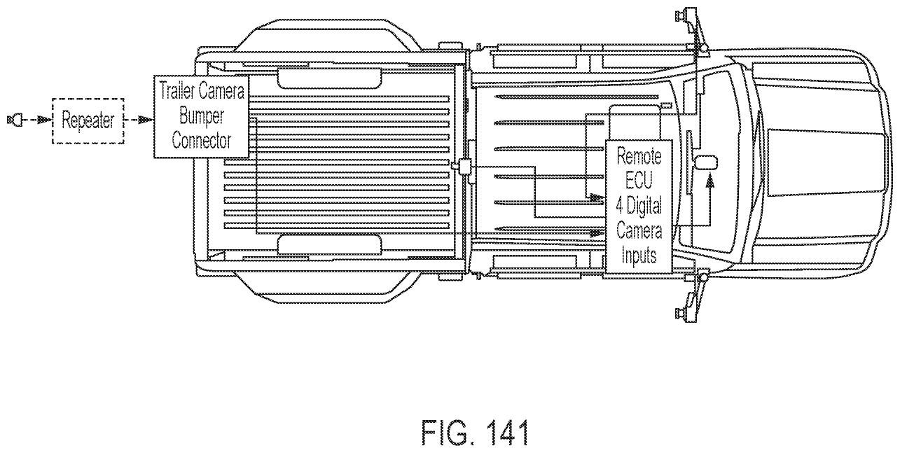

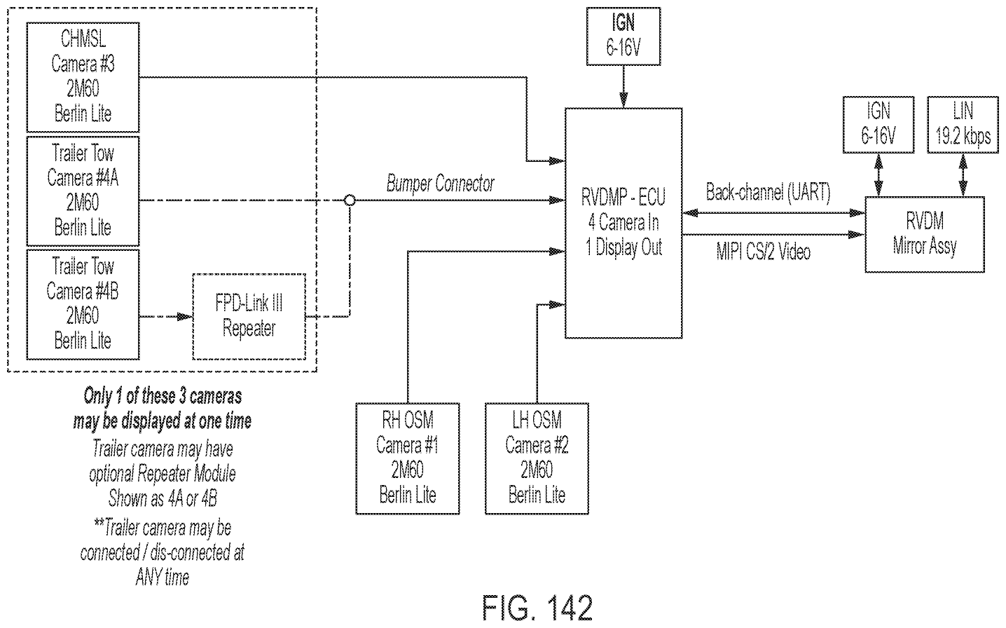

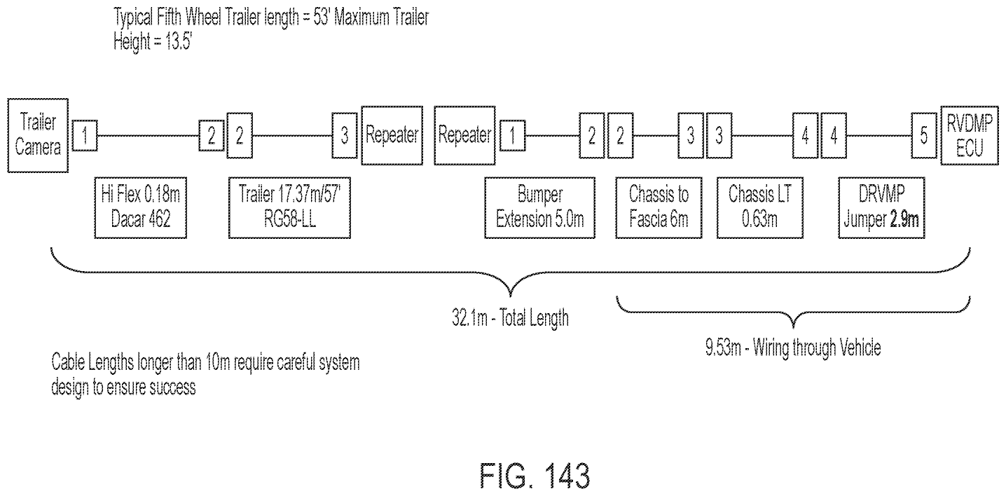

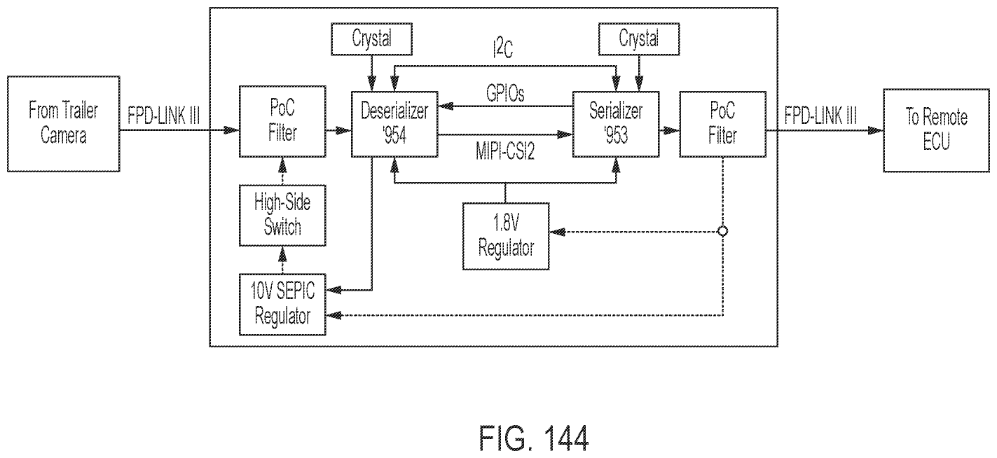

FIGS. 141 and 142 shows a vehicle or block diagram with the three CMS cameras and a remote ECU, with the ECU receiving digital camera inputs from the three CMS cameras and the trailer camera (via the repeater and cables), and outputting video image data or outputs or signals to the video display screen at the interior rearview mirror assembly. As shown in FIG. 143, the repeater allows for proper functioning of the trailer camera and system for fifth wheel trailers, which typically have a length of about 16 meters. The allowable cable length for the application is dependent on several factors, including a serializer/deserializer chipset selection (forward/video channel operating frequency, and back/control channel operating frequency), cable performance (attenuation or insertion loss at both the forward and back channel frequencies and cable diameter and flexibility for in-vehicle routing needs), and the number and type of interconnects (including insertion loss per interconnect, at both frequencies). FIG. 144 shows another repeater block diagram for the trailer camera and vision system.

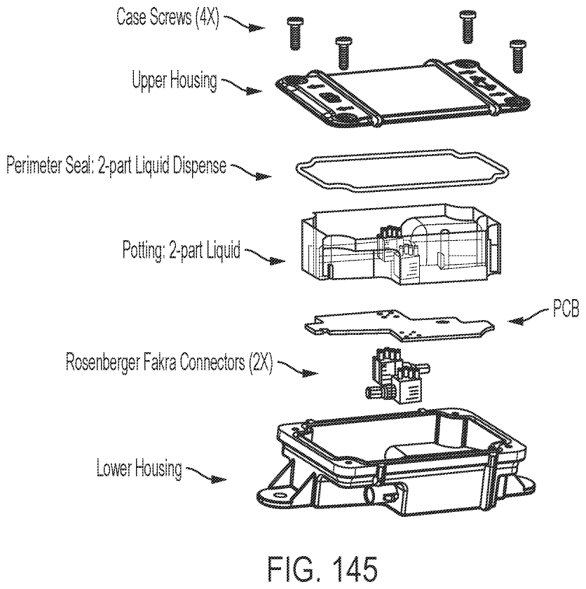

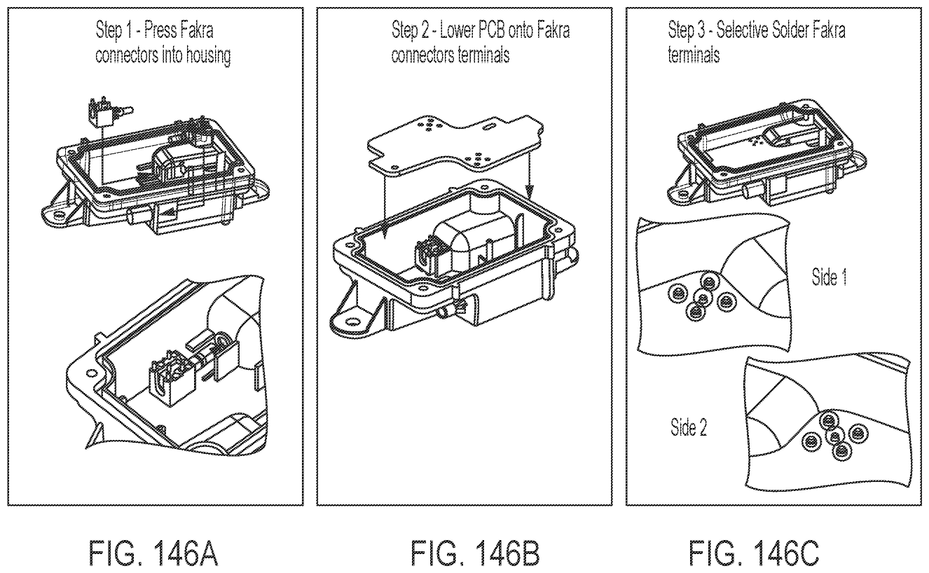

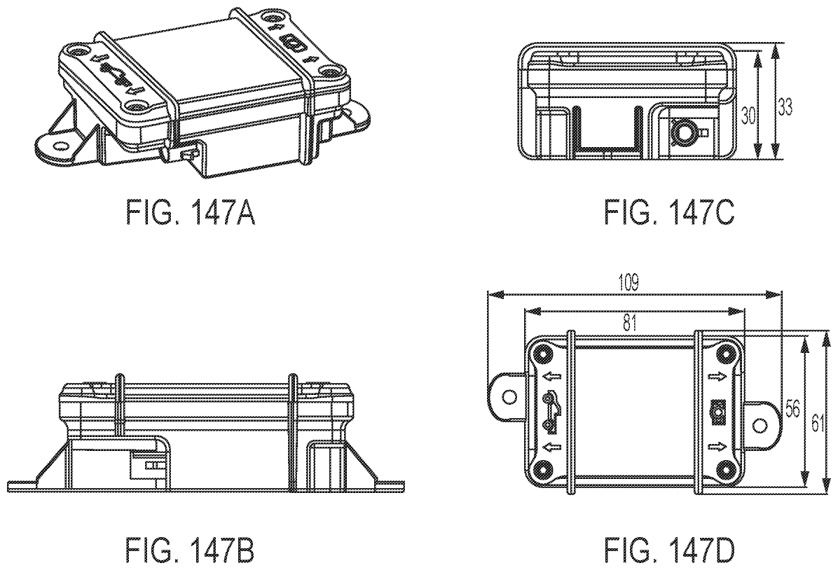

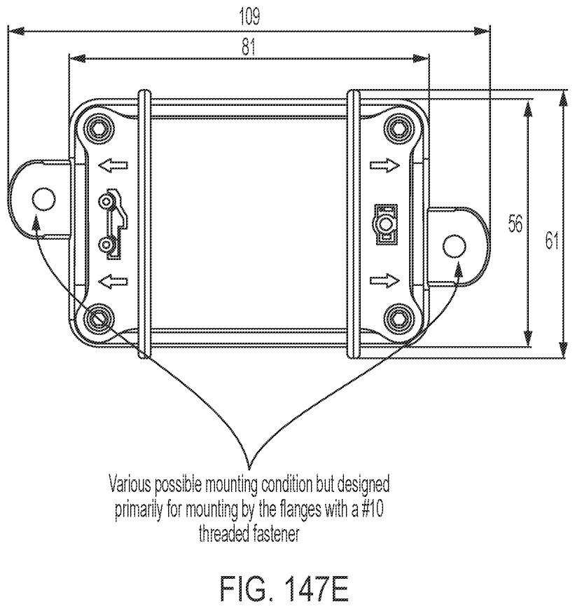

As shown in FIG. 145, the repeater comprises a housing (including an upper housing and a lower housing joined together with a perimeter seal at the mating interface), a printed circuit board and two Fakra connectors. A potting material (such as a two part liquid potting material) is dispensed into the housing to seal the PCB and connectors in the housing. The assembly process for the repeater is shown in FIGS. 146A-C. When fully assembled (as shown in FIGS. 147A-E), the repeater assembly or module provides a compact structure having a weight of around 135 g.

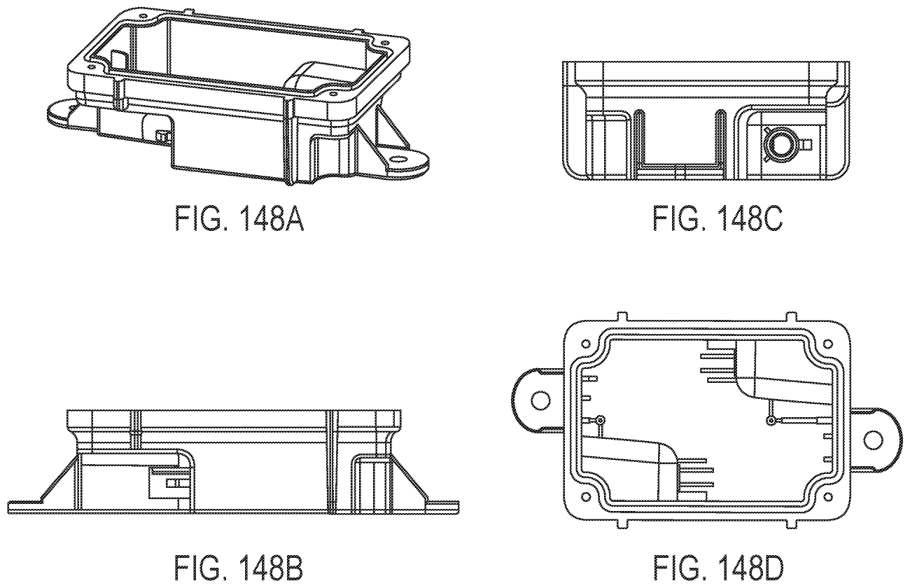

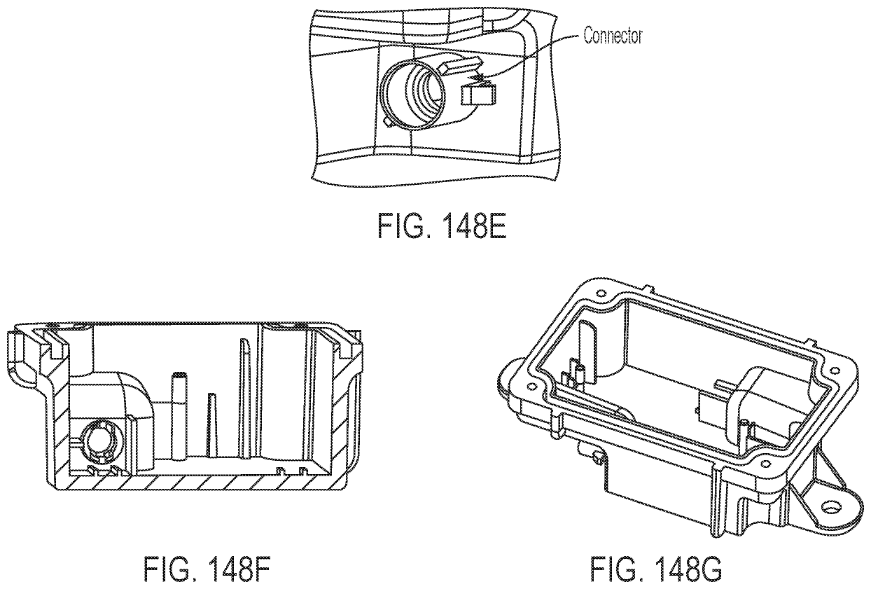

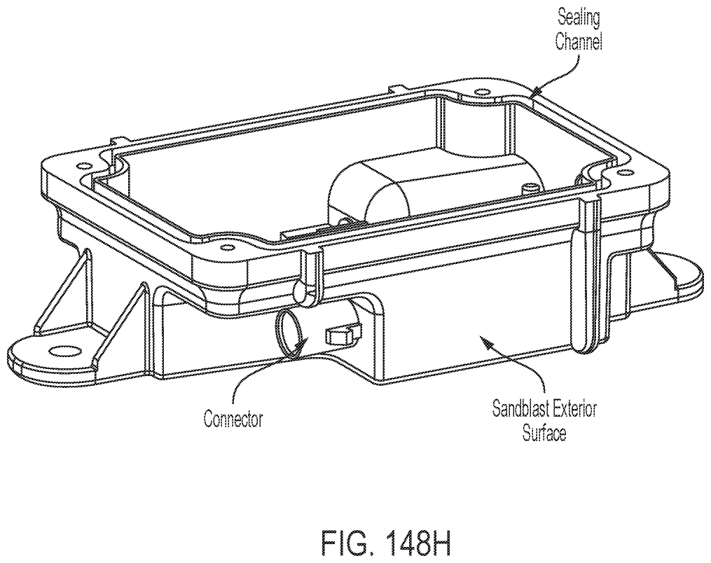

As shown in FIGS. 148A-D, the lower housing comprises a molded structure (such as formed by injection molding a polymeric resin, such as a 30% glass fiber reinforced polybutylene terephthalate, such as PBT 30GF, or the like). The selected material maintains tight tolerances, has sufficient thermal dimensional stability, sufficient creep resistance, sufficient UV resistance, sufficient chemical resistance, sufficient strength and sufficient adhesion characteristics. As shown in FIG. 148E, the lower housing portion has molded connectors configured to electrically connect to a coaxial cable to the trailer camera and to a coaxial cable to the ECU of the vehicle. As shown in FIGS. 148F and 148G, a channel or trough is formed at the interface of the lower housing portion for receiving the perimeter seal partially therein. The channel may be lightly textured to provide a bonding and sealing surface that has sufficient bonding characteristics with a two part urethane seal. The seal must be maintained when submerged in water. As shown in FIG. 148H, the outer surface of the lower housing portion may be sandblasted to provide the desired texture.

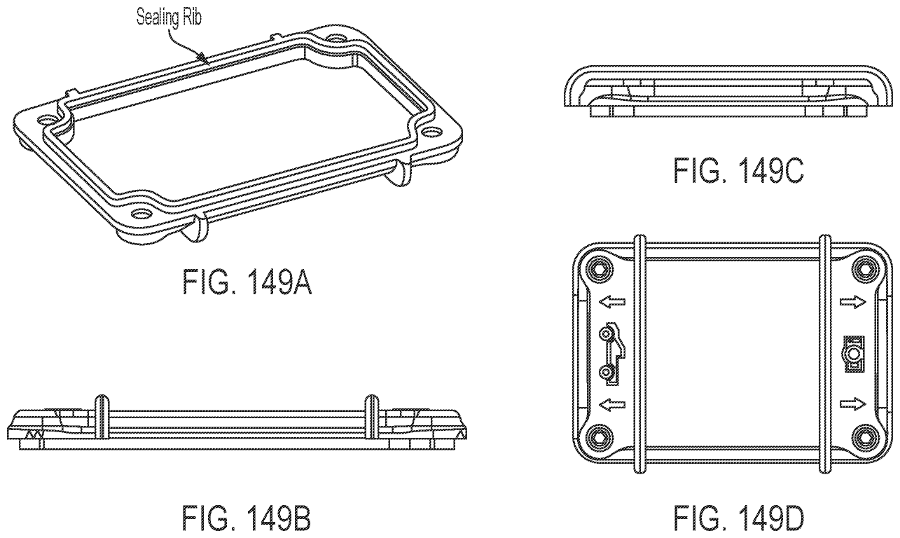

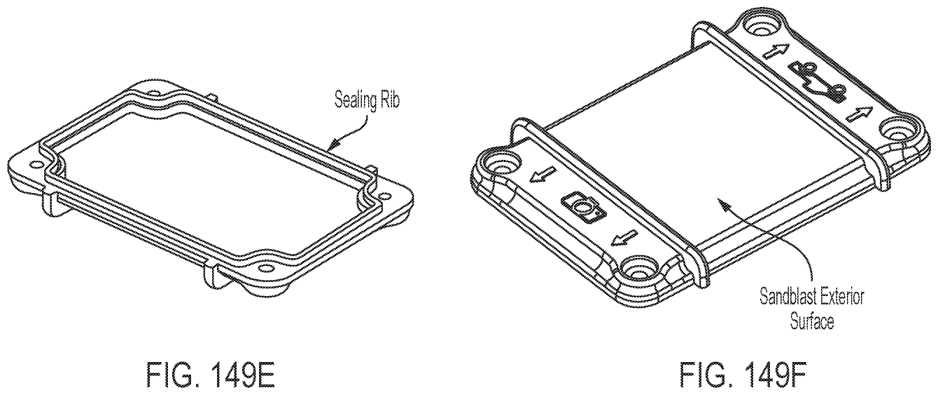

The upper housing (FIGS. 149A-F) may comprise a similar material as the lower housing and should provide similar performance and durability characteristics. As shown in FIG. 149E, the upper housing has a perimeter rib that is configured to be received in the channel of the lower housing (see FIGS. 149F and 149G). The rib may be lightly textured and provides a bonding and sealing surface that has sufficient bonding characteristics with a two part urethane seal. The seal must be maintained when submerged in water. As shown in FIG. 149F, the outer surface of the upper housing portion may be sandblasted to provide the desired texture, similar to the lower housing portion.

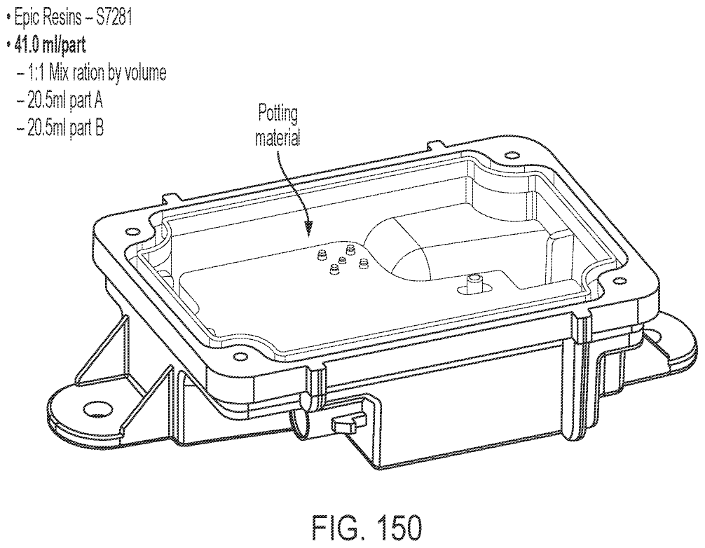

The potting material (see FIG. 150) is dispensed in the lower housing portion, after the PCB and connectors are disposed therein. The potting material may comprise a two part material, such as Epic Resins S7281 or the like.

The perimeter seal (see FIG. 151) may comprise a two part liquid urethane seal, such as, for example, Epic Resins S7511-20 or the like.

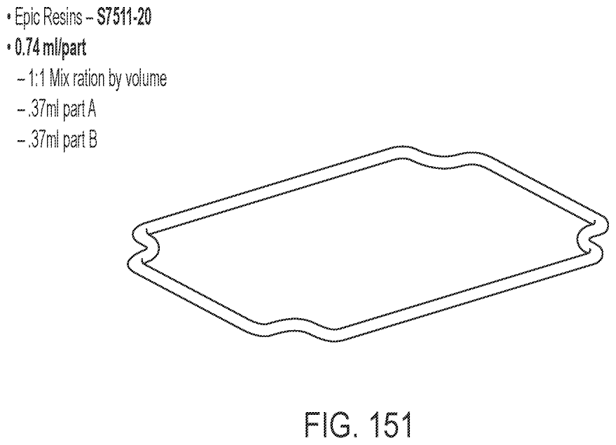

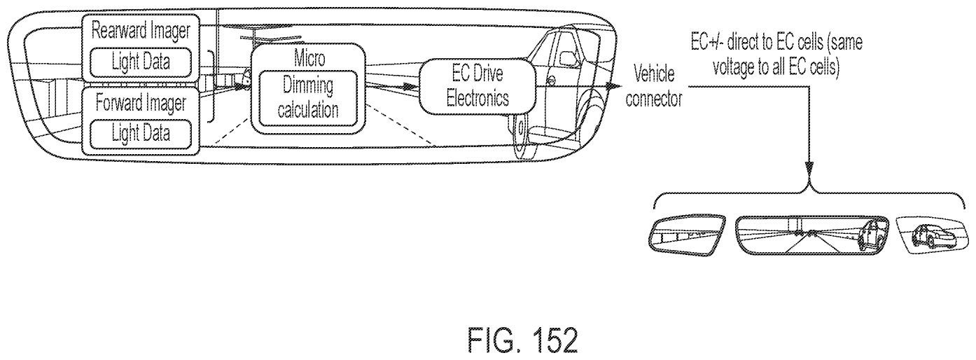

With reference to FIG. 152, the mirror system may provide for mirror dimming control via a mirror head that includes a forward facing light sensor (that senses ambient light), a rearward facing light sensor (that senses glare light) and dimming control circuitry and drive electronics. With such a system, the interior and exterior mirror reflective elements are controlled via the same signal or output of the EC drive electronics.

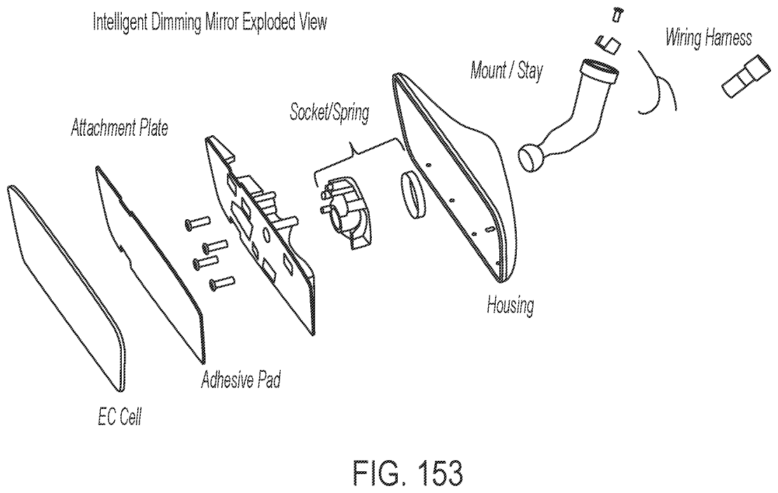

Optionally, the EC drive electronics may be removed from the mirror head, which allows for a reduced profile mirror head, such as shown in FIG. 153. Such a low profile mirror assembly may utilize aspects of the mirror assemblies described in U.S. Pat. No. 10,967,796 and/or U.S. publication No. US-2015-0334354, which are hereby incorporated herein by reference in their entireties.

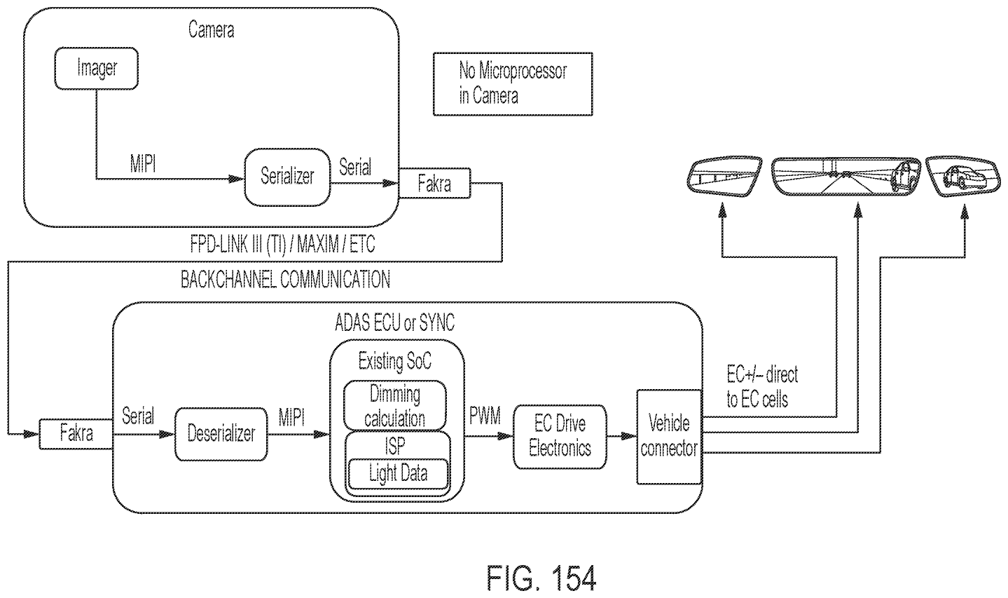

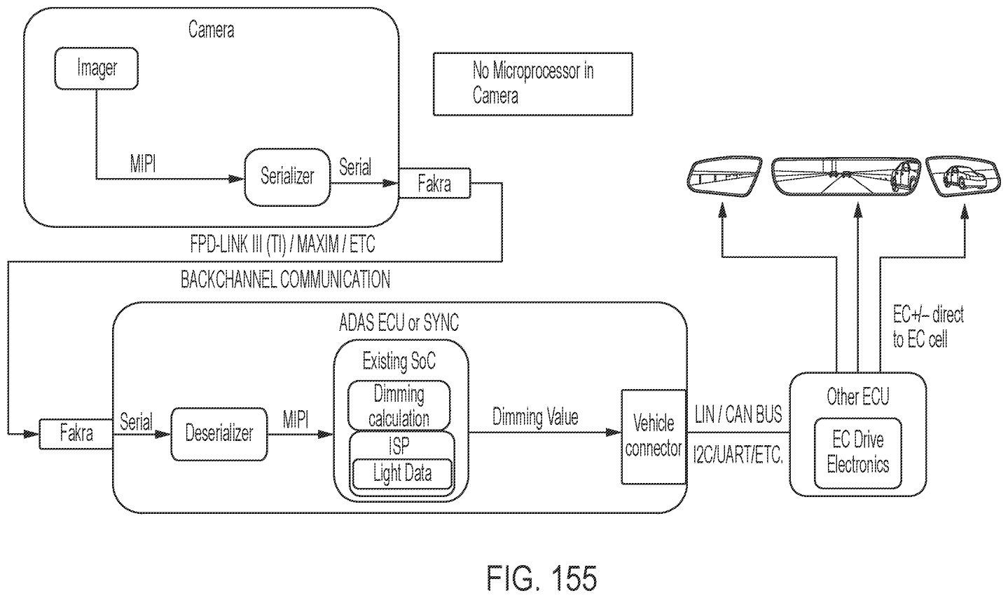

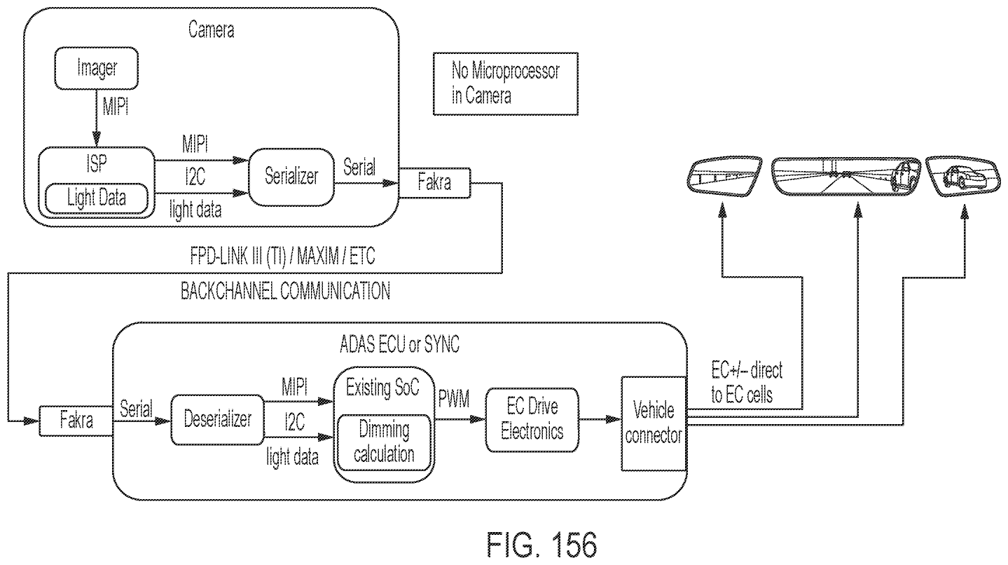

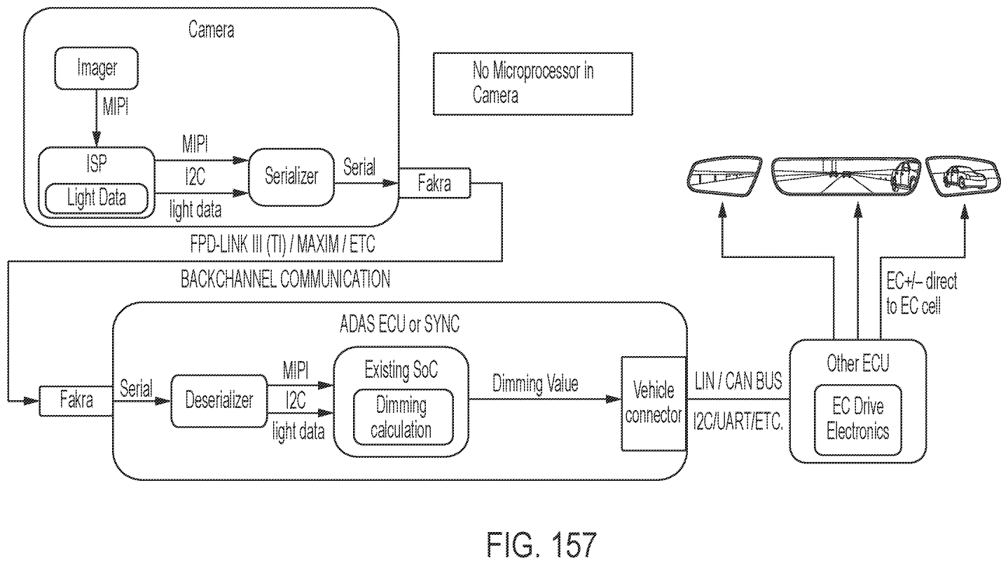

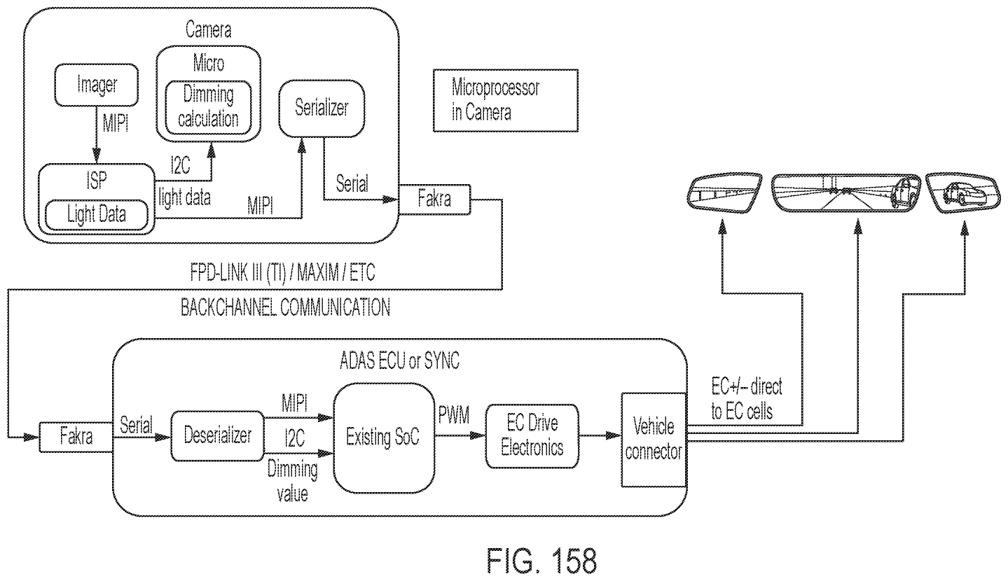

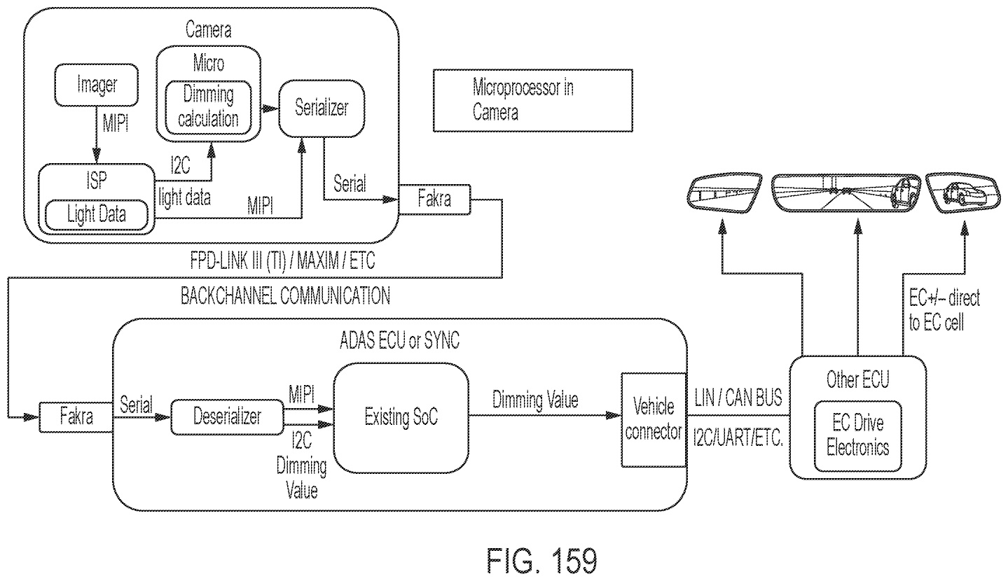

As shown in FIGS. 154 and 155, the camera (that captures image data that is processed for the EC mirror dimming control) may not include or not make use of an image signal processor (ISP). In these examples, the ADAS ECU may include a microprocessor for processing, for example, mirror dimming functions and/or calculations. The ADAS ECU may drive the EC (FIG. 154) or a separate ECU may drive the EC (FIG. 155). As shown in FIGS. 156 and 157, the camera may include and use an ISP. In these examples, the ADAS ECU may drive the EC mirror dimming (FIG. 156) or a separate ECU may drive the EC mirror dimming (FIG. 157). As shown in FIGS. 158 and 159, in some examples, the camera includes a microprocessor. For example, FIG. 158 includes a camera with a microprocessor that performs the dimming calculations where the ADAS ECU drives the EC mirror dimming. FIG. 159 includes a camera with a microprocessor that performs dimming calculations where a separate ECU drives the EC mirror dimming.

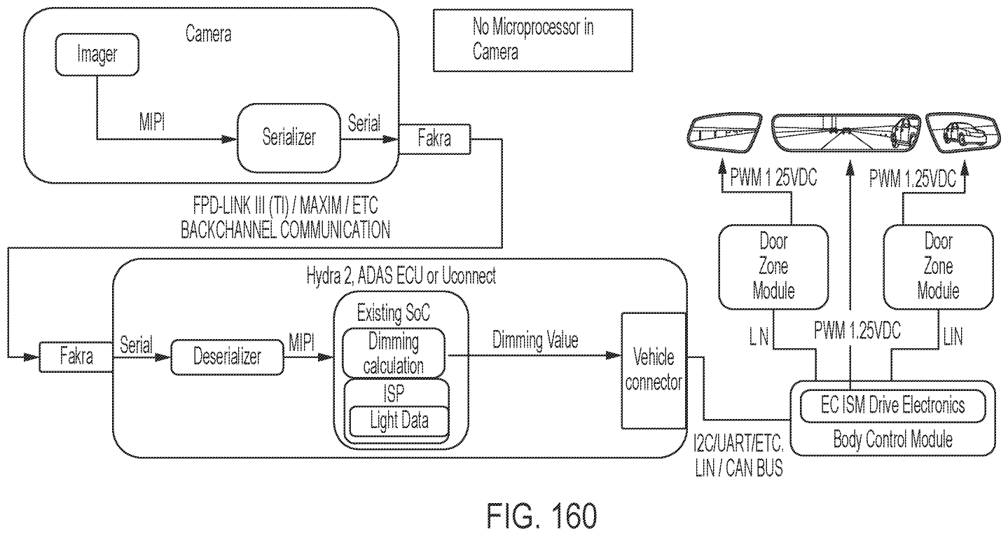

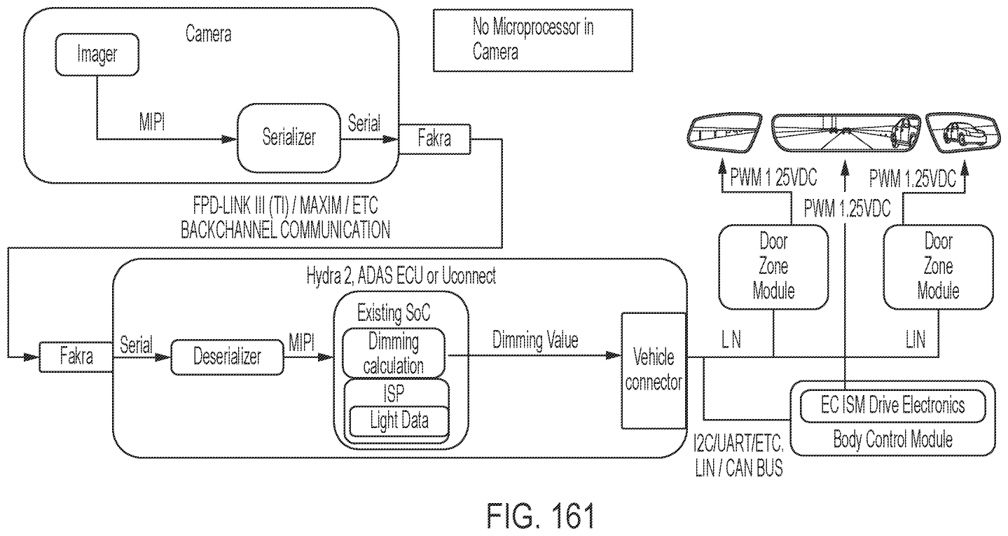

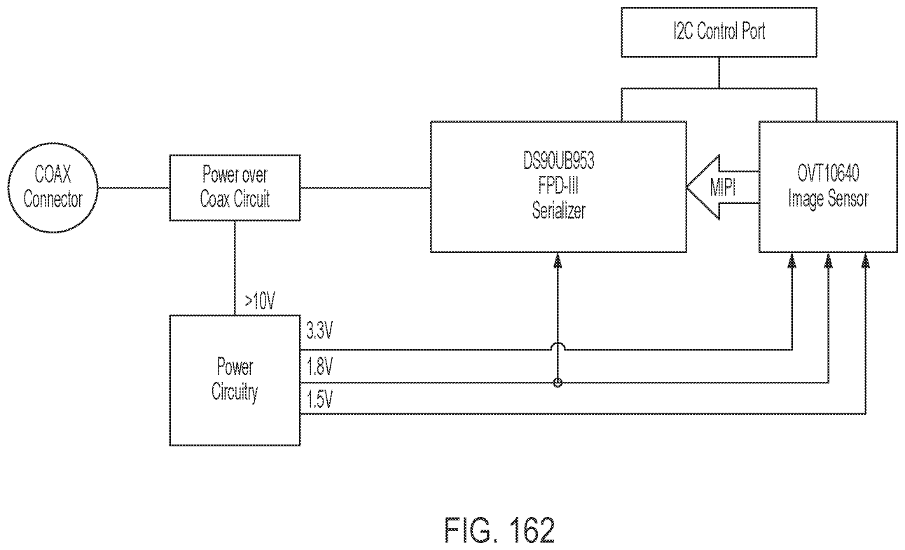

Light data may include raw data from various registers on the camera. The dimming calculations (e.g., performed by the microprocessor in the camera as shown in FIGS. 158 and 159 or in a microprocessor of the ADAS ECU as shown in FIGS. 154-157) may include an algorithm to calculate an amount of dimming required based on the light data gathered or generated or captured by the camera. Power drivers may send voltage (e.g., 0 to 1.2V) to the EC mirrors to activate the dimming function. As shown in FIG. 160, the camera may capture image data that is provided to the ADAS ECU, which includes an image processor and performs the dimming calculations (such as via an algorithm that calculates the amount of dimming required based on light data, which is raw data from various registers of the camera). The ADAS ECU outputs a dimming value to a body control module, which includes EC drive electronics (such as power drivers that send 0 to 1.2V to the EC mirrors to activate the dimming function) and which outputs an EC dimming control output to the interior mirror and outputs signals to door zone modules of the respective exterior side mirrors. As shown in FIG. 162, the ADAS ECU may output dimming values (e.g., via the LIN of the vehicle) to the body control module (for controlling dimming of the interior mirror reflective element) and to each door zone module (for controlling dimming of the respective exterior mirror reflective elements).

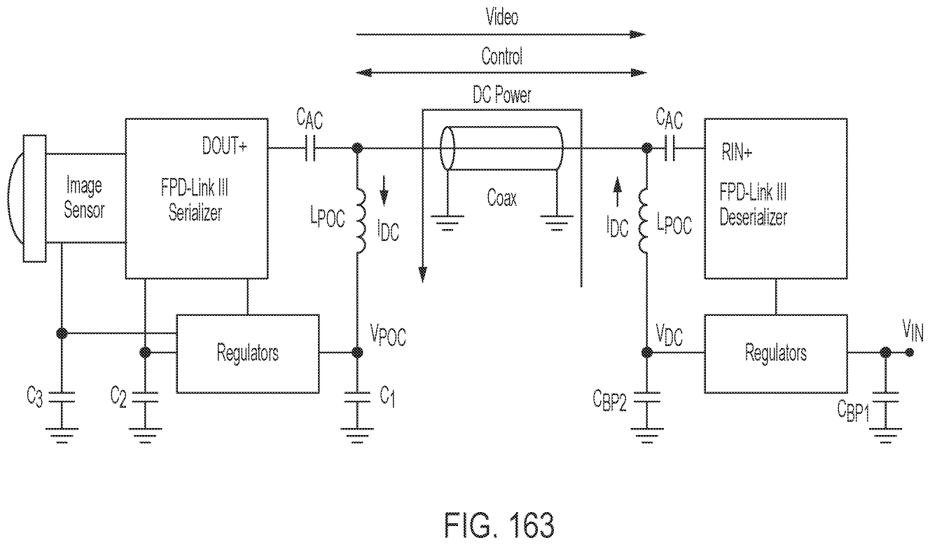

FIG. 162 illustrates an exemplary DS90UB953 serializer and camera block diagram that includes power-over-coaxial (PoC) capabilities. FIG. 163 includes a block diagram that demonstrates sharing signal data (e.g., video data and/or control data) and DC power over the same cable. For example, the signal data and DC power may be transmitted over a coaxial cable between a serializer and a deserializer.

The system removes the two light sensors (ambient light sensor and glare light sensor) and the EC dimming control electronics from the interior rearview mirror. The light data is extracted from the cameras via the image signal processor (ISP), and that data is used to calculate the dimming levels for the outside and inside mirrors. That data may be sent to other modules in the vehicle that control the mirrors (such as to the body control module or door control modules).

Thus, the display system may provide intelligent dimming to control the display intensity using camera lux information, and may utilize floating pogo pins between the backlighting FPC and the EC cell (such as by utilizing aspects of the mirror assemblies and electrical connectors described in U.S. Pat. Nos. 10,484,587; 10,466,563; 9,878,669 and/or 9,565,342, which are hereby incorporated herein by reference in their entireties). The video display screen may comprise at least an 8 inch screen, such as, for example, a 9.6 inch custom TFT with failsafe/on-screen-display image (displays a symbol or icon). The mirror assembly includes a human machine interface (HMI) that provides selectable three different view adjustments.

The ECU may be disposed or mounted under a seat of the vehicle, and may provide up to four (or more) digital camera inputs (two OSM Cameras, one CHMSL, one external trailer accessory camera) and one digital output to the video mirror display. The ECU may have a die cast aluminum heatsink with internal water drainage features, and may include integrated mounting feet for attaching the ECU to the floor or support structure of the vehicle. The camera (such as the trailer camera) may include a sealed exterior digital camera repeater for the trailer system.

For traditional auto-dimming systems, glare light detection is made via a line-of-sight sensor (e.g., a photosensor at the interior rearview mirror), which typically has a 20-25 degree wide field of view since the line of sight is limited to the view through the rear window of the vehicle (and may be further reduced by any obstructions, such as cargo, passengers, etc., in the vehicle). Thus, sensing of glare with such interior mirror-based sensors is limited to the scene directly behind the vehicle.

Aspects of the vehicular vision systems disclosed herein provide intelligent dimming of the interior mirror and exterior mirrors. The complete system solution (camera and mirrors) increases performance and enables independent auto dimming of interior and exterior mirrors. The rear vision camera that already exists on the vehicle is also used as an ambient and glare light sensor to provide independent control of each mirror. Some of the electronics are removed from the interior mirror to reduce cost. The system provides an increase in performance compared to traditional light sensors in the interior mirror. The system eliminates redundant electronics by eliminating the PCB from the interior mirror, which reduces mass and cost of the mirror and enhances product sustainability.

The system provides independent mirror dimming and dims each mirror only when necessary and to a customized dimming level to maintain safest operating conditions. The system avoids nuisance dimming due to in-cabin lights since the glare sensor is not located in the interior mirror in the vehicle cabin. The system avoids nuisance dimming when the vehicle is being backed out of a garage, since the ambient sensor is no longer looking forward, but now faces the rearward scene. The dimming performance is not impacted by objects since the ambient sensor is relocated so it cannot be obstructed by objects hanging on the interior mirror. Removal of the PCB and electronics from the interior mirror allows for a very thin mirror package enabling enhanced styling and reduced mirror weight.

The system reduces sensors and electronic content to provide a centralized architecture for EC dimming. The system reduces independent, function-specific ECUs to provide the centralized architecture, and the system eliminates redundant sensors (using an already existing camera of the vehicle to sense ambient light).

The vehicular vision system may display video images at a video display screen of an interior rearview mirror assembly for a camera monitoring system, a rear backup camera system, and a surround view vision system, and may also or selectively display video images at a center console or stack video display screen for the rear backup camera system and the surround view vision system. The ECU receives image data captured by the rear backup camera, the surround view vision cameras (such as a front forward-viewing camera, a driver-side sideward-viewing camera, a passenger-side sideward-viewing camera and the rear backup camera) and the camera monitoring system cameras (such as a rearward-viewing camera, a driver-side rearward-viewing camera and a passenger-side rearward-viewing camera), and outputs (such as via a respective coaxial cable) to the video display of the interior rearview mirror assembly and optionally to the video display of the center console for displaying video images at the respective display screen based on the driving situation and/or user input by the driver. The processing of image data captured by all of the cameras (optionally including a trailer camera disposed at a trailer that is being towed by the vehicle) is performed by a data processor or image processor at the ECU, such that less processing capabilities are needed at the video display devices at the interior rearview mirror assembly and at the center console. The ECU may automatically adjust the outputs to the display devices based on the driving conditions so the appropriate video images are displayed by one or more display devices for viewing by the driver of the vehicle.

For example, during normal forward driving conditions along a road, the interior mirror may be operated for displaying rearward images captured by the rearward-viewing camera and/or for displaying CMS (Camera Monitoring System) images captured by the rearward-viewing camera, the driver-side rearward-viewing camera and the passenger-side rearward-viewing camera. When the vehicle is reversing or parking, surround view video images (and rear backup camera video images) may be displayed at the video display of the center console and optionally rear backup camera video images may be displayed at the video display of the interior rearview mirror. The switch from displaying (at the video mirror display) rear backup camera video images to displaying CMS video images may be responsive to the speed of the vehicle, as the vehicle speeds up, such as following completion of an unparking maneuver (where the vehicle pulls out of a parking space and begins driving along a road).

Optionally, the system may include a trailer camera and the processor at the ECU may process image data captured by the trailer camera and may display trailer see-through images, which shows a rearward and transparent view through the trailer with seamless stitching of images and image data captured by the towing vehicle's rear backup camera with images and image data captured by the trailer camera to provide the rearward video images. The ECU may output the trailer see-through images to the video display of the center stack or console when the vehicle is traveling forward at slow speeds (such as less than 15 mph or less than 10 mph or less than 7 mph or the like), and may automatically switch to output the trailer see-through images to the video display of the interior rearview mirror when the vehicle speeds up and is traveling forward at higher speeds (such as greater than 15 mph or greater than 10 mph or greater than 7 mph or the like). Thus, when the vehicle is traveling slowly, the driver may view the trailer see-through images at the larger center console display screen, and when the vehicle is traveling at greater speeds, the driver can view the trailer see-through images at the interior mirror display so that the images can be viewed without the driver having to take his or her eyes off the road ahead of the vehicle.

Optionally, the vehicle may be equipped with a blind zone detector (such as a radar sensor or the like that senses the region sideward of the vehicle that is not readily viewed by the driver of the vehicle). When another vehicle or object appears in the blind zone, the blind zone indicator (typically an icon or indicator at the exterior rearview mirror at that side of the vehicle) is actuated to alert the driver of the detected other vehicle at that side of the vehicle. The detection system outputs an electrical signal that is provided to the indicator and may also provide an electrical signal to the interior mirror display, such that, simultaneous with the indicator at the exterior mirror being actuated, the video display at the interior mirror is also actuated to provide an alert to the driver at the interior mirror as well. For example, detection of a vehicle in the blind zone at a particular side of the vehicle may result in video images (derived from image data captured by the side camera at that side of the vehicle) being displayed at the interior mirror (such as at a respective side region of the interior mirror) and/or may result in an icon or indicia (indicative of a detection, such as an icon similar to the icon of the blind zone indicator at the exterior mirror) appearing at interior mirror (such as at a respective side region of the interior mirror). Optionally, the indication at the interior mirror may be user selected (such as via a user actuatable input or switch or such as via a menu selection from a touch screen of the vehicle or the like) to provide the desired image and/or icon at the interior mirror and/or to provide no display or icon at the interior mirror, depending on the preferences of the driver of the vehicle. The blind zone indicating system may utilize aspects of the systems described in U.S. Pat. Nos. 9,041,806; 7,492,281 and/or 5,786,772, and/or U.S. Publication Nos. US-2018-0134217 and/or US-2014-0098230, which are hereby incorporated herein by reference in their entireties.

The vehicle and trailer cameras may comprise any suitable imaging sensor or camera, such as a pixelated imaging array or the like, such as a CMOS imaging array sensor, a CCD sensor or other sensors or the like, such as a camera or sensor of the types disclosed in commonly assigned, U.S. Pat. Nos. 7,965,336; 5,550,677; 5,760,962; 6,097,023 and 5,796,094, which are hereby incorporated herein by reference in their entireties. Optionally, the cameras may comprise a stereo imaging camera or the like, such as by utilizing aspects of the imaging systems described in U.S. Pat. Nos. 6,396,397 and/or 5,796,094, which are hereby incorporated herein by reference in their entireties. Optionally, the cameras may comprise an infrared or near infrared light sensitive camera and may be suitable for capturing images in low lighting conditions, and/or the camera may include or be associated with an illumination source (such as an infrared or near-infrared light emitting illumination source that, when actuated to emit infrared or near-infrared light at the side of the vehicle, enhances the camera's performance but is not visible or discernible to the driver of the vehicle), such as by utilizing aspects of the cameras described in U.S. Pat. Nos. 7,965,336; 5,550,677; 5,760,962; 6,097,023 and 5,796,094, which are hereby incorporated herein by reference in their entireties.

The sideward and rearward-viewing cameras may be incorporated at the exterior rearview mirror assembly or elsewhere at the vehicle, such as at a side body or door portion of the vehicle, and having a sideward and rearward field of view. Optionally, the camera may have a wide angle field of view at the side of the vehicle and/or may have an adjustable field of view and/or may capture images for use in other vision systems, such as for use in a top-down view or bird's-eye view vision system of the vehicle or a surround view vision system at the vehicle, such as by utilizing aspects of the vision systems described in U.S. Pat. Nos. 9,126,525; 9,041,806; 9,900,522; 9,900,522; 10,071,687 and/or 9,762,880, and/or U.S. Publication Nos. US-2015-0022664 and/or US-2012-0162427, which are hereby incorporated herein by reference in their entireties.

The mirror reflective element of the mirror head of the mirror assembly has a transflective mirror reflector that is partially transmissive and partially reflective of visible light incident thereat. Thus, when the interior rearview mirror assembly is adjusted or set to be in the mirror mode (where the video display screen is not actuated to display video images and the mirror head is tilted upward or downward relative to its orientation when in the display mode), the driver can view rearward of the vehicle via the transflective mirror reflector of the mirror reflective element, and when the interior rearview mirror assembly is adjusted or set to be in the display mode (where the video display screen is actuated to display video images and the mirror head is tilted downward or upward relative to its orientation when in the mirror mode), the driver of the vehicle can view the video images displayed by the video mirror display screen.

Optionally, the mirror reflective element of the mirror head of the mirror assembly may comprise an electro-optic or electrochromic mirror reflective element having a front glass substrate and a rear glass substrate with an electrochromic medium disposed between the front glass substrate and the rear glass substrate. The front substrate has a front or first surface (the surface that generally faces the driver of a vehicle when the mirror assembly is normally mounted at the vehicle) and a rear or second surface opposite the front surface, and the rear substrate has a front or third surface and a rear or fourth surface opposite the front surface, with the electro-optic medium disposed between the second surface and the third surface and bounded by a perimeter seal of the reflective element (such as is known in the electrochromic mirror art). The second surface has a transparent conductive coating established thereat (such as an indium tin oxide (ITO) layer, or a doped tin oxide layer or any other transparent electrically semi-conductive layer or coating or the like (such as indium cerium oxide (ICO), indium tungsten oxide (IWO), or indium oxide (10) layers or the like or a zinc oxide layer or coating, or a zinc oxide coating or the like doped with aluminum or other metallic materials, such as silver or gold or the like, or other oxides doped with a suitable metallic material or the like, or such as disclosed in U.S. Pat. No. 7,274,501, which is hereby incorporated herein by reference in its entirety), while the third surface has an electrically conductive layer or coating (such as a metallic reflector coating (or multiple layers or coatings)) established thereat. The front or third surface of rear substrate may include one or more transparent semi-conductive layers (such as an ITO layer or the like), and one or more metallic electrically conductive layers (such as a layer of silver, aluminum, chromium or the like or an alloy thereof), and may include multiple layers such as disclosed in U.S. Pat. Nos. 7,274,501; 7,184,190 and/or 7,255,451, which are hereby incorporated herein by reference in their entireties. The mirror reflector may comprise any suitable coatings or layers, such as a transflective coating or layer, such as described in U.S. Pat. Nos. 7,626,749; 7,274,501; 7,255,451; 7,195,381; 7,184,190; 6,690,268; 5,140,455; 5,151,816; 6,178,034; 6,154,306; 6,002,511; 5,567,360; 5,525,264; 5,610,756; 5,406,414; 5,253,109; 5,076,673; 5,073,012; 5,115,346; 5,724,187; 5,668,663; 5,910,854; 5,142,407 and/or 4,712,879, which are hereby incorporated herein by reference in their entireties, disposed at the front surface of the rear substrate (commonly referred to as the third surface of the reflective element) and opposing the electro-optic medium, such as an electrochromic medium disposed between the front and rear substrates and bounded by the perimeter seal (but optionally, the mirror reflector could be disposed at the rear surface of the rear substrate (commonly referred to as the fourth surface of the reflective element).

The transflective mirror reflector (that is partially transmissive and partially reflective of visible light incident thereat) is disposed at a side or surface of the rear glass substrate of the electrochromic mirror reflective element. For example, the transflective mirror reflector may be disposed at the third surface or side of the rear glass substrate that faces or opposes or contacts the electrochromic medium (commonly referred to as a third surface reflector), or the transflective mirror reflector may be disposed at the fourth surface or side of the rear glass substrate that faces away from the electrochromic medium or is opposite from the side that faces the electrochromic medium (commonly referred to as a fourth surface reflector). Optionally, the mirror reflective element of the mirror head of the mirror assembly may comprise a prismatic mirror reflective element, with the single wedge-shaped glass substrate coated at one side or surface with the transflective mirror reflector that is partially transmissive and partially reflective of visible light incident thereat.

The mirror assembly may comprise any suitable construction, such as, for example, a mirror assembly with the reflective element being nested in the mirror casing and with a bezel portion that circumscribes a perimeter region of the front surface of the reflective element, or with the mirror casing having a curved or beveled perimeter edge around the reflective element and with no overlap onto the front surface of the reflective element (such as by utilizing aspects of the mirror assemblies described in U.S. Pat. Nos. 7,184,190; 7,274,501; 7,255,451; 7,289,037; 7,360,932; 7,626,749; 8,049,640; 8,277,059 and/or 8,529,108, which are hereby incorporated herein by reference in their entireties) or such as a mirror assembly having a rear substrate of an electro-optic or electrochromic reflective element nested in the mirror casing, and with the front substrate having curved or beveled perimeter edges, or such as a mirror assembly having a prismatic reflective element that is disposed at an outer perimeter edge of the mirror casing and with the prismatic substrate having curved or beveled perimeter edges, such as described in U.S. Pat. Nos. 8,508,831; 8,730,553; 9,598,016 and/or 9,346,403, and/or U.S. Publication Nos. US-2014-0313563 and/or US-2015-0097955, which are hereby incorporated herein by reference in their entireties (and with electrochromic and prismatic mirrors of such construction are commercially available from the assignee of this application under the trade name INFINITY™ mirror).

The mirror assembly may include user inputs or actuatable switches or touch sensors or the like for user/driver control of one or more features of the mirror assembly and/or display system. The user inputs or touch sensors may comprise any suitable sensors or inputs, and may utilize aspects of the inputs and sensors described in U.S. Pat. Nos. 9,827,913; 9,598,016; 9,346,403; 8,508,831; 8,730,553; 7,224,324; 7,253,723; 7,255,451 and/or 8,154,418, which are hereby incorporated herein by reference in their entireties.

Optionally, the display may utilize aspects of the displays of the types disclosed in U.S. Pat. Nos. 9,264,672; 9,041,806; 7,855,755; 7,777,611; 7,626,749; 7,581,859; 7,446,924; 7,446,650; 7,370,983; 7,338,177; 7,274,501; 7,255,451; 7,195,381; 7,184,190; 6,690,268; 6,329,925; 5,668,663; 5,530,240 and/or 5,724,187, and/or in U.S. Publication No. US-2006-0050018, which are all hereby incorporated herein by reference in their entireties. The display may be viewable through the reflective element when the display is activated to display information. The display element may be any type of display element, such as a vacuum fluorescent (VF) display element, a light emitting diode (LED) display element, such as an organic light emitting diode (OLED) or an inorganic light emitting diode, an electroluminescent (EL) display element, a liquid crystal display (LCD) element, a video screen display element or backlit thin film transistor (TFT) display element or the like, and may be operable to display various information (as discrete characters, icons or the like, or in a multi-pixel manner) to the driver of the vehicle, such as passenger side inflatable restraint (PSIR) information, tire pressure status, and/or the like.

Changes and modifications to the specifically described embodiments may be carried out without departing from the principles of the present invention, which is intended to be limited only by the scope of the appended claims as interpreted according to the principles of patent law.

1. A vehicular vision system comprising:
an electronic control unit (ECU) disposed at a vehicle equipped with the vehicular vision system, wherein the ECU comprises electronic circuitry and associated software;
a plurality of vehicle cameras disposed at the vehicle;
wherein the plurality of vehicle cameras comprises (i) a rearward-viewing vehicle camera viewing at least rearward of the vehicle, (ii) a left-side vehicle camera disposed at a left side of the vehicle and viewing at least rearward and sideward of the vehicle and (iii) a right-side vehicle camera disposed at a right side of the vehicle and viewing at least rearward and sideward of the vehicle;
wherein each camera of the plurality of vehicle cameras captures image data and provides captured image data to the ECU;
wherein, when the vehicle is towing a trailer in a forward direction of travel, and with the towed trailer equipped with a trailer camera disposed at a rear portion of the trailer and viewing at least rearward of the trailer, the trailer camera captures image data and provides captured image data to the ECU;
wherein the electronic circuitry of the ECU comprises an image processor operable to process image data captured by (i) the plurality of vehicle cameras and (ii) the trailer camera;
a video mirror display screen disposed at an interior rearview mirror assembly of the vehicle, the interior rearview mirror assembly comprising a mirror reflective element having a transflective mirror reflector disposed at a surface thereof;
wherein the ECU provides, for display at the video mirror display screen, video image data derived from image data provided to the ECU from at least one selected from the group consisting of (i) the trailer camera and (ii) at least one camera of the plurality of vehicle cameras;
wherein the video mirror display screen is operable to display video images derived, at least in part, from video image data provided from the ECU, and wherein video images displayed by the video mirror display screen are viewable through the transflective mirror reflector of the mirror reflective element of the interior rearview mirror assembly by a driver of the vehicle viewing the interior rearview mirror assembly;
wherein the interior rearview mirror assembly is adjustable between (i) a mirror mode, the mirror mode allowing the driver of the vehicle to view rearward of the vehicle via the transflective mirror reflector of the mirror reflective element, and (ii) a display mode, the display mode allowing the driver of the vehicle to view the video images displayed by the video mirror display screen;
wherein the interior rearview mirror assembly, when in the display mode, is operable to display at the video mirror display screen one selected from the group consisting of (i) a single image display of video images, (ii) a dual image display of video images and (iii) a three image display of video images;
wherein an image display selector is operable by the driver to select between (i) the single image display of video images, (ii) the dual image display of video images and (iii) the three image display of video images;
wherein, when the vehicle is not towing the trailer and the interior rearview mirror assembly is displaying at the video mirror display screen the single image display of video images, the single image display of video images comprises video images derived from image data captured by the rearward-viewing vehicle camera;
wherein, when the vehicle is towing the trailer and the interior rearview mirror assembly is displaying at the video mirror display screen the single image display of video images, the single image display of video images comprises video images derived from image data captured by the trailer camera;
wherein, when the interior rearview mirror assembly is displaying at the video mirror display screen the dual image display of video images, the dual image display of video images comprises tiled side-by-side video images derived from image data captured by the left-side vehicle camera and the right-side vehicle camera;
wherein, when the dual image display of video images is selected, the video image data provided by the ECU includes left-side video image data derived from image data captured by the left-side vehicle camera and right-side video image data derived from image data captured by the right-side vehicle camera, and wherein left-side video images derived from the left-side video image data are displayed at a left side of the video mirror display screen and right-side video images derived from the right-side video image data are displayed at a right side of the video mirror display screen;
wherein, when the vehicle is towing the trailer and the interior rearview mirror assembly is displaying at the video mirror display screen the three image display of video images, the three image display of video images comprises tiled side-by-side video images derived from image data captured by the trailer camera, the left-side vehicle camera and the right-side vehicle camera; and
wherein, when the vehicle is towing the trailer, and when the three image display of video images is selected, the video image data provided by the ECU includes left-side video image data derived from image data captured by the left-side vehicle camera, rear video image data derived from image data captured by the trailer camera, and right-side video image data derived from image data captured by the right-side vehicle camera, and wherein left-side video images derived from the left-side video image data are displayed at the left side of the video mirror display screen, rear video images derived from the rear video image data are displayed at a center region of the video mirror display screen and right-side video images derived from the right-side video image data are displayed at the right side of the video mirror display screen.

2. The vehicular vision system of claim 1, wherein, when the interior rearview mirror assembly is displaying at the video mirror display screen the dual image display of video images, the driver can selectively adjust display parameters of the displayed left-side video images independent of the displayed right-side video images, and wherein, when the interior rearview mirror assembly is displaying at the video mirror display screen the three image display of video images, the driver can selectively adjust at least one display parameter of the displayed left-side video images independently of the displayed rear video images and the displayed right-side video images.

3. The vehicular vision system of claim 2, wherein a view adjuster is operable by the driver to selectively adjust the display parameters of the displayed left-side video images or the displayed right-side video images or the displayed rear video images.

4. The vehicular vision system of claim 2, wherein the display parameters comprise zoom.

5. The vehicular vision system of claim 2, wherein the display parameters comprise tilt.

6. The vehicular vision system of claim 2, wherein the display parameters comprise roll.

7. The vehicular vision system of claim 2, wherein the display parameters comprise intensity.

8. The vehicular vision system of claim 2, wherein the video mirror display screen provides indication of which displayed video images the driver selects for selectively adjusting the display parameters.

9. The vehicular vision system of claim 8, wherein the indication comprises illuminating a ring around the respective portion of the video mirror display screen that displays the displayed video images that the driver selects for selectively adjusting the display parameters.

10. The vehicular vision system of claim 8, wherein the indication comprises illuminating a respective portion of an iconistic representation of a mirror reflective element, with the respective portion of the iconistic representation corresponding with the portion of the video mirror display screen that displays the displayed video images that the driver selects for selectively adjusting the display parameters.

11. The vehicular vision system of claim 2, wherein an iconistic menu is displayed that includes icons representative of the display parameters that the driver selectively adjusts.

12. The vehicular vision system of claim 1, wherein the ECU is mounted under a seat of the vehicle.

13. The vehicular vision system of claim 1, wherein the interior rearview mirror assembly comprises the ECU.

14. The vehicular vision system of claim 1, wherein a head unit of the vehicle comprises the ECU.

15. The vehicular vision system of claim 1, wherein the ECU, via processing of image data captured by the trailer camera and by at least the rearward-viewing vehicle camera, generates see-through trailer video images and provides the see-through trailer video images to the video mirror display screen.

16. The vehicular vision system of claim 1, wherein an iconistic menu is displayed that includes icons representative of which vision selection is made by the driver via operation of the image display selector.

17. The vehicular vision system of claim 16, wherein the iconistic menu is displayed as a row along a lower region of the video mirror display screen.

18. The vehicular vision system of claim 17, wherein the iconistic menu is displayed at a darkened band along the lower region.

19. The vehicular vision system of claim 18, wherein the iconistic menu and darkened band scroll upward when the image display selector is operated by the driver of the vehicle.

20. The vehicular vision system of claim 17, wherein the iconistic menu includes an icon of a trailer to indicate when a trailer is hitched to the vehicle and when the video images being displayed are derived from image data captured by the trailer camera.

21. The vehicular vision system of claim 1, wherein, when the vehicle is not towing the trailer, the driver can operate the image display selector to select (i) the single image display of video images derived from image data captured by the rearward-viewing vehicle camera or (ii) the dual image display of video images derived from image data captured by the left-side vehicle camera and the right-side vehicle camera.

22. The vehicular vision system of claim 21, wherein, when the vehicle is not towing the trailer, the driver cannot select the three image display of video images via operation of the image display selector.

23. The vehicular vision system of claim 1, further comprising a repeater disposed inline between the trailer camera and the ECU, and wherein image data captured by the trailer camera is provided to the repeater, and wherein the repeater provides the image data captured by the trailer camera to the ECU.

24. The vehicular vision system of claim 1, wherein captured image data is provided to the ECU from the respective vehicle cameras via respective coaxial cables.

25. The vehicular vision system of claim 1, wherein, when the dual image display of video images is selected or when the three image display of video images is selected, the video mirror display screen displays the video images in a split screen format.

26. The vehicular vision system of claim 1, wherein the mirror reflective element having the transflective mirror reflector comprises an electrochromic mirror reflective element.

27. The vehicular vision system of claim 1, wherein the mirror reflective element having the transflective mirror reflector comprises a prismatic mirror reflective element.

28. The vehicular vision system of claim 1, wherein the rearward-viewing vehicle camera has a field of view that is different than a field of view of a rear backup camera of the vehicle.

29. The vehicular vision system of claim 1, wherein the rearward-viewing vehicle camera comprises a rear backup camera of the vehicle.

30. The vehicular vision system of claim 1, wherein, when the vehicle is not towing the trailer and the interior rearview mirror assembly is displaying at the video mirror display screen the single image display of video images, the video mirror display screen does not display video images derived from image data captured by the left-side vehicle camera and the right-side vehicle camera.

31. The vehicular vision system of claim 1, wherein, when the vehicle is towing the trailer and the interior rearview mirror assembly is displaying at the video mirror display screen the single image display of video images, the video mirror display screen does not display video images derived from image data captured by the rearward-viewing vehicle camera, the left-side vehicle camera and the right-side vehicle camera.

32. The vehicular vision system of claim 1, wherein, when the interior rearview mirror assembly is displaying at the video mirror display screen the dual image display of video images, the video mirror display screen does not display video images derived from image data captured by the rearward-viewing vehicle camera and the trailer camera.

33. A vehicular vision system comprising:
an electronic control unit (ECU) disposed at a vehicle equipped with the vehicular vision system, wherein the ECU comprises electronic circuitry and associated software;
a plurality of vehicle cameras disposed at the vehicle;
wherein the plurality of vehicle cameras comprises (i) a rearward-viewing vehicle camera viewing at least rearward of the vehicle, (ii) a left-side vehicle camera disposed at a left side of the vehicle and viewing at least rearward and sideward of the vehicle and (iii) a right-side vehicle camera disposed at a right side of the vehicle and viewing at least rearward and sideward of the vehicle;
wherein each camera of the plurality of vehicle cameras captures image data and provides captured image data to the ECU;
wherein, when the vehicle is towing a trailer in a forward direction of travel, and with the towed trailer equipped with a trailer camera disposed at a rear portion of the trailer and viewing at least rearward of the trailer, the trailer camera captures image data and provides captured image data to the ECU;
wherein the electronic circuitry of the ECU comprises an image processor operable to process image data captured by (i) the plurality of vehicle cameras and (ii) the trailer camera;
a video mirror display screen disposed at an interior rearview mirror assembly of the vehicle, the interior rearview mirror assembly comprising a mirror reflective element having a transflective mirror reflector disposed at a surface thereof;
wherein the ECU provides, for display at the video mirror display screen, video image data derived from image data provided to the ECU from at least one selected from the group consisting of (i) the trailer camera and (ii) at least one camera of the plurality of vehicle cameras;
wherein the video mirror display screen is operable to display video images derived, at least in part, from video image data provided from the ECU, and wherein video images displayed by the video mirror display screen are viewable through the transflective mirror reflector of the mirror reflective element of the interior rearview mirror assembly by a driver of the vehicle viewing the interior rearview mirror assembly;
wherein the interior rearview mirror assembly is adjustable between (i) a mirror mode, the mirror mode allowing the driver of the vehicle to view rearward of the vehicle via the transflective mirror reflector of the mirror reflective element, and (ii) a display mode, the display mode allowing the driver of the vehicle to view the video images displayed by the video mirror display screen;
wherein the interior rearview mirror assembly, when in the display mode, is operable to display at the video mirror display screen one selected from the group consisting of (i) a single image display of video images, (ii) a dual image display of video images and (iii) a three image display of video images;
wherein an image display selector is operable by the driver to select between (i) the single image display of video images, (ii) the dual image display of video images and (iii) the three image display of video images;
wherein, when the vehicle is not towing the trailer and the interior rearview mirror assembly is displaying at the video mirror display screen the single image display of video images, the single image display of video images comprises video images derived from image data captured by the rearward-viewing vehicle camera;
wherein, when the vehicle is towing the trailer and the interior rearview mirror assembly is displaying at the video mirror display screen the single image display of video images, the single image display of video images comprises video images derived from image data captured by the trailer camera;
wherein, when the interior rearview mirror assembly is displaying at the video mirror display screen the dual image display of video images, the dual image display of video images comprises tiled side-by-side video images derived from image data captured by the left-side vehicle camera and the right-side vehicle camera;
wherein, when the dual image display of video images is selected, the video image data provided by the ECU includes left-side video image data derived from image data captured by the left-side vehicle camera and right-side video image data derived from image data captured by the right-side vehicle camera, and wherein left-side video images derived from the left-side video image data are displayed at a left side of the video mirror display screen and right-side video images derived from the right-side video image data are displayed at a right side of the video mirror display screen;
wherein, when the vehicle is towing the trailer and the interior rearview mirror assembly is displaying at the video mirror display screen the three image display of video images, the three image display of video images comprises tiled side-by-side video images derived from image data captured by the trailer camera, the left-side vehicle camera and the right-side vehicle camera;
wherein, when the vehicle is towing the trailer, and when the three image display of video images is selected, the video image data provided by the ECU includes left-side video image data derived from image data captured by the left-side vehicle camera, rear video image data derived from image data captured by the trailer camera, and right-side video image data derived from image data captured by the right-side vehicle camera, and wherein left-side video images derived from the left-side video image data are displayed at the left side of the video mirror display screen, rear video images derived from the rear video image data are displayed at a center region of the video mirror display screen and right-side video images derived from the right-side video image data are displayed at the right side of the video mirror display screen;
wherein, when the interior rearview mirror assembly is displaying at the video mirror display screen the dual image display of video images, the driver can selectively adjust at least one display parameter of the displayed left-side video images independently of the displayed right-side video images;
wherein, when the interior rearview mirror assembly is displaying at the video mirror display screen the three image display of video images, the driver can selectively adjust at least one display parameter of the displayed left-side video images independently of the displayed rear video images and the displayed right-side video images; and
wherein the at least one display parameter at least comprises zoom.

34. The vehicular vision system of claim 33, wherein the at least one display parameter further comprises tilt.

35. The vehicular vision system of claim 33, wherein the at least one display parameter further comprises roll.

36. The vehicular vision system of claim 33, wherein the at least one display parameter further comprises intensity.

37. The vehicular vision system of claim 33, wherein a view adjuster is operable by the driver to selectively adjust the at least one display parameter of the displayed left-side video images or the displayed right-side video images or the displayed rear video images.

38. The vehicular vision system of claim 37, wherein the video mirror display screen provides indication of which displayed video images the driver selects for selectively adjusting the at least one display parameter.

39. The vehicular vision system of claim 38, wherein the indication comprises illuminating a ring around the respective portion of the video mirror display screen that displays the displayed video images that the driver selects for selectively adjusting the at least one display parameter.

40. The vehicular vision system of claim 38, wherein the indication comprises illuminating a respective portion of an iconistic representation of a mirror reflective element, with the respective portion of the iconistic representation corresponding with the portion of the video mirror display screen that displays the displayed video images that the driver selects for selectively adjusting the at least one display parameter.

41. The vehicular vision system of claim 37, wherein an iconistic menu is displayed that includes icons representative of which vision selection is made by the driver via operation of the image display selector.

42. The vehicular vision system of claim 41, wherein the iconistic menu includes at least one icon representative of the at least one display parameter that the driver selectively adjusts.

43. The vehicular vision system of claim 42, wherein the iconistic menu is displayed as a row along a lower region of the video mirror display screen.

44. The vehicular vision system of claim 43, wherein the iconistic menu is displayed at a darkened band along the lower region.

45. The vehicular vision system of claim 44, wherein the iconistic menu and darkened band scroll upward when the image display selector is operated by the driver of the vehicle.

46. The vehicular vision system of claim 43, wherein the iconistic menu includes an icon of a trailer to indicate when a trailer is hitched to the vehicle and when the video images being displayed are derived from image data captured by the trailer camera.

47. The vehicular vision system of claim 33, wherein, when the vehicle is not towing the trailer, the driver can operate the image display selector to select (i) the single image display of video images derived from image data captured by the rearward-viewing vehicle camera or (ii) the dual image display of video images derived from image data captured by the left-side vehicle camera and the right-side vehicle camera.

48. The vehicular vision system of claim 47, wherein, when the vehicle is not towing the trailer, the driver cannot select the three image display of video images via operation of the image display selector.

49. The vehicular vision system of claim 33, further comprising a repeater disposed inline between the trailer camera and the ECU, and wherein image data captured by the trailer camera is provided to the repeater, and wherein the repeater provides the image data captured by the trailer camera to the ECU.

50. The vehicular vision system of claim 33, wherein, when the dual image display of video images is selected or when the three image display of video images is selected, the video mirror display screen displays the video images in a split screen format.

51. The vehicular vision system of claim 33, wherein the mirror reflective element having the transflective mirror reflector comprises an electrochromic mirror reflective element.

52. The vehicular vision system of claim 33, wherein the mirror reflective element having the transflective mirror reflector comprises a prismatic mirror reflective element.

53. The vehicular vision system of claim 33, wherein the rearward-viewing vehicle camera has a field of view that is different than a field of view of a rear backup camera of the vehicle.

54. The vehicular vision system of claim 33, wherein the rearward-viewing vehicle camera comprises a rear backup camera of the vehicle.

55. The vehicular vision system of claim 33, wherein, when the vehicle is not towing the trailer and the interior rearview mirror assembly is displaying at the video mirror display screen the single image display of video images, the video mirror display screen does not display video images derived from image data captured by the left-side vehicle camera and the right-side vehicle camera.

56. The vehicular vision system of claim 33, wherein, when the vehicle is towing the trailer and the interior rearview mirror assembly is displaying at the video mirror display screen the single image display of video images, the video mirror display screen does not display video images derived from image data captured by the rearward-viewing vehicle camera, the left-side vehicle camera and the right-side vehicle camera.

57. The vehicular vision system of claim 33, wherein, when the interior rearview mirror assembly is displaying at the video mirror display screen the dual image display of video images, the video mirror display screen does not display video images derived from image data captured by the rearward-viewing vehicle camera and the trailer camera.

58. A vehicular vision system comprising:
an electronic control unit (ECU) disposed at a vehicle equipped with the vehicular vision system, wherein the ECU comprises electronic circuitry and associated software;
a plurality of vehicle cameras disposed at the vehicle;
wherein the plurality of vehicle cameras comprises (i) a rearward-viewing vehicle camera viewing at least rearward of the vehicle, (ii) a left-side vehicle camera disposed at a left side of the vehicle and viewing at least rearward and sideward of the vehicle and (iii) a right-side vehicle camera disposed at a right side of the vehicle and viewing at least rearward and sideward of the vehicle;
wherein each camera of the plurality of vehicle cameras captures image data and provides captured image data to the ECU;
wherein, when the vehicle is towing a trailer in a forward direction of travel, and with the towed trailer equipped with a trailer camera disposed at a rear portion of the trailer and viewing at least rearward of the trailer, the trailer camera captures image data and provides captured image data to the ECU;
wherein the electronic circuitry of the ECU comprises an image processor operable to process image data captured by (i) the plurality of vehicle cameras and (ii) the trailer camera;
a video mirror display screen disposed at an interior rearview mirror assembly of the vehicle;
wherein the interior rearview mirror assembly comprises an electrochromic mirror reflective element having a front glass substrate and a rear glass substrate with an electrochromic medium disposed between the front glass substrate and the rear glass substrate, and wherein a transflective mirror reflector is disposed at a surface of the rear glass substrate;
wherein the ECU provides, for display at the video mirror display screen, video image data derived from image data provided to the ECU from at least one selected from the group consisting of (i) the trailer camera and (ii) at least one camera of the plurality of vehicle cameras;
wherein the video mirror display screen is operable to display video images derived, at least in part, from video image data provided from the ECU, and wherein video images displayed by the video mirror display screen are viewable through the transflective mirror reflector of the electrochromic mirror reflective element of the interior rearview mirror assembly by a driver of the vehicle viewing the interior rearview mirror assembly;
wherein the interior rearview mirror assembly is adjustable between (i) a mirror mode, the mirror mode allowing the driver of the vehicle to view rearward of the vehicle via the transflective mirror reflector of the electrochromic mirror reflective element, and (ii) a display mode, the display mode allowing the driver of the vehicle to view the video images displayed by the video mirror display screen;
wherein the interior rearview mirror assembly, when in the display mode, is operable to display at the video mirror display screen one selected from the group consisting of (i) a single image display of video images, (ii) a dual image display of video images and (iii) a three image display of video images;
wherein an image display selector is operable by the driver to select between (i) the single image display of video images, (ii) the dual image display of video images and (iii) the three image display of video images;
wherein, when the vehicle is not towing the trailer and the interior rearview mirror assembly is displaying at the video mirror display screen the single image display of video images, the single image display of video images comprises video images derived from image data captured by the rearward-viewing vehicle camera;
wherein, when the vehicle is towing the trailer and the interior rearview mirror assembly is displaying at the video mirror display screen the single image display of video images, the single image display of video images comprises video images derived from image data captured by the trailer camera;
wherein, when the interior rearview mirror assembly is displaying at the video mirror display screen the dual image display of video images, the dual image display of video images comprises tiled side-by-side video images derived from image data captured by the left-side vehicle camera and the right-side vehicle camera;
wherein, when the dual image display of video images is selected, the video image data provided by the ECU includes left-side video image data derived from image data captured by the left-side vehicle camera and right-side video image data derived from image data captured by the right-side vehicle camera, and wherein left-side video images derived from the left-side video image data are displayed at a left side of the video mirror display screen and right-side video images derived from the right-side video image data are displayed at a right side of the video mirror display screen;
wherein, when the vehicle is towing the trailer and the interior rearview mirror assembly is displaying at the video mirror display screen the three image display of video images, the three image display of video images comprises tiled side-by-side video images derived from image data captured by the trailer camera, the left-side vehicle camera and the right-side vehicle camera; and
wherein, when the vehicle is towing the trailer, and when the interior rearview mirror assembly is displaying at the video mirror display screen the three image display of video images, the video image data provided by the ECU includes left-side video image data derived from image data captured by the left-side vehicle camera, rear video image data derived from image data captured by the trailer camera, and right-side video image data derived from image data captured by the right-side vehicle camera, and wherein left-side video images derived from the left-side video image data are displayed at the left side of the video mirror display screen, rear video images derived from the rear video image data are displayed at a center region of the video mirror display screen and right-side video images derived from the right-side video image data are displayed at the right side of the video mirror display screen.

59. The vehicular vision system of claim 58, wherein, when the interior rearview mirror assembly is displaying at the video mirror display screen the dual image display of video images or the three image display of video images, the driver can selectively adjust display parameters displayed left-side video images independent of the displayed right-side video images.

60. The vehicular vision system of claim 59, wherein a display parameter adjuster, operable by the driver, selectively adjusts the display parameters of the displayed left-side video images independent of the displayed right-side video images.

61. The vehicular vision system of claim 59, wherein the display parameters comprise zoom.

62. The vehicular vision system of claim 59, wherein the display parameters comprise tilt.

63. The vehicular vision system of claim 59, wherein the display parameters comprise roll.

64. The vehicular vision system of claim 59, wherein the display parameters comprise intensity.

65. The vehicular vision system of claim 59, wherein the video mirror display screen provides indication of which displayed video images the driver selects for selectively adjusting the display parameters.

66. The vehicular vision system of claim 65, wherein the indication comprises illuminating a ring around the respective portion of the video mirror display screen that displays the displayed video images that the driver selects for selectively adjusting the display parameters.

67. The vehicular vision system of claim 65, wherein the indication comprises illuminating a respective portion of an iconistic representation of a mirror reflective element, with the respective portion of the iconistic representation corresponding with the portion of the video mirror display screen that displays the displayed video images that the driver selects for selectively adjusting the display parameters.

68. The vehicular vision system of claim 59, wherein an iconistic menu is displayed that includes icons representative of the display parameters that the driver selectively adjusts.

69. The vehicular vision system of claim 58, wherein an iconistic menu is displayed that includes icons representative of which vision selection is made by the driver via operation of the image display selector.

70. The vehicular vision system of claim 69, wherein the iconistic menu is displayed as a row along a lower region of the video mirror display screen.

71. The vehicular vision system of claim 70, wherein the iconistic menu is displayed at a darkened band along the lower region.

72. The vehicular vision system of claim 71, wherein the iconistic menu and darkened band scroll upward when the image display selector is operated by the driver of the vehicle.

73. The vehicular vision system of claim 70, wherein the iconistic menu includes an icon of a trailer to indicate when a trailer is hitched to the vehicle and when the video images being displayed are derived from image data captured by the trailer camera.

74. The vehicular vision system of claim 58, wherein, when the vehicle is not towing the trailer, the driver can operate the image display selector to select (i) the single image display of video images derived from image data captured by the rearward-viewing vehicle camera or (ii) the dual image display of video images derived from image data captured by the left-side vehicle camera and the right-side vehicle camera.

75. The vehicular vision system of claim 74, wherein, when the vehicle is not towing the trailer, the driver cannot select the three image display of video images via operation of the image display selector.

76. The vehicular vision system of claim 58, further comprising a repeater disposed inline between the trailer camera and the ECU, and wherein image data captured by the trailer camera is provided to the repeater, and wherein the repeater provides the image data captured by the trailer camera to the ECU.

77. The vehicular vision system of claim 58, wherein the rearward-viewing vehicle camera has a field of view that is different than a field of view of a rear backup camera of the vehicle.

78. The vehicular vision system of claim 58, wherein the rearward-viewing vehicle camera comprises a rear backup camera of the vehicle.

79. The vehicular vision system of claim 58, wherein, when the vehicle is not towing the trailer and the interior rearview mirror assembly is displaying at the video mirror display screen the single image display of video images, the video mirror display screen does not display video images derived from image data captured by the left-side vehicle camera and the right-side vehicle camera.

80. The vehicular vision system of claim 58, wherein, when the vehicle is towing the trailer and the interior rearview mirror assembly is displaying at the video mirror display screen the single image display of video images, the video mirror display screen does not display video images derived from image data captured by the rearward-viewing vehicle camera, the left-side vehicle camera and the right-side vehicle camera.

81. The vehicular vision system of claim 58, wherein, when the interior rearview mirror assembly is displaying at the video mirror display screen the dual image display of video images, the video mirror display screen does not display video images derived from image data captured by the rearward-viewing vehicle camera and the trailer camera.

82. The vehicular vision system of claim 58, wherein the front glass substrate has a first surface that faces the driver of the vehicle and a second surface opposite the first surface, and wherein the rear glass substrate has a third surface and a fourth surface opposite the third surface, and wherein the electrochromic medium is disposed between the second surface and the third surface and bounded by a perimeter seal of the electrochromic mirror reflective element, and wherein the transflective mirror reflector is disposed at the third surface of the rear glass substrate of the electrochromic mirror reflective element.
